(19) United States
(12) Patent Application Publication
(10) Pub. No.: US 2013/0283142 A1
(43) Pub. Date: Oct. 24, 2013

(54) METHOD AND APPARATUS FOR A SECURE, COLLABORATIVE COMPUTER BASED COMMUNITY

(71) Applicants: KAYVAN FARZIN, San Diego, CA (US); Tony Anton, La Mesa, CA (US); Edward C. Reitz, Lakeside, CA (US)

(72) Inventors: KAYVAN FARZIN, San Diego, CA (US); Tony Anton, La Mesa, CA (US); Edward C. Reitz, Lakeside, CA (US)

(21) Appl. No.: 13/867,745

(22) Filed: Apr. 22, 2013

Related U.S. Application Data
(60) Provisional application No. 61/636,284, filed on Apr. 20, 2012.

(51) Int. Cl. G06F 3/0481; G06F 17/24

(52) U.S. Cl. CPC G06F 3/0481; G06F 17/245; G06F 17/243
USPC 715/224; 715/227; 715/753

(57) ABSTRACT

A safe cloud-based environment for student learning and collaboration, promotion of appropriate and responsible online student behavior, introduction and development of student work skills and abilities, and access to hundreds of online learning systems for students instantly and securely. For parents, real-time access to student performance and behavior is afforded, as is easily submitted student registration information online. Collaboration of parents with school staff and other parents is promoted. For teachers, appropriate teaching curriculum and effective assessment/grading methods can be created/provided and collaboration with students and parents regarding assignments, events, and other information is promoted. The effectiveness of teaching initiatives and programs is tracked and analyzed and direct and instant access to critical student information is provided. For administrators, performance data and metrics is tracked, and individualized or customized information and data is distributed globally within the community.

This application claims priority from U.S. provisional application 61/636,284, filed Apr. 20, 2012, the contents of which are incorporated herein.

### FIELD OF THE INVENTION

The present application relates generally to computer-based classrooms.

### BACKGROUND OF THE INVENTION

Schools and other similar social institutions including churches have turned to technology to assist them in overcoming the operational and budgetary constraints associated with the recent downturn in the market. Many software systems have been developed that only provide partial functionality. These include, but are not limited to online learning systems, assignment creators, grade books, web-based calendars, file depositories, and behavior trackers.

Unfortunately, most of the current school-oriented systems do not offer an integrated approach. Data must be shared between each of the systems which usually results in redundant or unnecessary data entry, and eventually leads to poor data integrity. Unreliable data inevitably leads to poor system performance and an unfavorable user experience. In some cases, teachers have even become frustrated to the point that they register their students in systems out on the Internet cloud without any prior parental or district consent.

### SUMMARY OF THE INVENTION

Present principles provide a safe cloud-based environment for student learning and collaboration, promote appropriate and responsible online student behavior, introduce and develop student work skills and abilities, and access hundreds of online learning systems for students instantly and securely. For parents, real-time access to student performance and behavior is afforded, as is easily submitted student registration information online. Present principles promote effective collaboration of parents with school staff and other parents and provide parents access to online stores for purchasing school merchandise or submitting payments. For teachers, appropriate teaching curriculum and effective assessment/grading methods can be created/provided and collaboration with students and parents regarding assignments, events, and other information is promoted. The effectiveness of teaching initiatives and programs can be tracked and analyzed and direct and instant access to critical student information is provided. For administrators, performance data and metrics can be tracked and measured in real time, individualized or customized information and data can be distributed globally within the community, and costs can be reduced by consolidating and streamlining school management components. Optimal levels of data security and integrity can be maintained while eliminating redundant or unnecessary data entry.

Accordingly, an apparatus includes at least one computer readable storage medium that is not a carrier wave and that is accessible to a digital processor. The medium bears instructions which when executed by the processor configure the processor to execute logic to execute a method comprising present on a display a user interface (UI). The UI includes a first column of sections. A first section in the first column is a personal profile section configurable to contain personal information associated with a user of the display, a second section is a contact section configurable to contain contact information pertaining to users in a closed group of users affiliated with the user of the display, while a third section is configurable to present indications of academic performance of the user of the display. Yet a second column is configurable to present icons representing applications, and the icons are selectable to invoke respective web sites in a closed group of web sites. The UI further includes a third column of sections. A first section in the third column is configurable for listing events by name and date associated with the user of the display. A second section in the third column is configurable for listing messages to the user of the display, and a third section in the third column is configurable to list work assignments of the user of the display.

In example embodiments, the first through third sections of the first column are presented in order respectively from top to bottom on the display. The first through third sections of the third column may also be presented in order respectively from top to bottom on the display. On the other hand, the second column can be presented on the display between the first and third columns. In specific examples the first column is presented along a left edge of the display and the third column is presented along a right edge of the display. In addition to the above-mentioned UI sections, in example implementations the UI can also include a banner section presented simultaneously on the display above the first, second, and third columns.

As explained further below, functionality of the UI when presented on a display of a user in a first user category may be different from the functionality of the UI when presented on a display of a user in a second user category.

In another aspect, an apparatus includes a computer readable storage medium that is not a carrier wave and that is accessible to a digital processor. The medium bears instructions which when executed by the processor configure the processor to execute logic to execute a method that includes presenting on a display a user interface. The UI can include data input elements allowing a parent to enter student name, address, contact information, and preferred language, indicate whether the student is part of a custody agreement, and whether the student has a sibling at a school.

In another aspect, a computer system includes one or more student computers providing an entry student user interface (UI) on a display. One or more parent computers provide an entry parent UI on a display and are associated with respective student UIs, and while one or more teacher computers provide an entry teacher UI on a display for interacting with the student and parent computers to establish a cloud-based environment for student learning and collaboration. The combination of computers also promotes appropriate and responsible online student behavior, introduces and develops student work skills and abilities, and accesses hundreds of online learning systems for students instantly and securely. Additionally, the parent UI affords a parent access to student performance and behavior, and the parent computer is programmed to facilitate submission of student registration information online. The teacher UI facilitates teaching curriculum development and publication to student computers and online grading of student-submitted responses to curriculum.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system according to present principles;

FIGS. 2-25 show various screen shots related to user registration into the system;

FIGS. 26-137 show various screen shots pertaining to the “dashboard” screens of various users; and

FIGS. 138-149 show various administrative screens.

### DETAILED DESCRIPTION OF THE PREFERRED EMBODIMENT

Disclosed are methods, apparatus, and systems for a computer based secure education community that provides for safe collaboration between students, educators, and parents or guardians. The community provides for customized roles and permissions based on each community member's role.

The community may be implemented as a system. The system may include at least server and client components, connected over a network such that data may be exchanged between the client and server components. The client components may include one or more computing devices. These may include personal computers, laptops, tablet computers, and other mobile devices including smart phones. These client devices may operate with a variety of operating environments. For example, some of the client computers may be running Microsoft Windows® operating system. Other client devices may be running one or more derivatives of the Unix operating system, or operating systems produced by Apple® Computer, such as the IOS® operating system, or the Android® operating system, produced by Google®. While examples of client device configurations are provided, these are only examples and are not meant to be limiting. These operating environments may also include one or more browsing programs, such as Microsoft Internet Explorer®, Firefox, Google Chrome®, or one of the other many browser programs known in the art. The browsing programs on the client devices may be used to access web applications hosted by the server components discussed below.

Server components may include one or more computer servers executing instructions that configure the servers to receive and transmit data over the network. For example, in some implementations, the client and server components may be connected over the Internet. In other implementations, the client and server components may be connected over a local intranet, such as an intranet within a school or a school district. In other implementations a virtual private network may be implemented between the client components and the server components. This virtual private network may then also be implemented over the interne or an intranet.

The data produced by the servers may be received by the client devices discussed above. The client devices may also generate network data that is received by the servers. The server components may also include load balancers, firewalls, caches, and proxies, and other network infrastructure known in the art for implementing a reliable and secure web site infrastructure. One or more server components may form an apparatus that implement methods of providing a secure community to one or more members. The methods may be implemented by software instructions executing on processors included in the server components. These methods may utilize one or more of the user interface examples provided below in the appendix.

The community offers a customized home page for each member, which may include profile information, applications approved for use by the community member, event planning information, messaging information, and course work information such as upcoming assignments and due dates. The community also provides performance management features. For example, gauges of student performance across multiple dimensions of student performance may be presented. For example, student performance with respect to grades, attendance, and citizenship may be displayed.

The technology is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, processor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor such as the AMD® Athlon® II or Phenom® II processor, Intel® i3®/i5®/i7® processors, Intel Xeon® processor, Apple® processor, or any implementation of an ARM® processor. In addition, the processor may be any conventional special purpose processor, including OMAP processors, Qualcomm® processors such as Snapdragon®, or a digital signal processor or a graphics processor. The processor typically has conventional address lines, conventional data lines, and one or more conventional control lines.

The system is comprised of various modules as discussed in detail. As can be appreciated by one of ordinary skill in the art, each of the modules comprises various sub-routines, procedures, definitional statements and macros. Each of the modules has been created as a standalone script that can function independently or in collaboration with other scripts. Each script resides on the server as a live functional module and can perform functions on demand. Therefore, the description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system has been created using PHP, JavaScript, AJAX, jQuery, HTML, HTML5, and JSON programming languages and can be run under a conventional operating system. PHP, JavaScript, AJAX, jQuery, HTML, HTML5, and JSON are industry standard programming languages for which many commercial compilers can be used to create executable code. The system may also be made to be compatible with other conventional programming languages such as C#, C, C++, BASIC, Pascal, or Java, and interpreted languages such as Perth, Python, and Ruby.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a, computer-readable medium. Computer-readable media include both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” While various aspects and embodiments have been disclosed herein, other aspects and embodiments will be apparent to those skilled in the art. The various aspects and embodiments disclosed herein are for purposes of illustration and are not intended to be limiting.

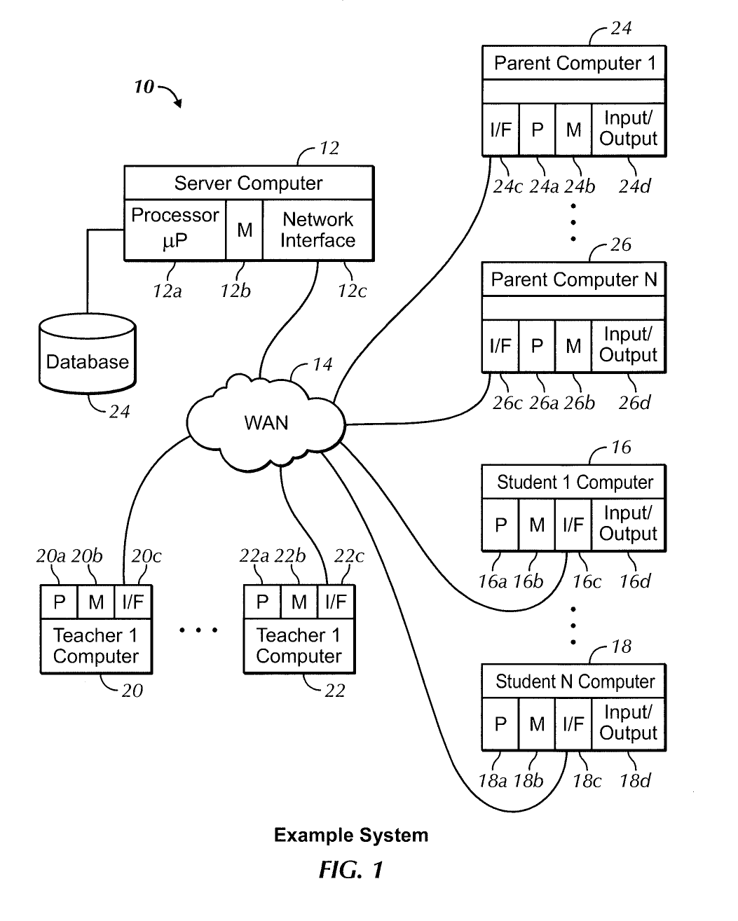

Referring initially to FIG. 1, a system 10 includes a server computer 12 communicating via a wide area network 14 such as the Internet with multiple student computers 16, 18 and multiple teacher computers 20, 22 for purposes to be shortly disclosed. The server computer 12 may be used to establish a computer-based classroom as described herein.

In the example shown, the server computer 12 can have one or more processors 12a accessing one or more computer memories 12b, such as disk-based or solid state storage, to execute logic disclosed herein. The server computer 12 can communicate with the WAN 14 using one or more network interfaces 12c, such as wired or wireless modems, wireless telephony transceivers, Wi-Fi transceivers, and the like. Also, the processor 12a may access a database 24 of student and teacher accounts.

The student computer 16 can have one or more processors 16a accessing one or more computer memories 16b, such as disk-based or solid state storage, to execute logic disclosed herein. The student computer 16 can communicate with the WAN 14 using one or more network interfaces 16c, such as wired or wireless modems, wireless telephony transceivers, Wi-Fi transceivers, and the like. Typically, the student computer 16 includes one or more input/output devices 16d such as but not limited to video displays, audio speakers, and printers (for output), and keyboards, keypads, voice recognition software with microphone, mice, trackballs, joysticks, touch sensitive displays, touch sensitive track pads, and other types of point-and-click devices (for input). The student computer 16 may be implemented by a desktop computer, a laptop or notebook computer, a slate computer, a smart phone, a tablet computer, a personal digital assistant (PDA), etc.

In general, the n^{th} student computer 18 can have one or more processors 18a accessing one or more computer memories 18b, such as disk-based or solid state storage, to execute logic disclosed herein. The student computer 18 can communicate with the WAN 14 using one or more network interfaces 18c, such as wired or wireless modems, wireless telephony transceivers, Wi-Fi transceivers, and the like. Typically, the student computer 18 includes one or more input/output devices 18d such as but not limited to video displays, audio speakers, and printers (for output), and keyboards, keypads, voice recognition software with microphone, mice, trackballs, joysticks, touch sensitive displays, touch sensitive track pads, and other types of point-and-click devices (for input).

Turning to the teacher computer 20, which may also represent the computer of any member of a school staff including an administrator, supervisor, technical computer administrator, etc., it typically may be implemented as one or more server-type computers as well as a personal computer such as one of those described above. Accordingly the teacher computer 20 can have one or more processors 20a accessing one or more computer memories 20b, such as disk-based or solid state storage, to execute logic disclosed herein. The teacher computer 20 can communicate with the WAN 14 using one or more network interfaces 20c, such as wired or wireless modems, wireless telephony transceivers, Wi-Fi transceivers, and the like. In general, the n^{th teacher} computer 22 can have one or more processors 22a accessing one or more computer memories 22b, such as disk-based or solid state storage, to execute logic disclosed herein. The teacher computer 22 can communicate with the WAN 14 using one or more network interfaces 22c, such as wired or wireless moderns, wireless telephony transceivers, Wi-Fi transceivers, and the like. The teacher computers can also include input devices and output devices such as those described for the student computers.

A parent computer 24 can have one or more processors 24a accessing one or more computer memories 24b, such as disk-based or solid state storage, to execute logic disclosed herein. The parent computer 24 can communicate with the WAN 14 using one or more network interfaces 24c, such as wired or wireless modems, wireless telephony transceivers, Wi-Fi transceivers, and the like. Typically, the parent computer 24 includes one or more input/output devices 24d such as but not limited to video displays, audio speakers, and printers (for output), and keyboards, keypads, voice recognition software with microphone, mice, trackballs, joysticks, touch sensitive displays, touch sensitive track pads, and other types of point-and-click devices (for input). The parent computer 24 may be implemented by a desktop computer, a laptop or notebook computer, a slate computer, a smart phone, a tablet computer, a personal digital assistant (PDA), etc.

In general, the n^{th} parent computer 26 can have one or more processors 26a accessing one or more computer memories 26b, such as disk-based or solid state storage, to execute logic disclosed herein. The parent computer 26 can communicate with the WAN 14 using one or more network interfaces 26c, such as wired or wireless modems, wireless telephony transceivers, Wi-Fi transceivers, and the like. Typically, the parent computer 26 includes one or more input/output devices 18d such as but not limited to video displays, audio speakers, and printers (for output), and keyboards, keypads, voice recognition software with microphone, mice, trackballs, joysticks, touch sensitive displays, touch sensitive track pads, and other types of point-and-click devices (for input).

With the example non-limiting system in mind, in brief overview, present principles provide a fully integrated software solution that incorporates the main components of school management. The process starts the instant parents submit detailed student information using our secure online registration process. Then, classes are created, teachers are assigned, students are allocated, parents are connected, calendars are populated, notifications are delivered, assignments are created, student performance is assessed, and grades are reported.

According to description set forth herein, any device is successfully locked down from access to inappropriate content on the Internet. Students are given every resource they need to fulfill their scholastic requirements without ever being exposed to potential dangers or risks.

The following role types are used in the following description.

Students—Each student entered into the system is assigned to a grade level (Transitional Kindergarten, Kindergarten, 1^{st} Grade, 2^{nd} Grade, 3^{rd} Grade, 4^{th} Grade, and 5^{th} Grade) and must be associated with at least one parental unit.

Parental Units (PU)—Adults registered in the system as having parental involvement with one or more of the student Users in the system. This can include, but is not limited to Parents, Step Parents, Grandparents, Uncles/Aunts, Legal Guardians, etc. There are three (3) different types of parental units defined in example embodiments. This includes a Primary Parent who is the User that submits the student's initial registration information into the system is considered the primary parent. Only one primary parent can be associated with each student. Secondary Parents can be added once a student has been registered into the system and has been associated with a primary parent. Multiple secondary parental units may be associated with one student. Joint Parents are secondary parental units that are subject to various limitations in regard to communication and interaction with others within the family unit. They can only be associated with a Student once they complete a separate registration process.

Faculty Members (FM)—Individuals that exist within the school staff in a teaching capacity are identified as Faculty Members. This includes, but is not limited to Teachers, Substitute Teachers, and Teaching Assistants.

School Administrators (SA)—Individuals that exist within the school staff in an administrative support role that requires advanced functionality are identified as School Administrators. This includes, but is not limited to Health Clerks, Librarians, School Clerks, and Office Assistants.

Executive Staff (ES)—Individuals that exist within the school staff in an executive management or leadership role that require advanced functionality are identified as Executive Staff. This can include, but is not limited to Principals, Vice Principals, Superintendents, Assistant Superintendents, District Clerks, Board Members, etc.

User Administrators (AUA)—Individuals that exist within the school staff in an administrative role that require functionality specific to the process of User management. This can include, but is not limited to School Clerks and School Office Managers.

System Administrators (ASA)—Individuals that require access to the entire front and back end of the system with restricted or limited access to critical data. This can include, but is not limited to a system Help Center, system technical Regional Consultants, system District Plants, etc.

Master Administrators (AMA)—Individuals that require full access to the entire front and back end of the system, including critical data. This may be limited to only employees of the supplier of the system.

### Registration

Note that the discussion below related to various ins describe which user role the UIs pertain to. User roles that do not pertain to a particular UI generally are not given access to that UI.
1. Registration—All User accounts should preferably be created by a System Administrator.

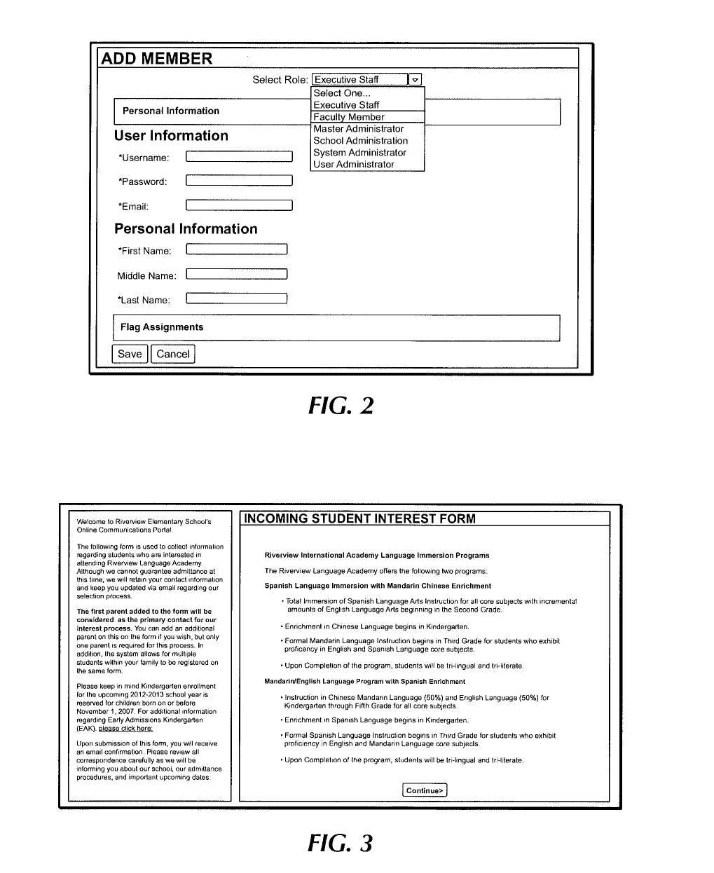

There are four separate methods for creating User accounts.
a. Add Member (FIG. 2) is a function that is only available to system administrators and is used to create accounts for all role types except for Students and Parental Units. These include, but are not limited to Executive Staff (ES), Faculty Member (FM), Master Administrator (AMA), School Administrator (SA), System Administrator (ASA), and User Administrator (AUA).

For accounts created using this function the system prompts Admin to create a unique Username and Password, to enter a valid and unique email address, and enter the User's first and last name. Once the Save button is clicked, the User's account is created and a system generated email notification is sent to the email that was entered into the form.

If additional information must be collected during the registration process, the Reg Form Builder function gives Admin the ability to add different types of form fields to each registration form.
b. Interest Form (FIG. 3) is the most formal registration process for Students and Parental Units that consists of the highest level of data collection and validation. This registration process is recommended as it will satisfy all of the requirements of a fully functional Student Information System (SIS). It also guarantees that Users will be able to take advantage of all of the benefits and features inside the GatherSafely system.

### Interest Form Page Content

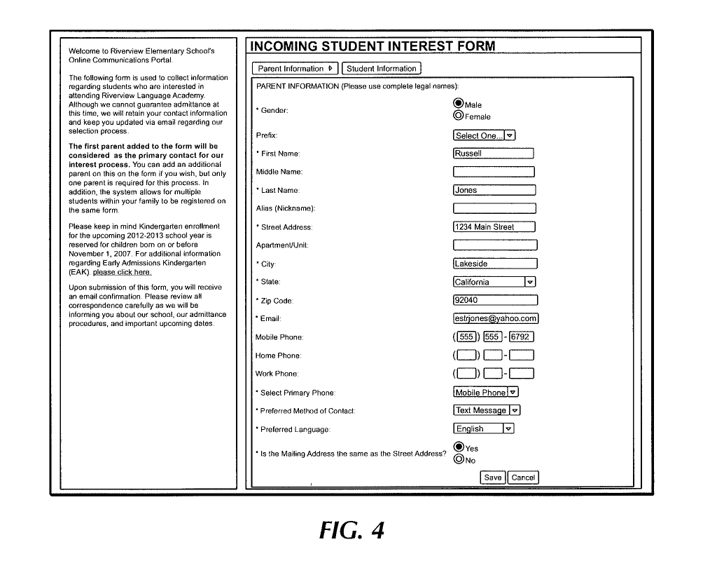

The Interest Form registration process begins with the information page shown in FIG. 3. The school can either place a direct hyperlink to this page under a button or text link within their existing web page or provide the URL to prospective registrants via digital or printed material. School Administrators have the ability to login and revise the side and main copy of this page as needed in real time. Once the User has reviewed the page content and is ready to proceed, they click the Continue button and are taken to the Pre-Registration Form for the Primary Parent (FIG. 4).

### Primary Parent Interest Form

For the User to submit the form of FIG. 4, they must provide valid entries for all of the required fields (marked with an “*”) and enter a unique email address. All system generated auto-notifications are delivered to the email address entered into this form, including internal messaging that is being forwarded to an outside email provider.

School Administrators have the ability to login and revise the side copy of this page as needed in real time. Once the User has entered the necessary form field data and is ready to proceed, they click the Save button and are taken to the Pre-Registration Form for the Student.

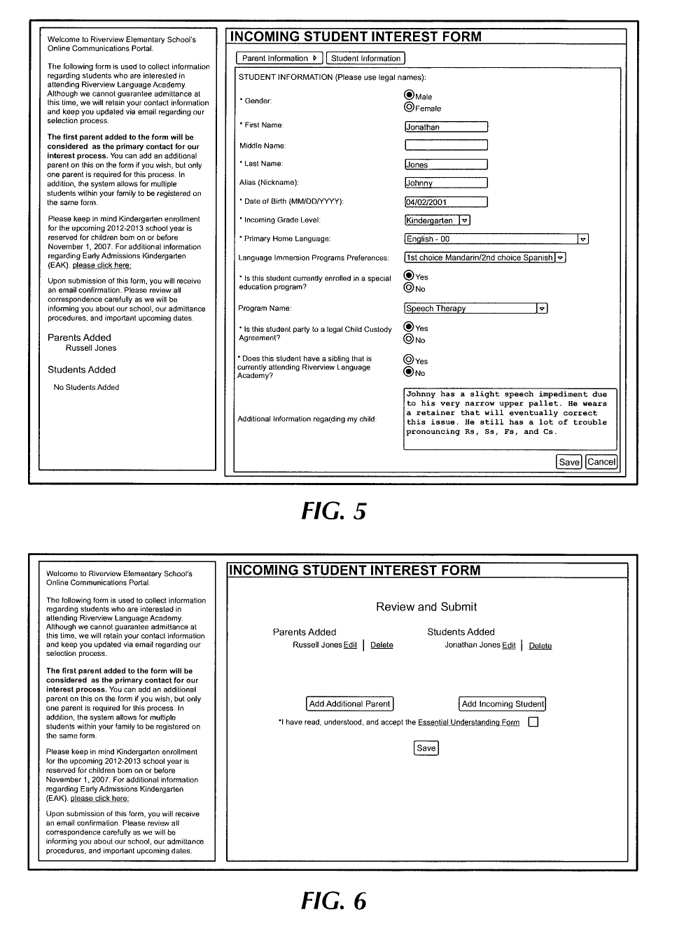

### Student Interest Form (FIG. 5)

For the User to submit the form of FIG. 5, they must provide valid entries for all of the required fields (marked with an “*”). School Administrators have the ability to login and revise the side copy of this page as needed in real time. Once the User has entered the necessary form field data and is ready to proceed, they click the Save button and are taken to the Pre-Registration Summary Page of FIG. 6. Note that the registration forms in FIGS. 4 and 5 allow a parent to enter student name, address, contact information, and preferred language, indicate whether the child is part of a custody agreement, and whether the student has a sibling at the school.

### Interest Form Summary Page (FIG. 6)

The User has three options at this point in the process, using the form of FIG. 6:
1) Submit “As-is”—The User can submit the form data as it was originally entered into the forms.
2) Edit|Delete—The User can edit the data or delete the forms they have entered so far and modify or re-enter their original pre-registration information.
3) Add Additional Parent|Add Incoming Student—The User can enter additional pre-registration information for Secondary Parents or Students.
   Once the User has finished entering all of the necessary pre-registration information, they should preferably check that they have reviewed the disclaimer (which can be modified by a School Administrator in real time), and then click the Save button.

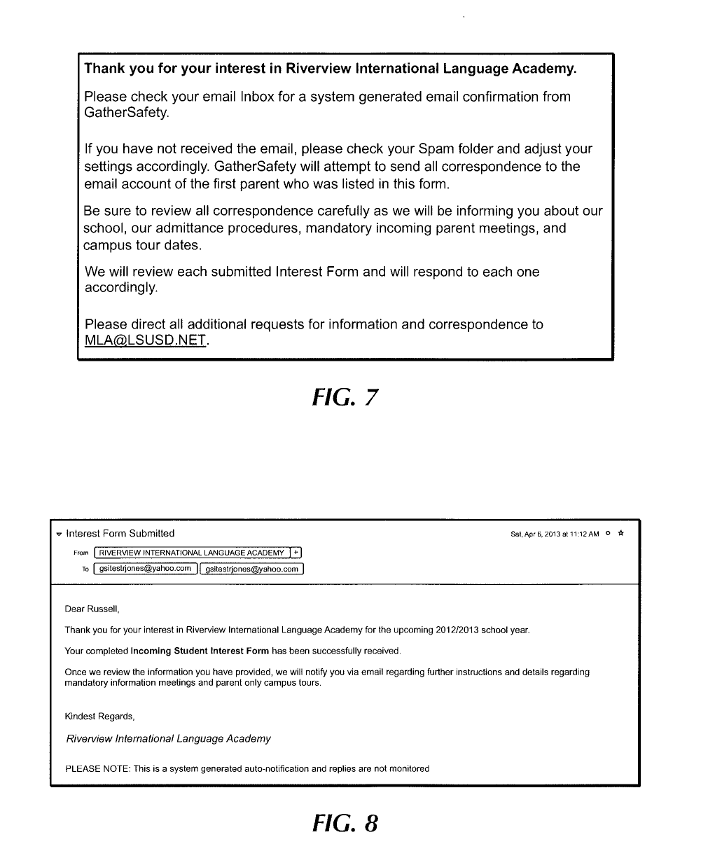

The system displays an on-screen confirmation message (FIG. 7) informing the User that their pre-registration forms have been received and are being reviewed.

### Interest Form On-Screen Confirmation (FIG. 7)

The copy and hyperlinks within this on-screen message can be changed instantly by the School Administrator.

### Interest Form Submitted Auto-Notification (FIG. 8)

The auto-notification of FIG. 8 is delivered to the email address that was entered into the Pre-Registration Form submitted by the Primary Parent. School Administrators can modify the message content as necessary.

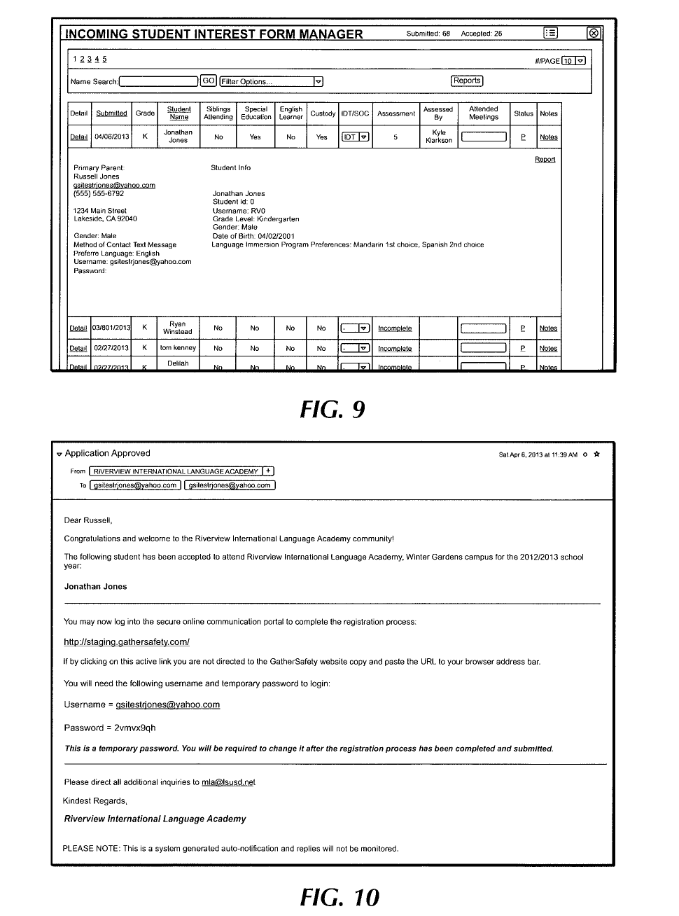

### Interest Form Management Interface (FIG. 9)

With FIG. 9, the School Administrator logs in and reviews the pre-registration information that was submitted during the Interest Form process. For security purposes, Passwords are not visible in this interface. School Administrators only have the ability to initiate a Password reset process for the Parent or Student. Any information that is recorded under the Notes column will be visible during the entire registration process.

Once all of the information has been reviewed, the School Administrator clicks on the P under the Status column and selects the appropriate flag:
a. Pending (P)—More information is required to process the pre-registration completely. A message is emailed to the Primary Parent telling them to contact the school regarding their request.
b. Denied (D)—After reviewing the pre-registration information, the request has been denied. Selecting this status requires that a reason be entered. A message is emailed to the Primary Parent telling them their request was denied. The reason is visible in this email message.
c. Accepted (A)—After reviewing the pre-registration information, the request has been accepted. A message is emailed to the Primary Parent telling them that their request has been accepted.

### Application Approved Auto-Notification (FIG. 10)

If the Interest Form request was accepted, then the message in FIG. 10 is emailed to the Primary Parent with further registration instructions. School Administrators can revise the content of this message as needed. For security reasons, a system generated temporary password is provided to the Primary Parent for their initial login. The system will prompt them to change this to a permanent password upon their initial login once they have completed the remainder of the registration process. If the Primary Parent entered an invalid or incorrect email address into the Interest Form, then they will not receive the above message. Although School Administrators do not have access to Parent or Student passwords, they can initiate the password reset process.

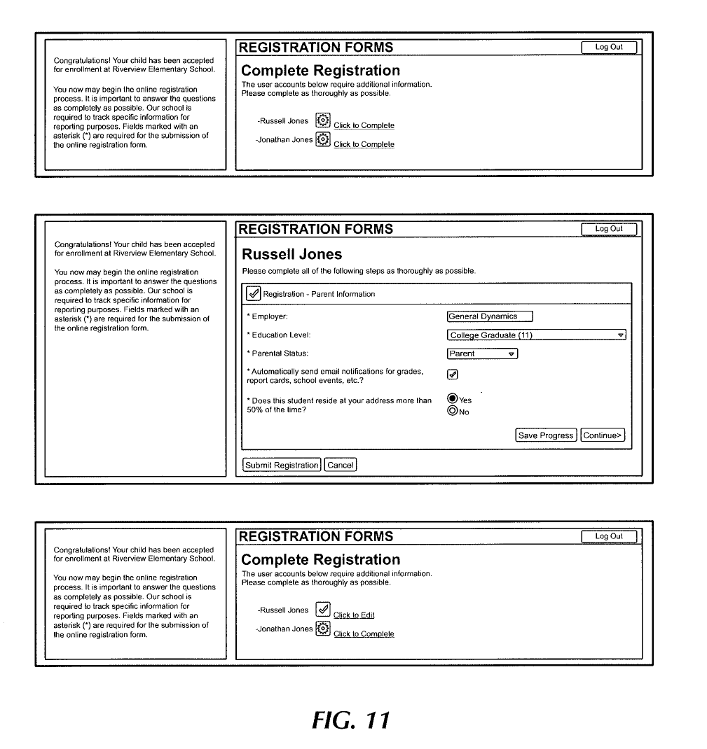

### Complete Registration—Parental Unit (FIG. 11)

All Parental Units entered during the initial Interest Form pre-registration process can enter additional registration information. The system displays the Registration Form once the User clicks the Click to Complete text link 1100 next to the ‘gear’ icon at the right of their name. School Administrators can modify the data requirements of the Parental Unit Registration Form as needed. The User may click the Save Progress button 1102 if they need to complete this form at a later point. Once all of the required information is entered into the form, and the User clicks the Submit Registration button, the system takes them back to the summary screen to enter the Registration Form for the Student.

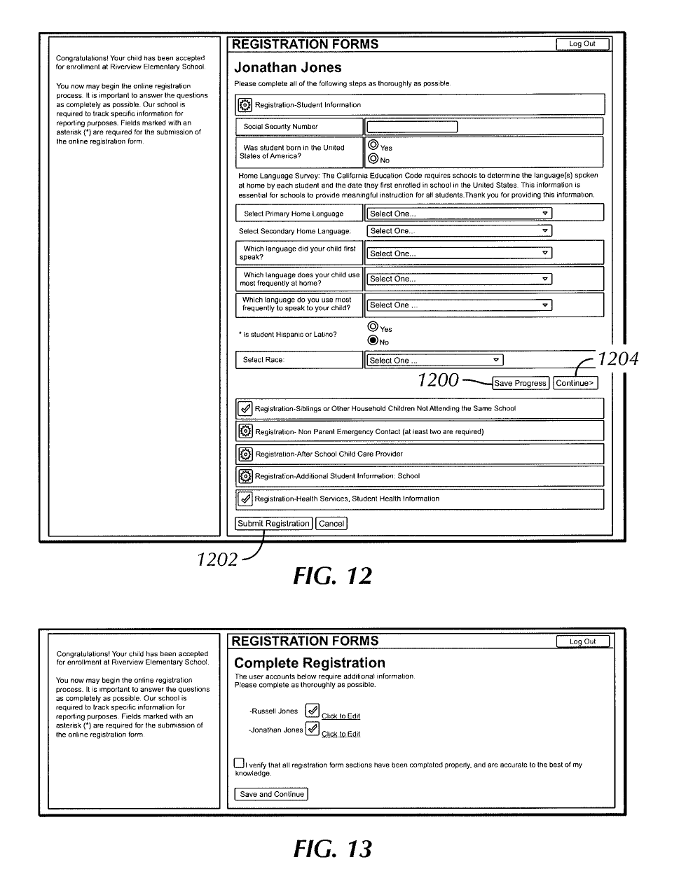

### Complete Registration—Student (FIG. 12)

The User should preferably enter additional registration information for all Students entered during the initial Interest Form pre-registration. The system displays the Registration Form once the User clicks the Click to Complete text link next to the ‘gear’ icon at the right of the Student's name.

School Administrators can modify the data requirements of the Student Registration Form as needed. The User may click the Save Progress 1200 button if they need to complete this form at a later point. Once all of the required information is entered into the form, and the User clicks the Submit Registration button 1202, the system takes them back to the summary screen. When all of the Parents and Students have a check mark next to their name, the User may mark the disclaimer box and click the Save and Continue button 1204 to proceed.

### Complete Registration Summary Screen (FIG. 13)

The Registration Completed auto-notification is sent to the Primary Parent's email address. School Administrators can revise the content of this message as needed.

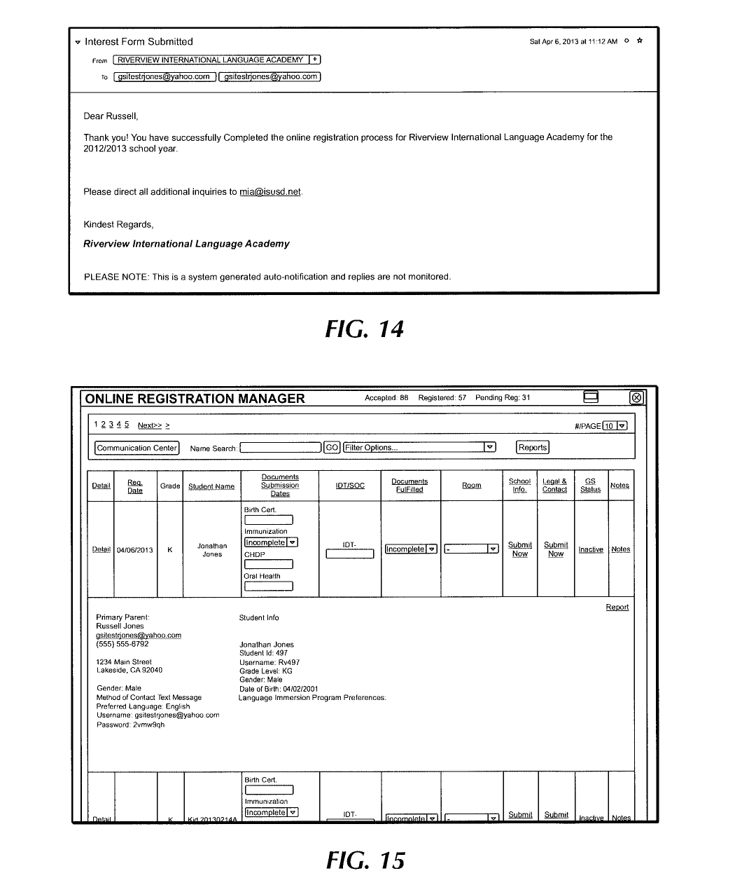

### Registration Completed Auto-Notification (FIG. 14)

### Registration Management Interface (FIG. 15)

With these forms, the School Administrator collects and reviews the Student's health records and birth certificate, enters additional School Information and Legal & Contact Information, adds additional Notes, and changes the system status of the student from Inactive to Active. The Status can be modified at any time from the Registration Management Interface which allows the School Administrator to control individual User access. If the status is changed from Active to Inactive, and the User attempts to login to their account, the system presents an on-screen message informing the User their account has been deactivated and giving them further instructions.

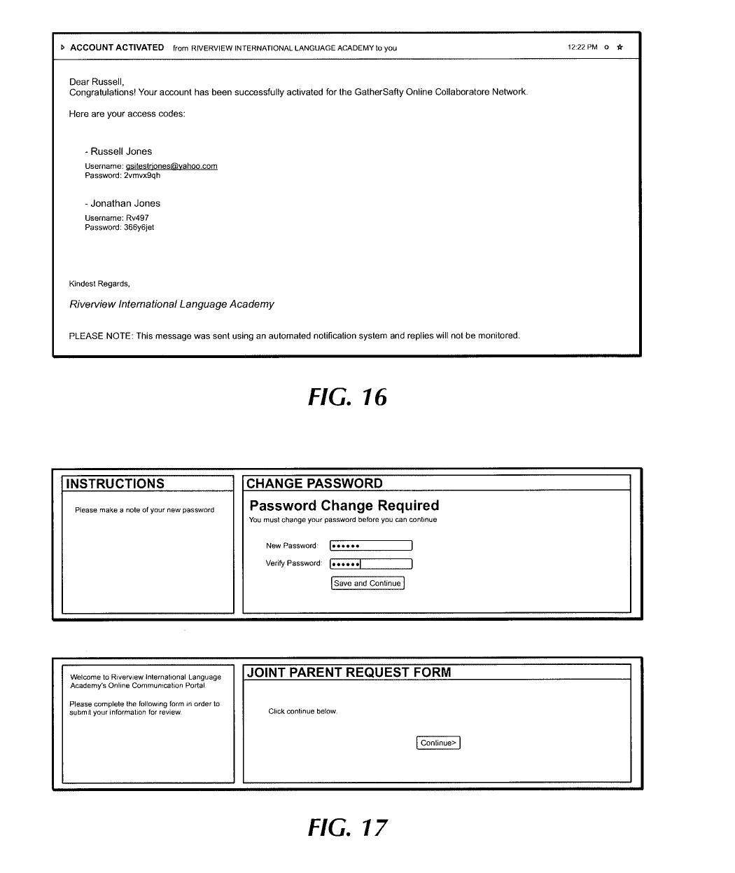

If the account(s) are successfully activated by the School Administrator, then the Account Activated auto-notification of FIG. 16 is emailed to the Primary Parent with instructions on accessing their new accounts. The School Administrator can revise the content of this message as needed. The Primary Parent's temporary password is visible in this interface in the event the School Administrator needs to login to their account to assist the User.

### Account Activated Auto-Notification (FIG. 16)

The Account Activated Auto-Notification provides the access codes for all of the Users that completed the registration process. Each account is assigned a temporary password and upon the User's initial login, the system will prompt them to change this to a permanent password.

### Password Change On-Screen Message (FIG. 17)

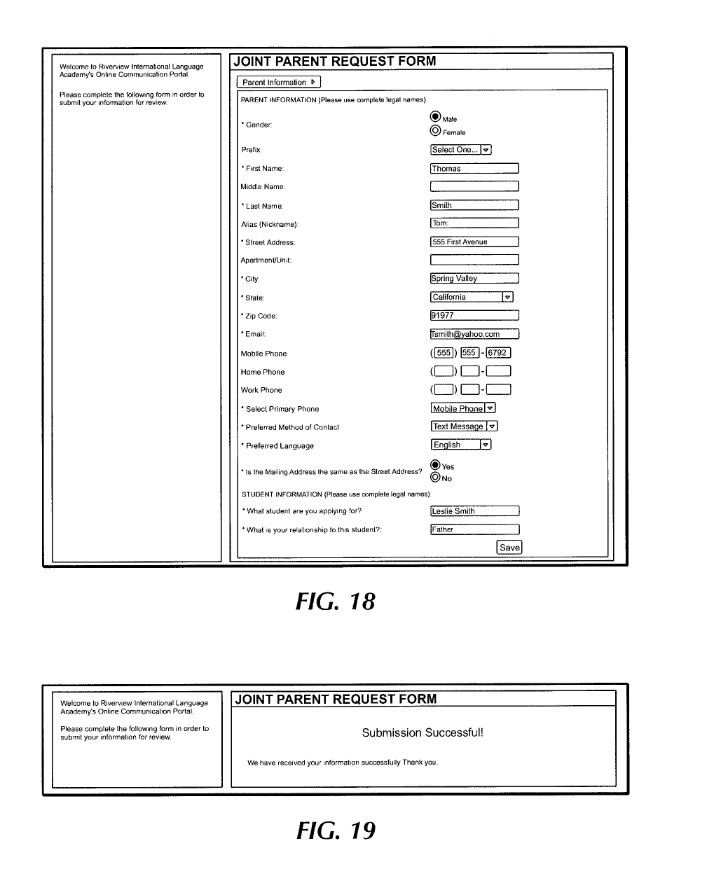

Once the User's password has been changed from temporary to permanent, this information is no longer visible to the School Administrator. If a Parental Unit or Student requires a password reset, the School Administrator has the ability to initiate this process from their login.
c. Quick Reg is the least formal registration process for Students and Parental Units and should only be utilized in cases where a school is using a separate Student Information System (SIS). Only limited registration information will be collected for the Parental Units and Students that enter through this process. Pre-Registration information is collected identical to the Interest Form. Once the User has reached the Interest Form Summary Page, they can check the disclaimer box and click the Save button. The remainder of the registration process is bypassed and their account is automatically activated. Registration data that is compiled using an outside SIS may not be compatible with the system and data may be mapped in on a case by case basis depending on the integrity and structure of the individual database(s).
d. Joint Parent (FIG. 18) is used to register Parental Units that may require additional limitations on their access and permissions to various functions or features within their account.

### Joint Parent Request Form (FIGS. 18 and 19)

Once the User satisfies all of the requirements within the Joint Parent Request Form and clicks the Save button, they receive an on-screen confirmation message. After reviewing the information within this page, the User can proceed by clicking the Continue button.

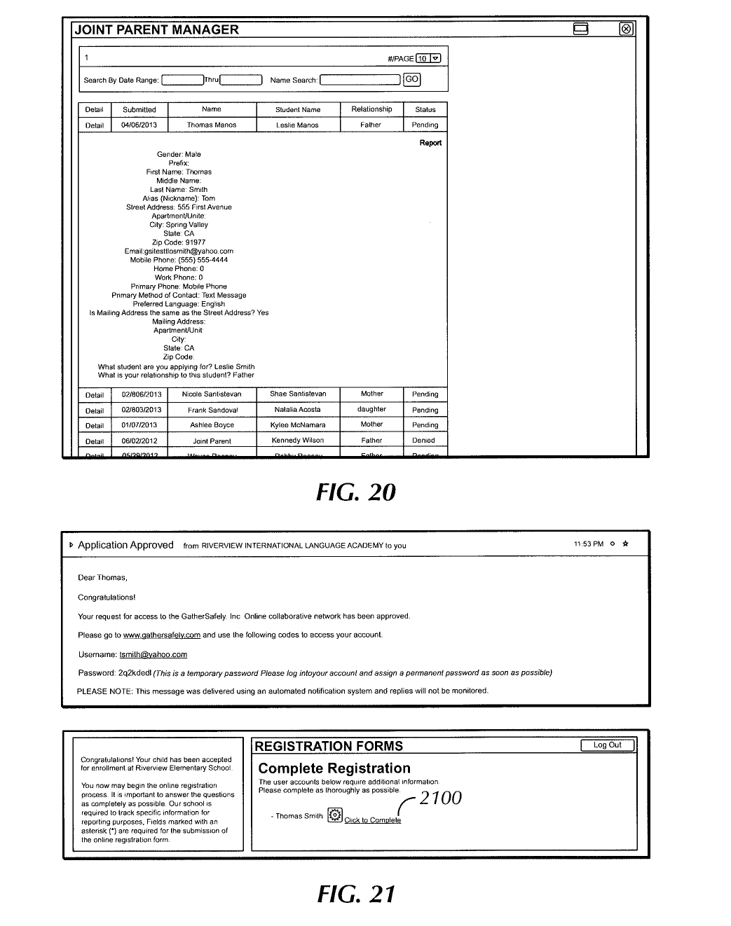

The information that was submitted is collected and displayed in the Joint Parent Manager interface under the School Administrator login (FIG. 20). Once the information has been reviewed, the School Administrator can change the setting of the registration from Pending to Approved or Denied. If the status is marked as Denied, then the School Administrator should preferably record a reason the request was denied. An auto-notification (FIG. 21) is delivered to the email that was entered into the request form. If the request status is marked as Accepted, then the Application Approved auto-notification is delivered to the email that was entered into the original request form. The content of each of these auto-notifications can be revised as needed by the School Administrator.

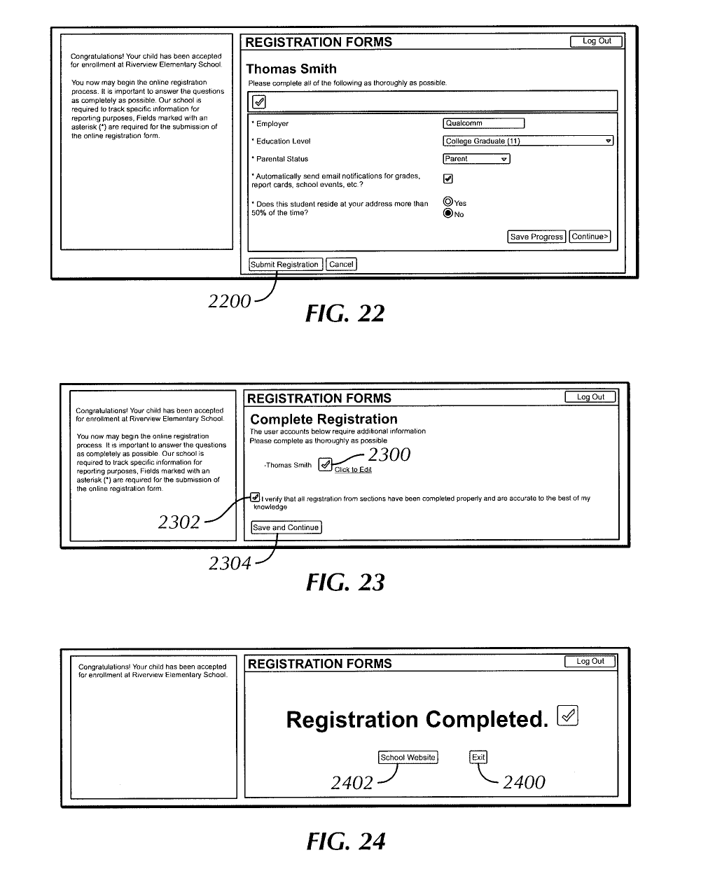

When a Joint Parent initially logs into their new account, the system prompts them to complete the registration process by entering additional information. The User clicks the Click to Complete link 2100 to view the additional registration requirements, which are entered by means of FIG. 22. Once the User finishes entering the required registration information, including employer, education level, parental status, message notification mode, and whether the student resides with the parent, they can click the Submit Registration button 2200 to proceed. The system takes them to the Registration Completion summary page of FIG. 23 and changes the ‘gear’ icon to a green checked icon 2300. The User should preferably check the disclaimer box 2302 and click the Save and Continue button 2304 to proceed. An on-screen confirmation message (FIG. 24) is displayed prompting the User to Exit (2400) the system or to go (2402) to the School Website.

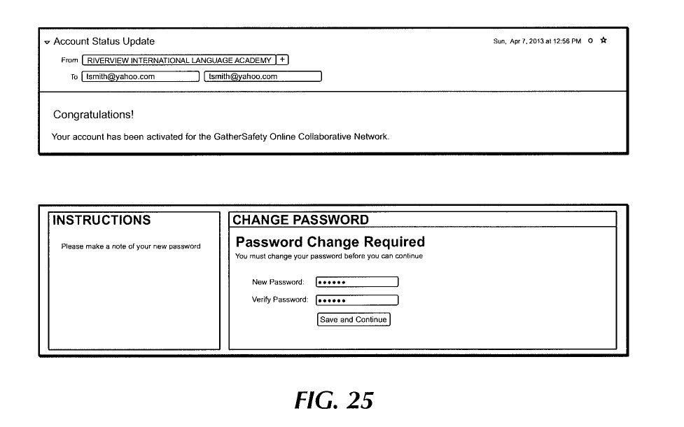

Once the School Administrator has activated the Joint Parent's account, a confirmation (FIG. 25) to the joint parent is delivered to the email address that was entered into the registration form. The School Administrator may revise the content of this message as needed. The Joint Parent may now access their account using their system-generated temporary password. The system will prompt the User to enter a permanent password upon their initial login. The User should preferably enter and verify their new password in FIG. 25 and click the Save and Continue button to proceed. They are then taken to their main Dashboard page.

### Dashboards

All Users that access the system are taken to their respective Dashboard upon the initial login. This is the main landing page and functionality is determined based on the access levels and permissions applied to the specific role of the User.

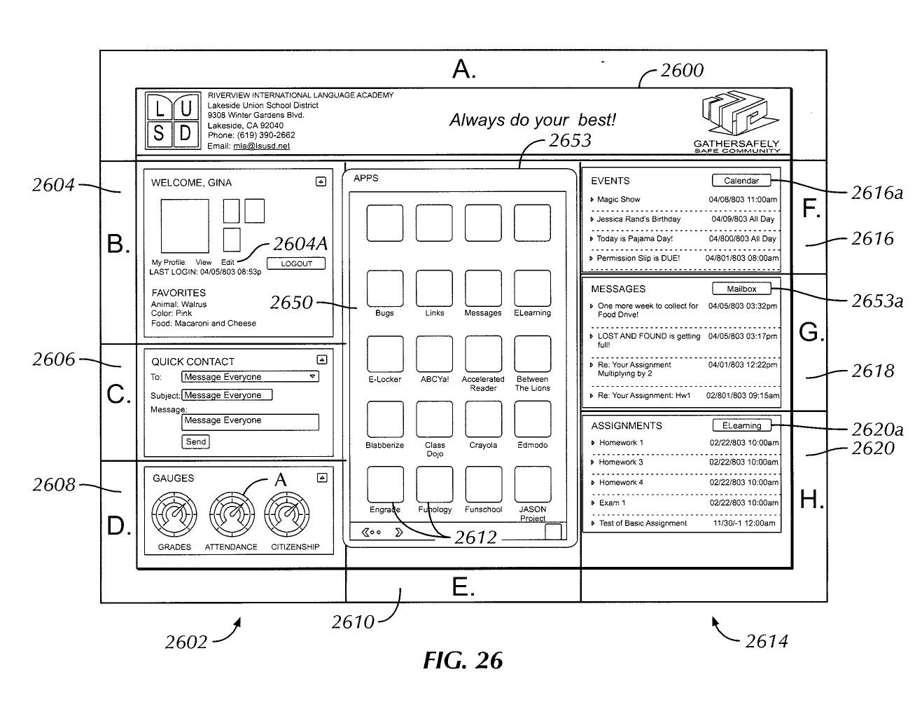

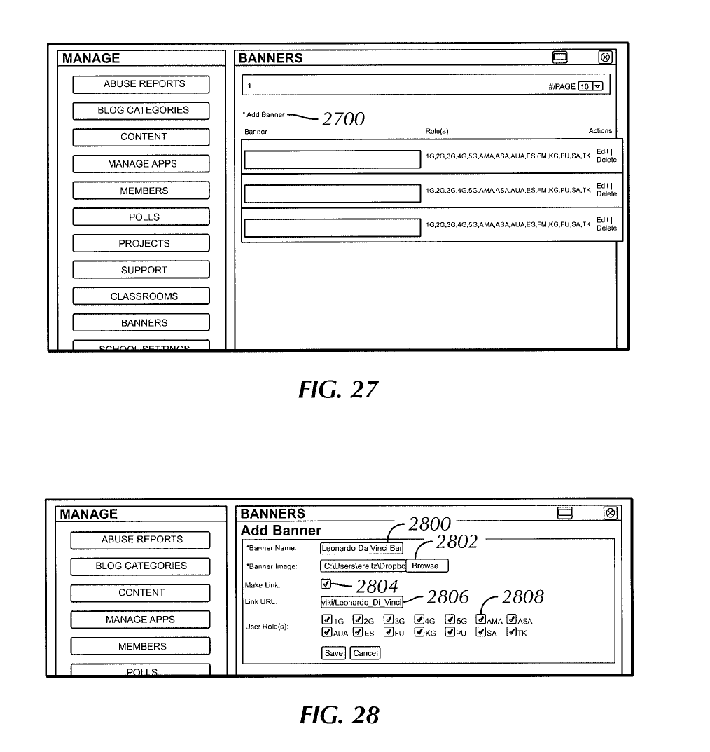

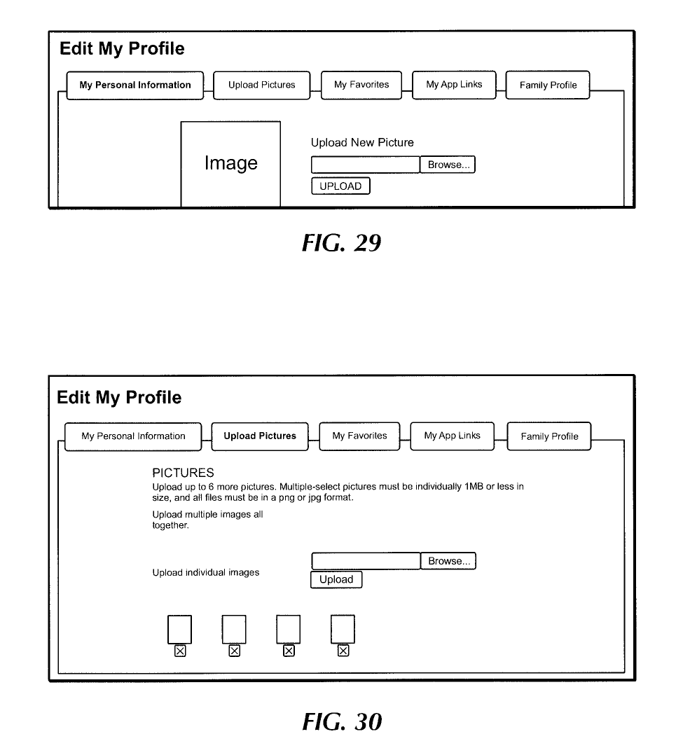

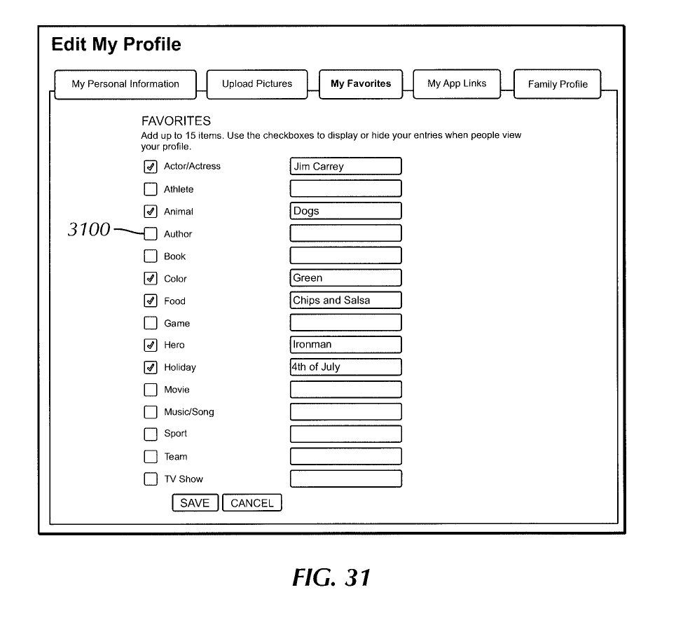

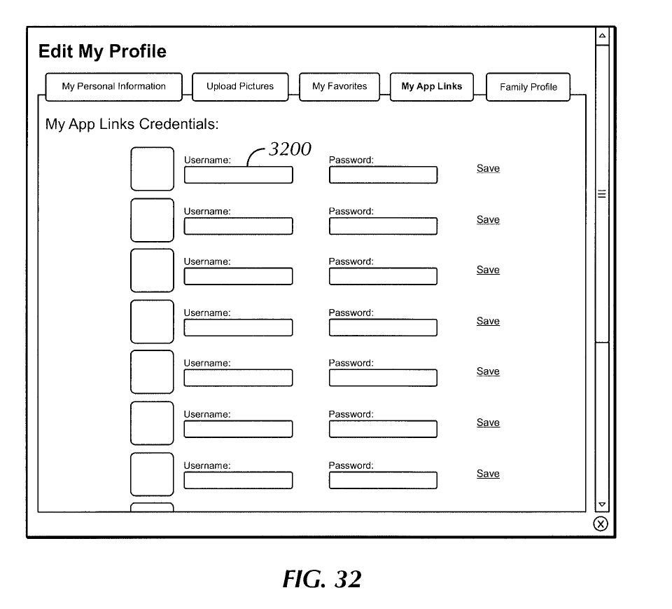

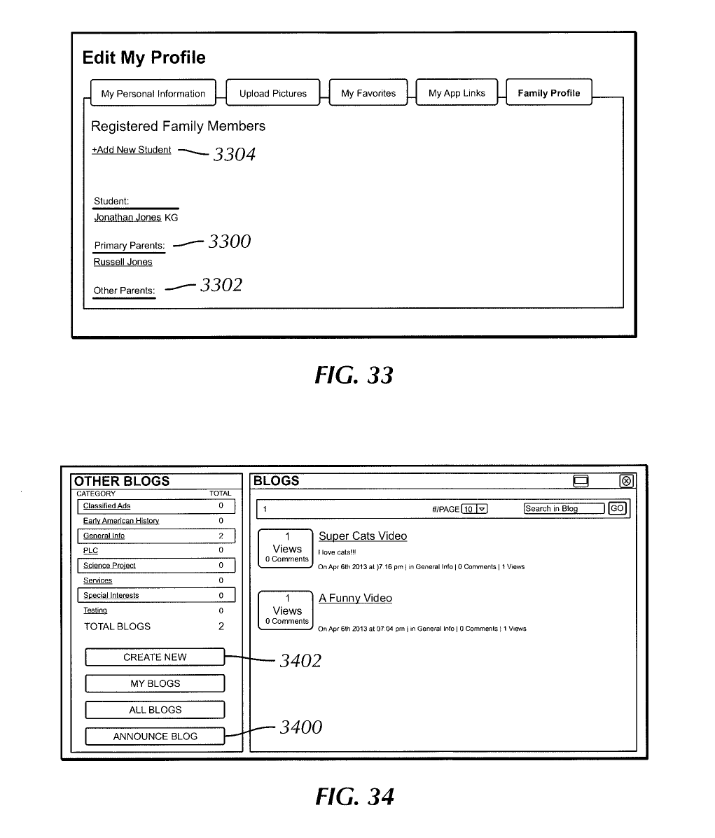

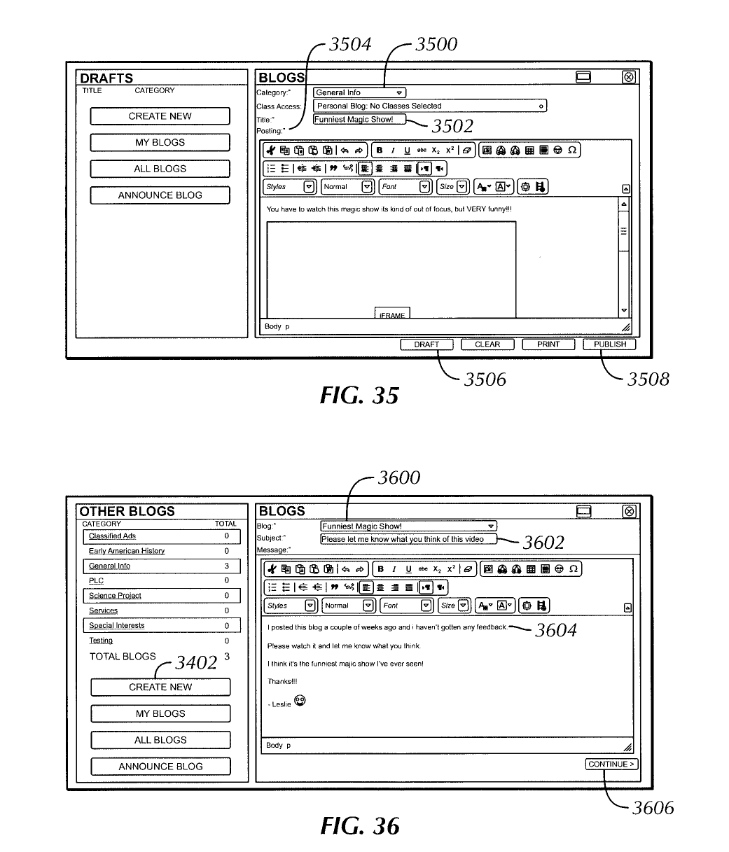

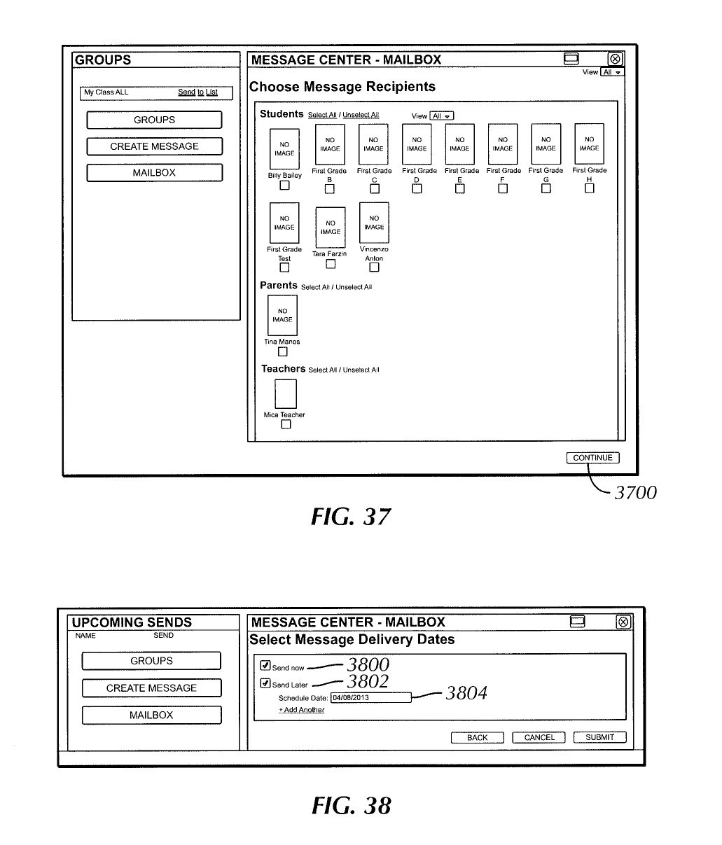

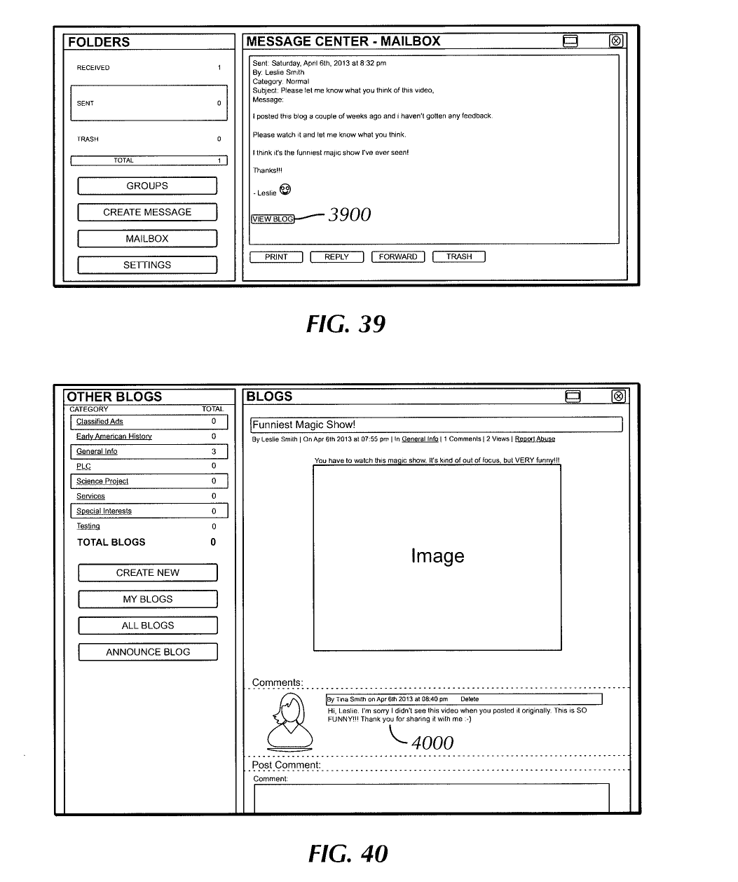

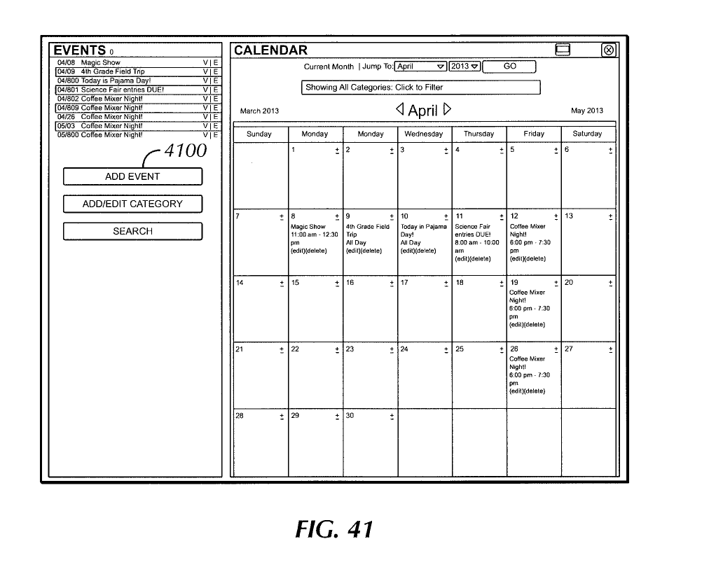

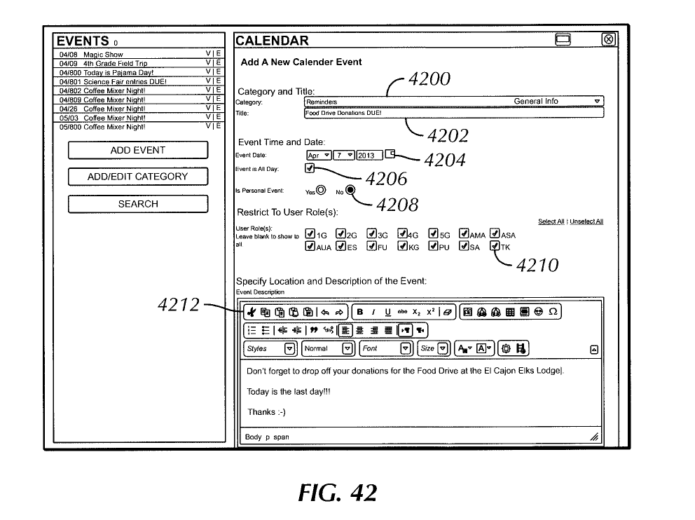

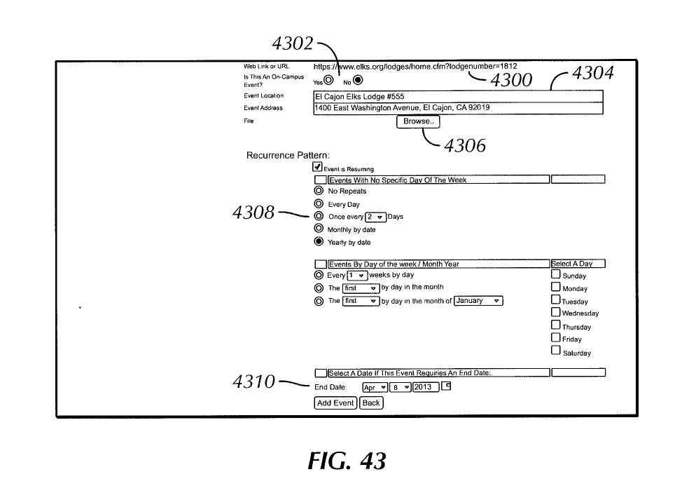

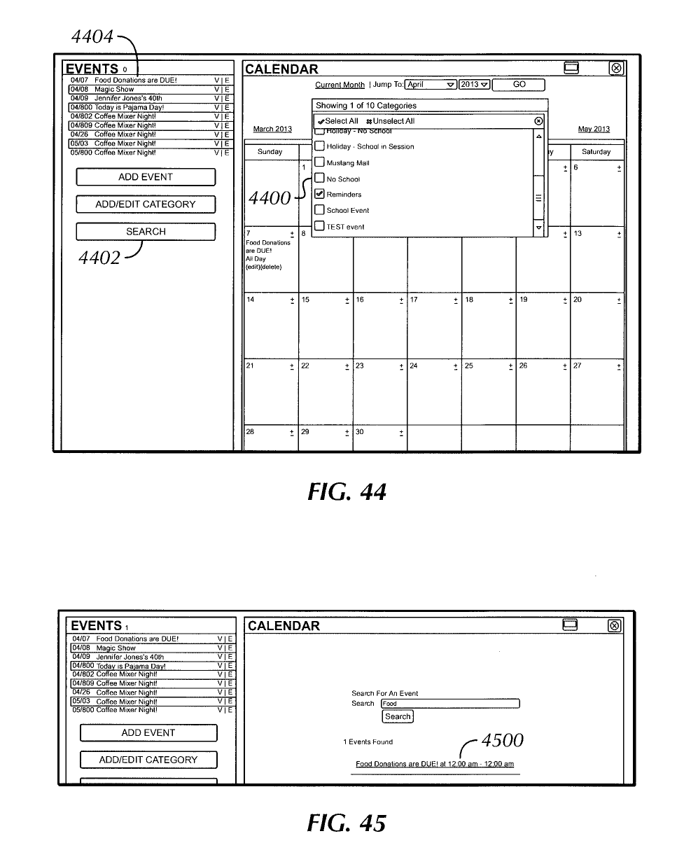

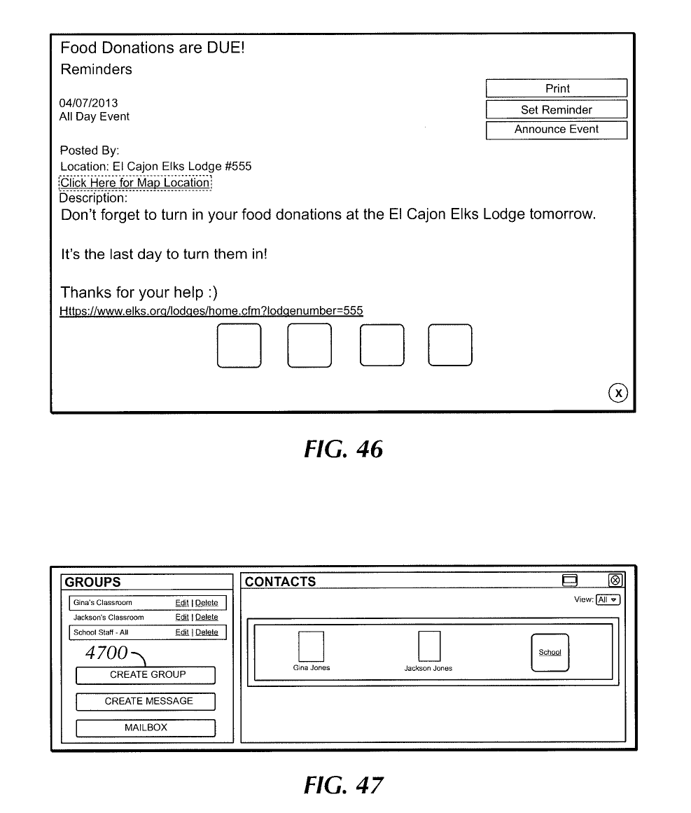

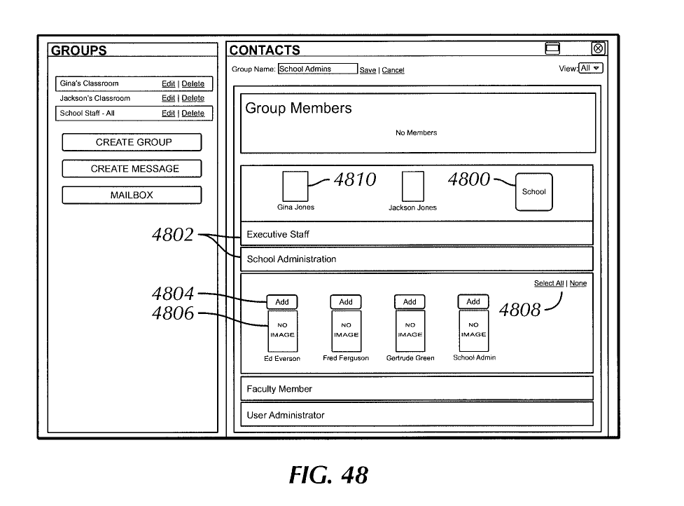

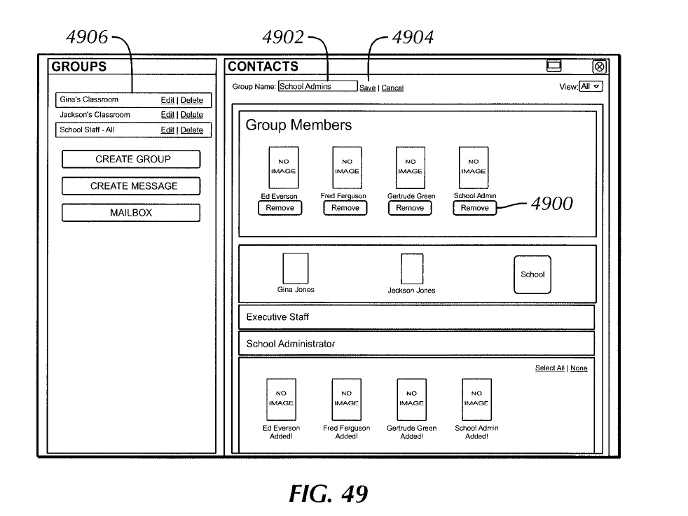

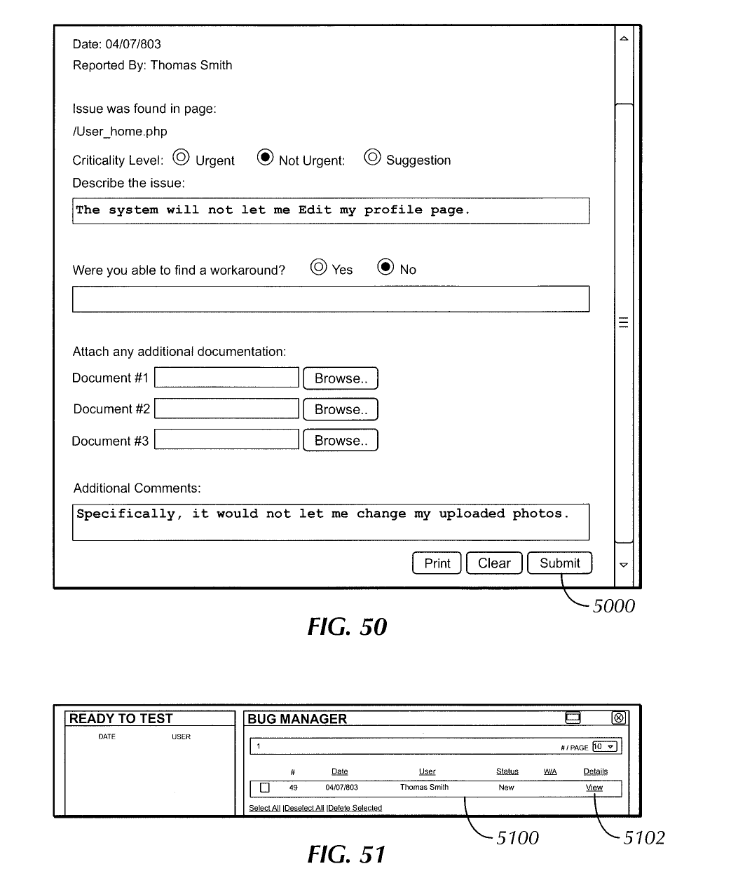

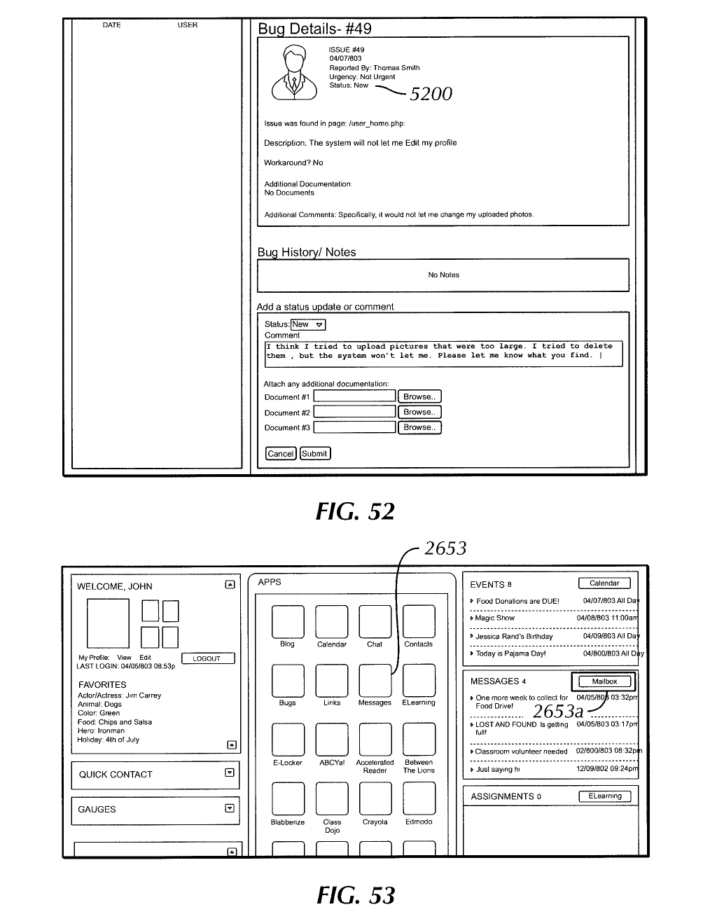

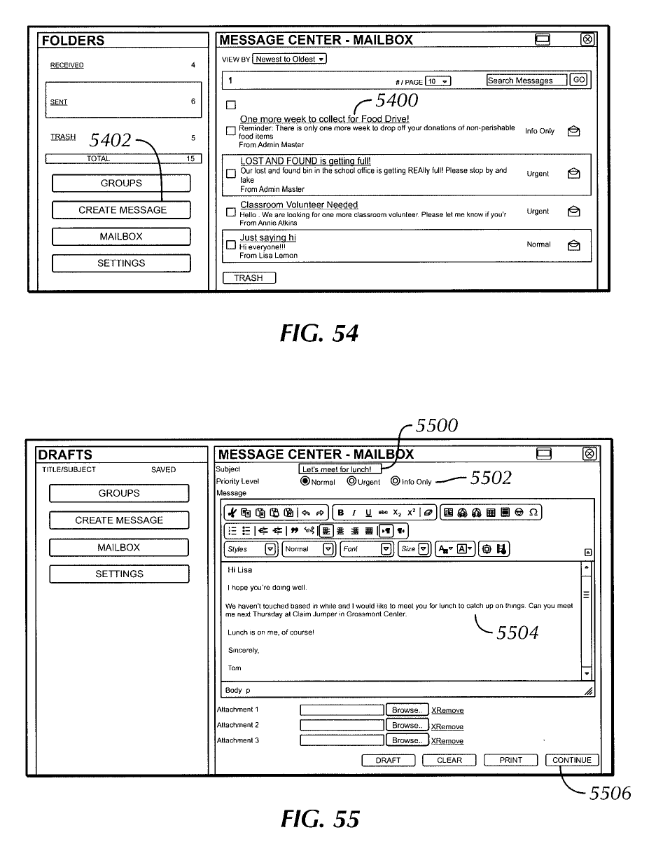

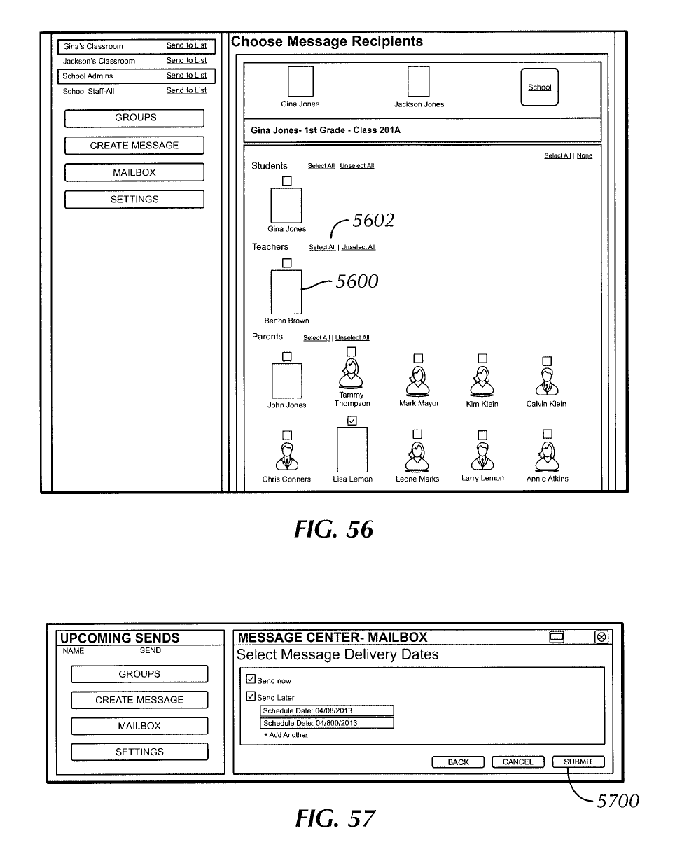

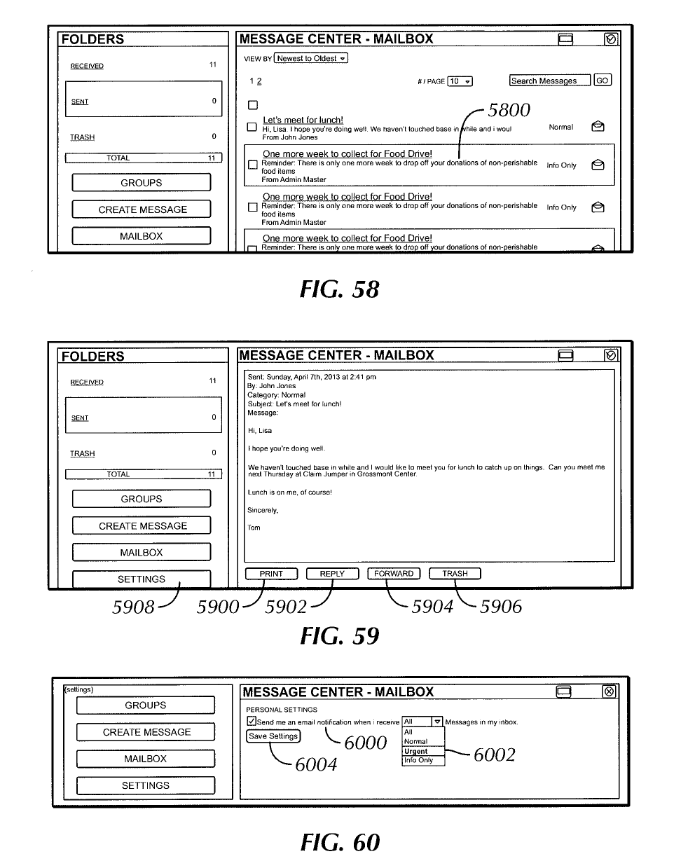

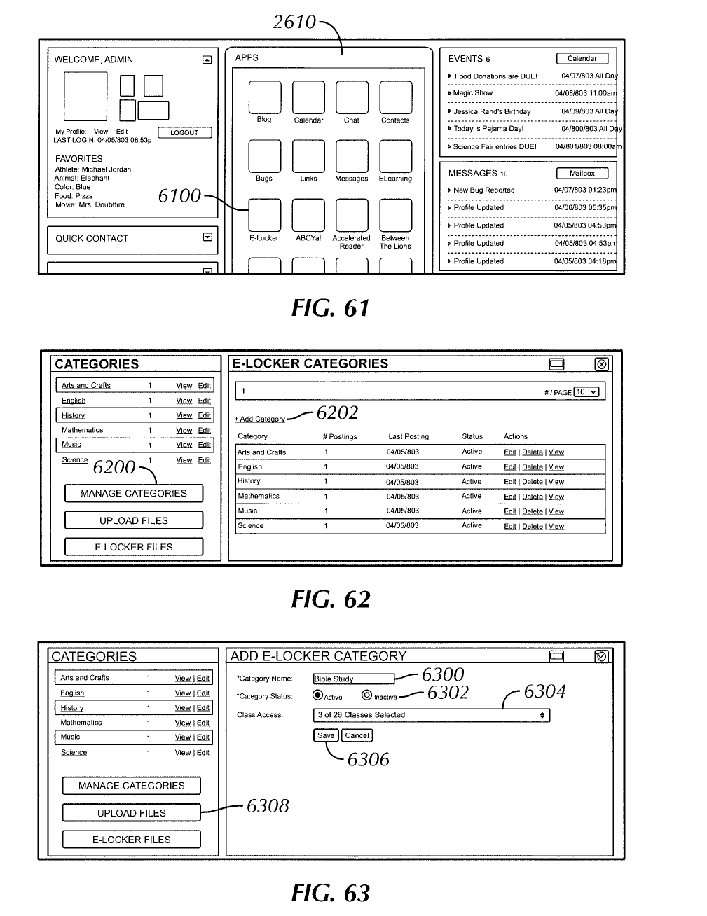

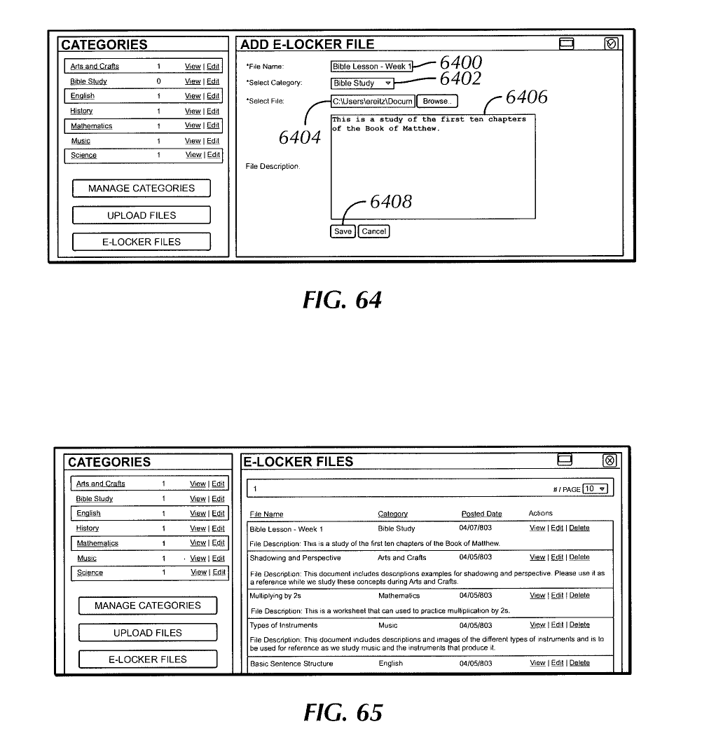

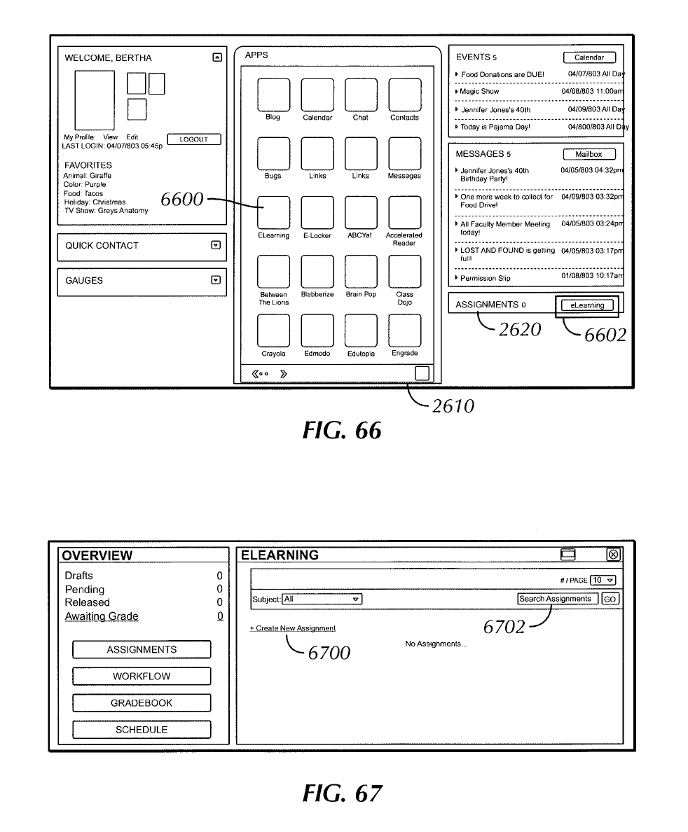

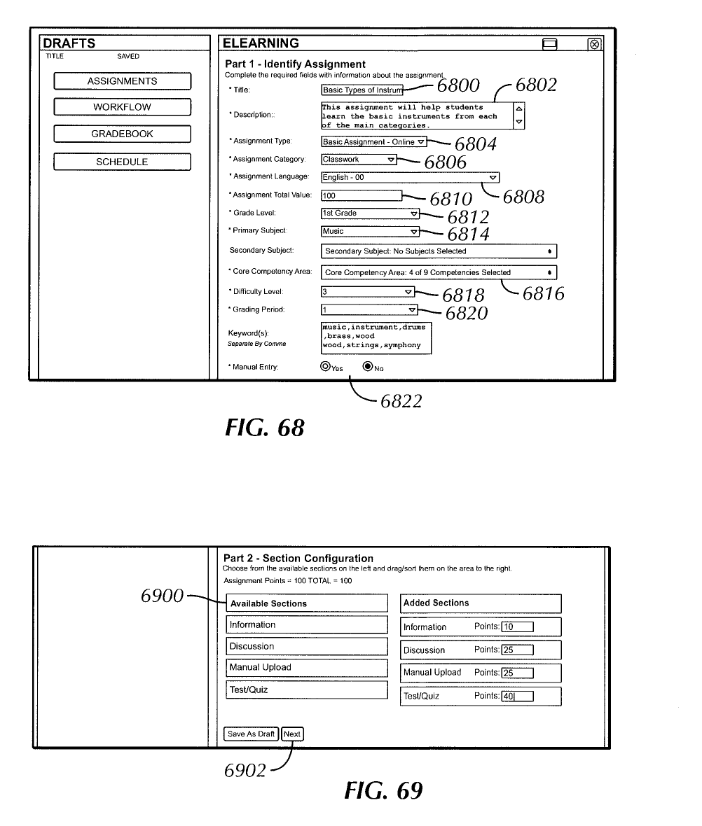

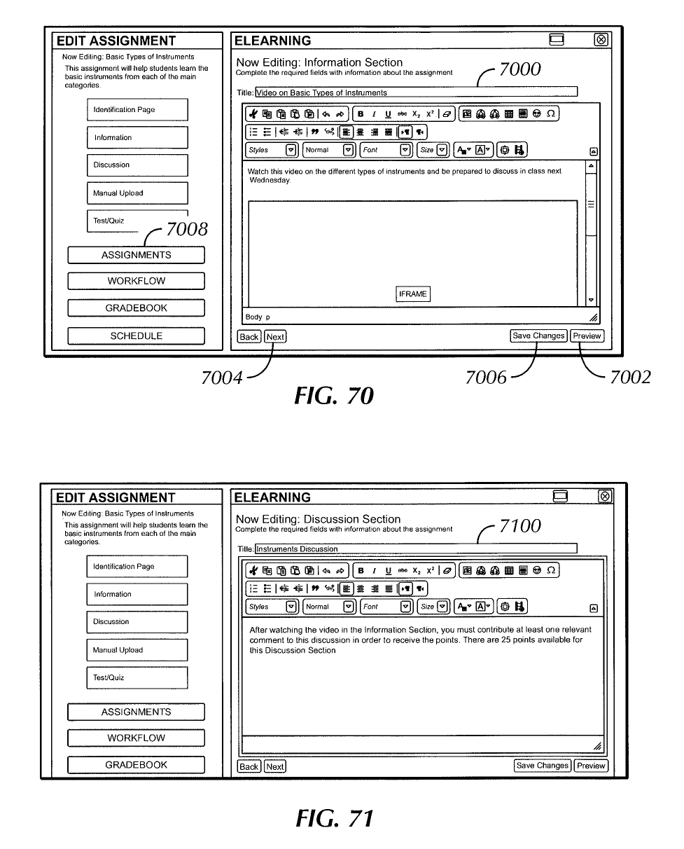

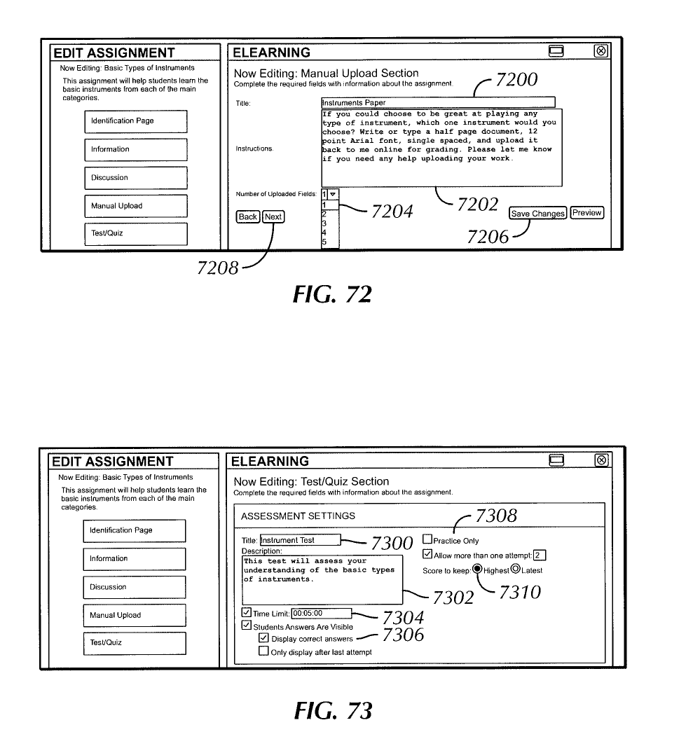

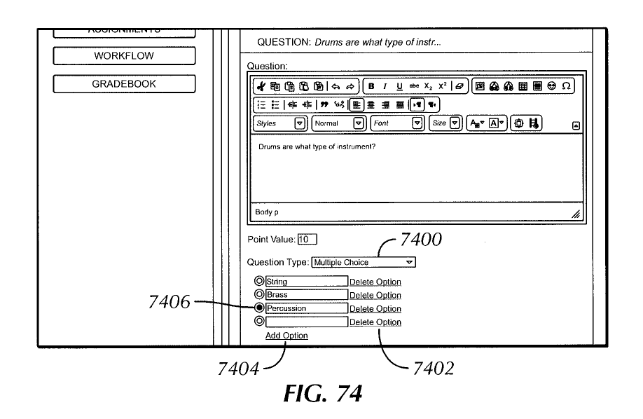

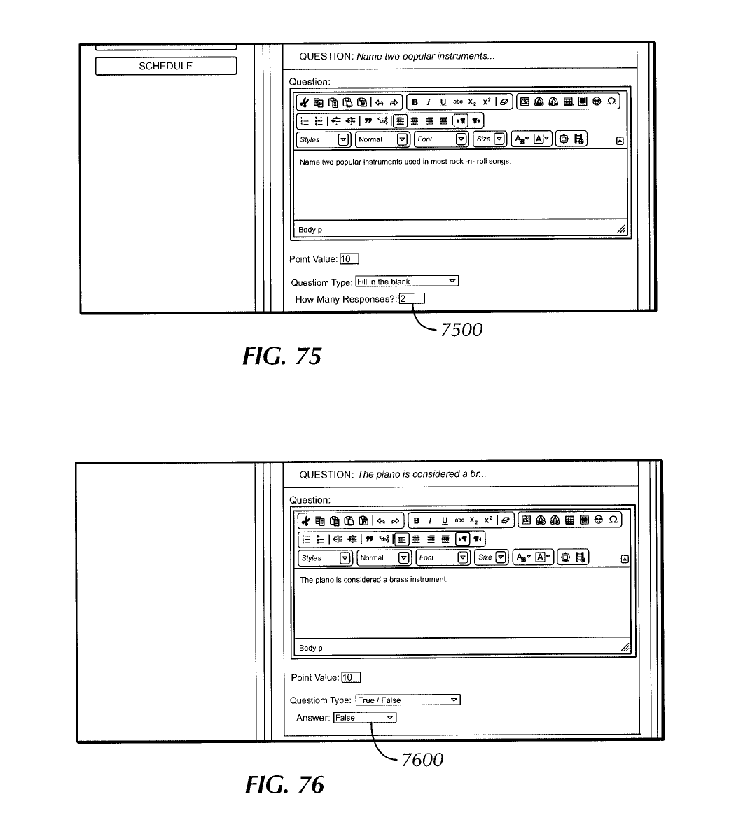

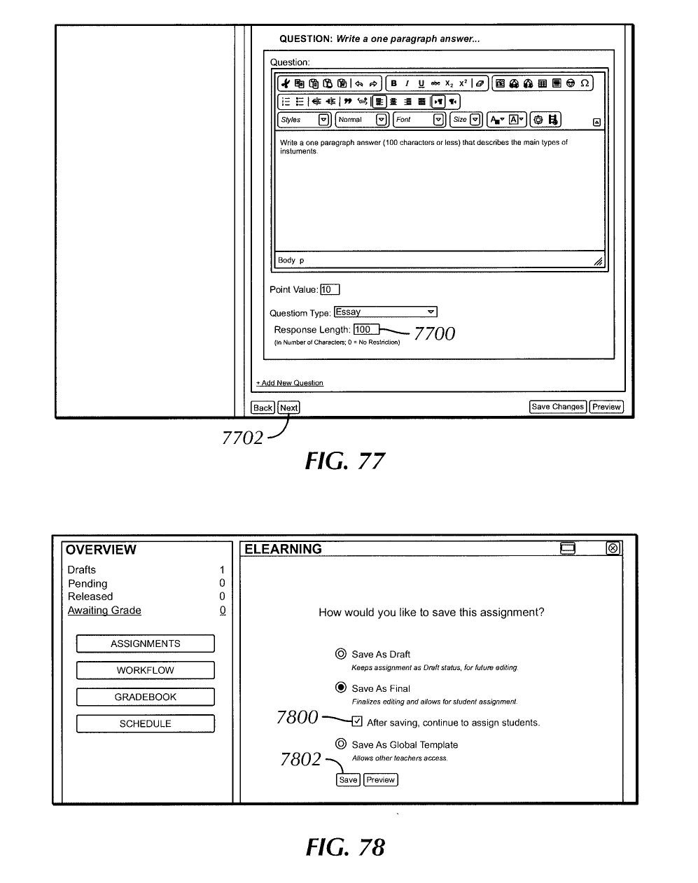

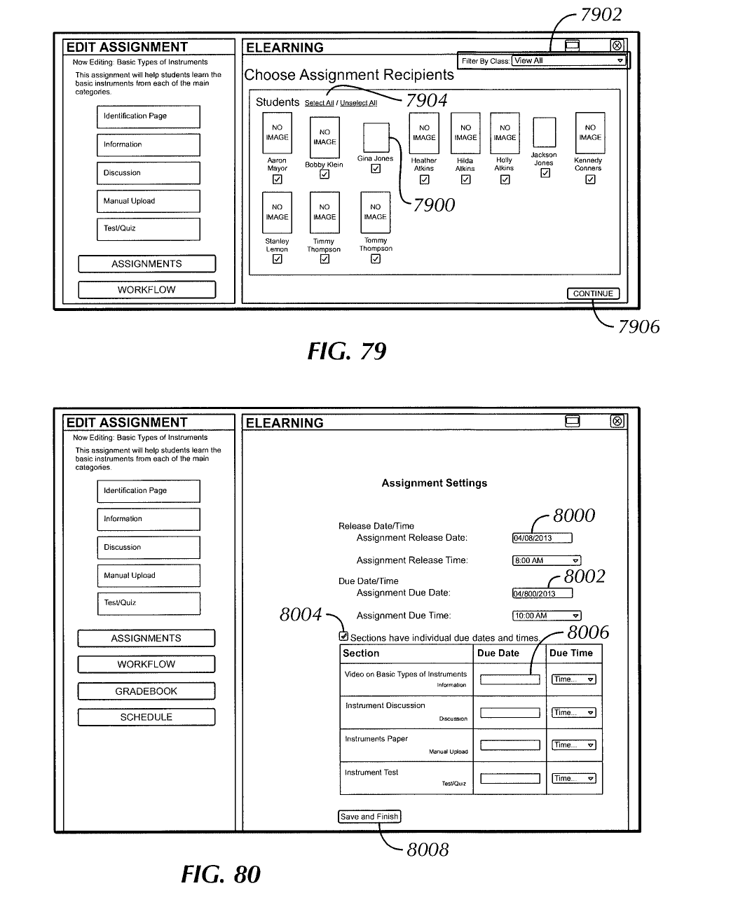

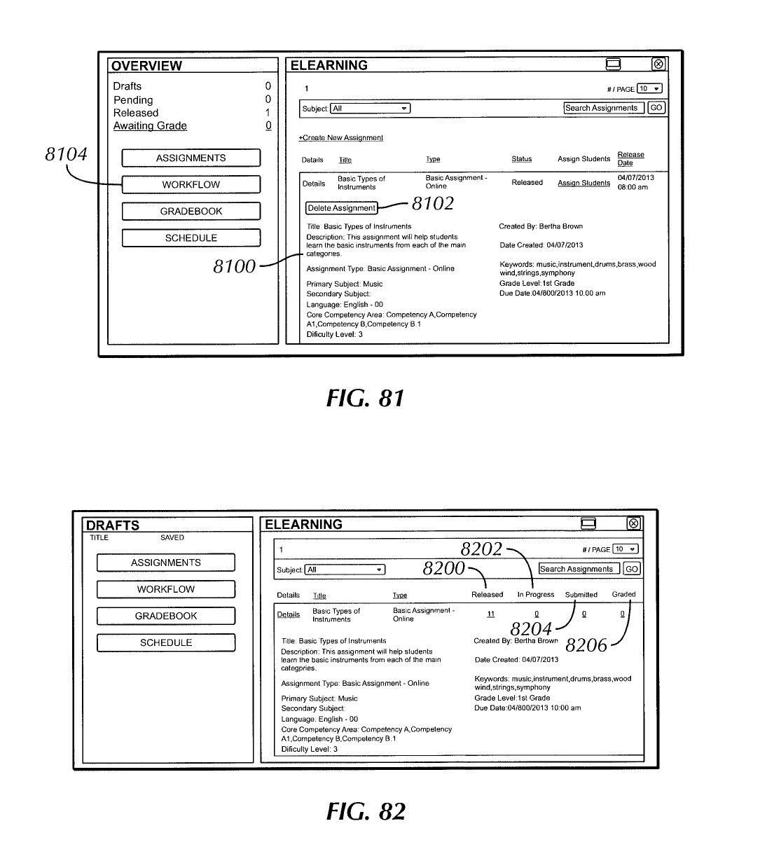

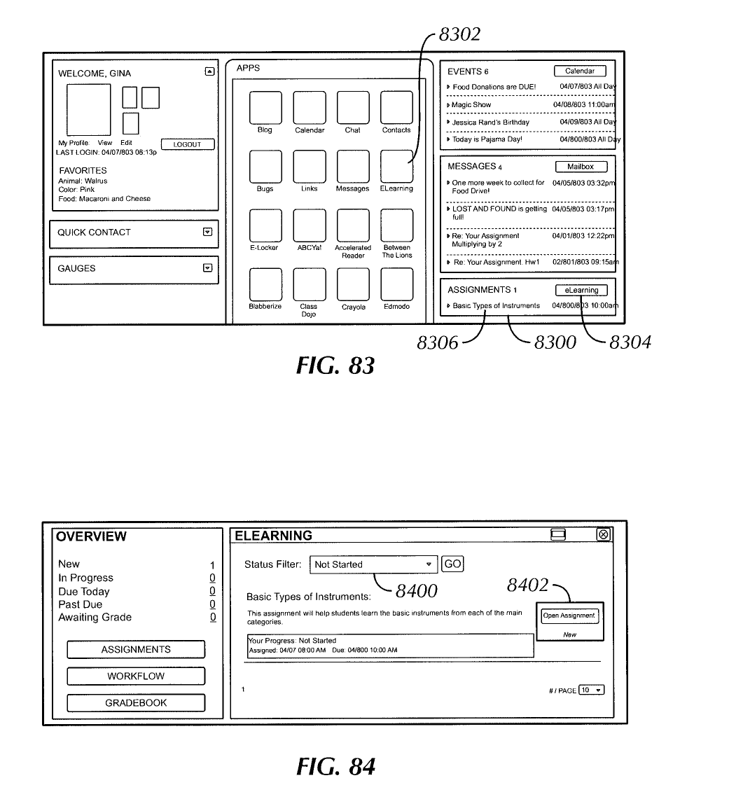

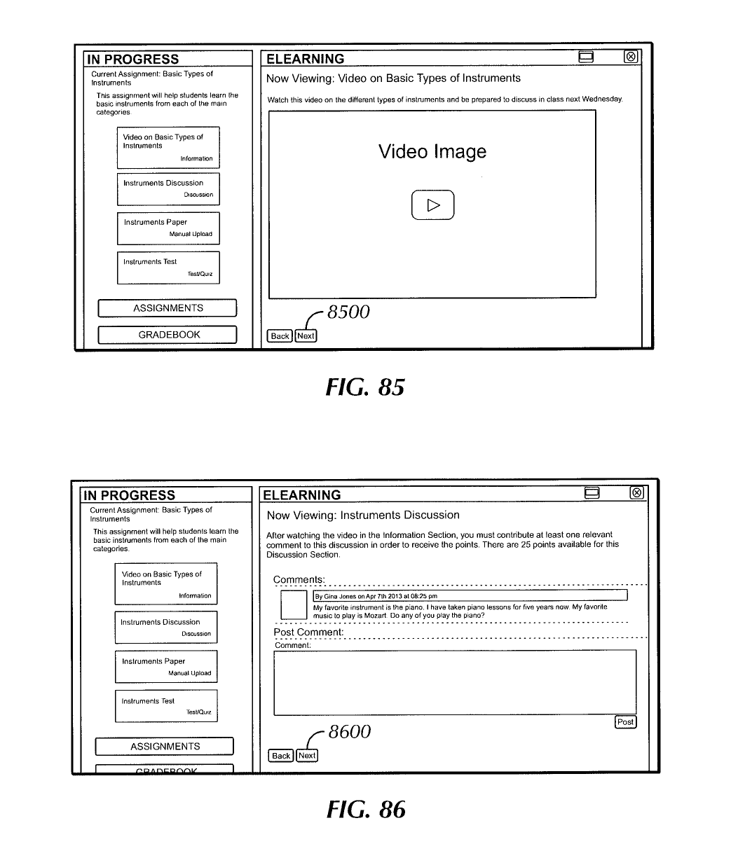

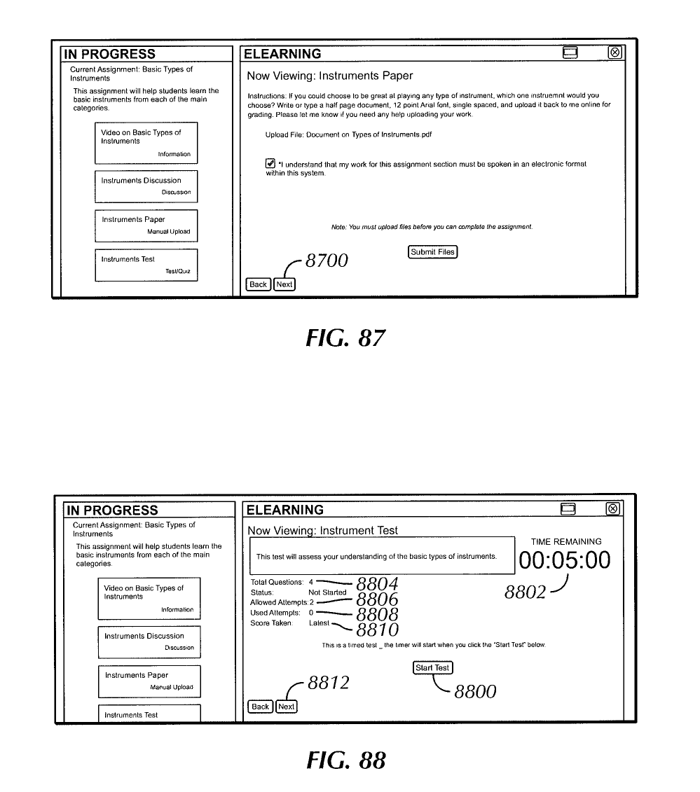

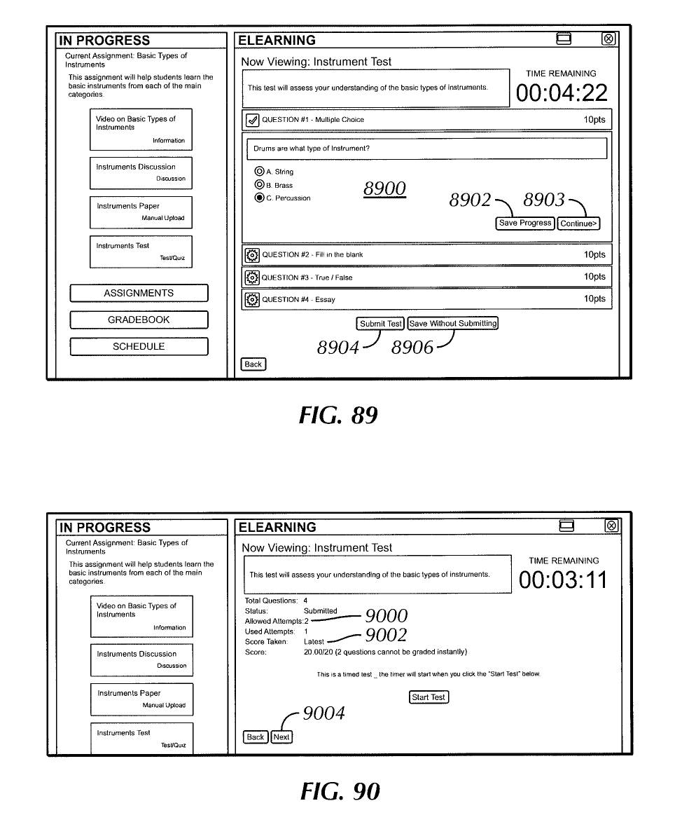

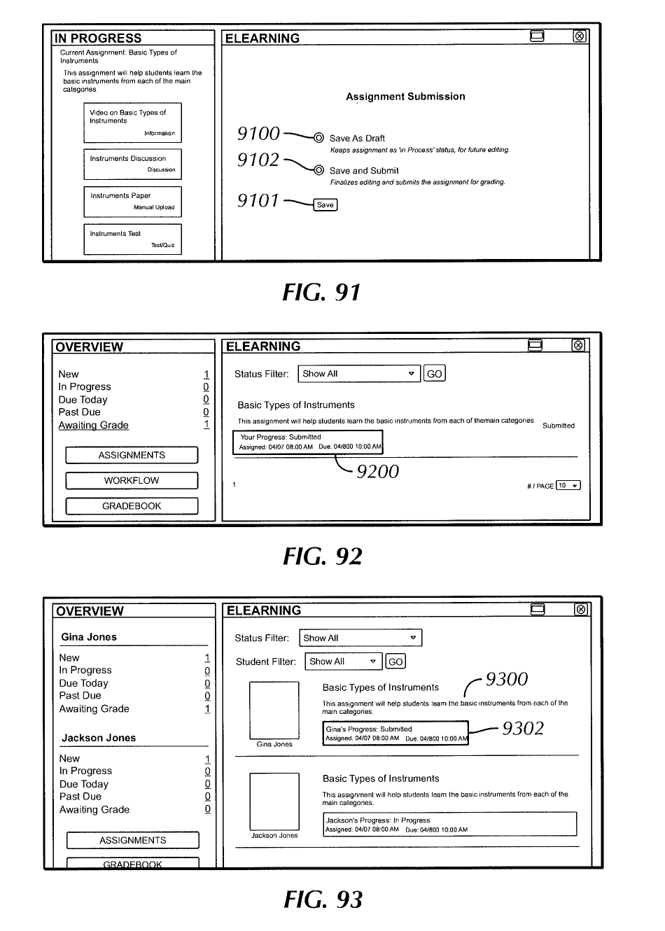

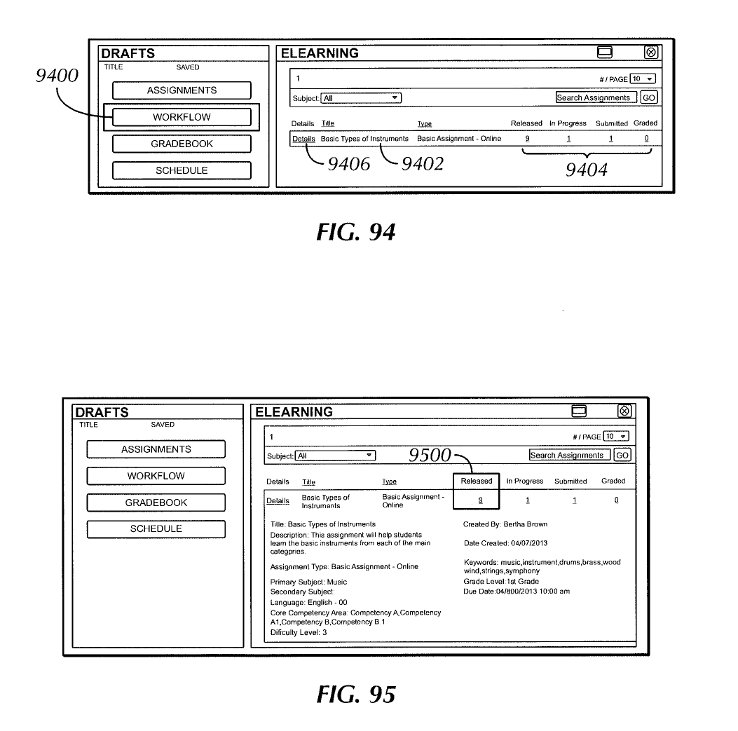

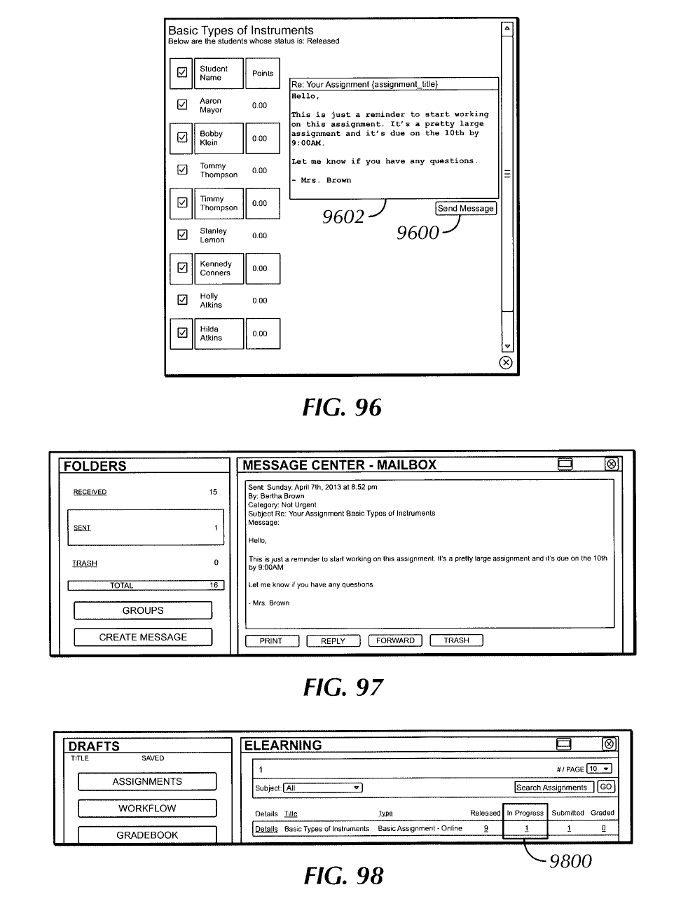

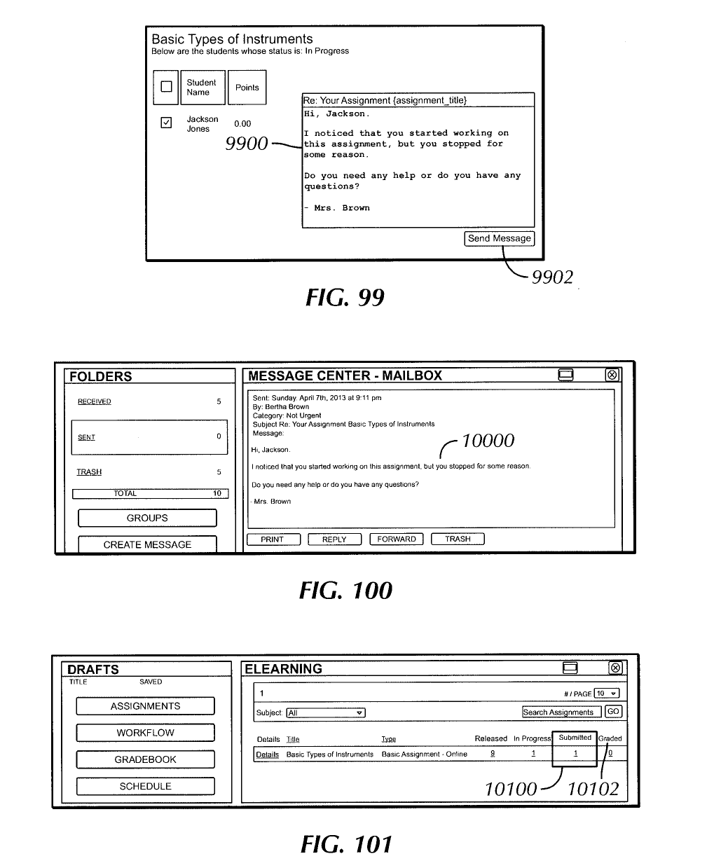

FIG. 26 shows an example dashboard, which includes a custom top banner section 2600 that is fully controlled by System and Master Administrators, and banner content visibility is limited by the permissions and access levels assigned to each individual User role type.

Note that while the dashboard shown in FIG. 26 has the same general appearance regardless of whose computer (student, teacher, parent, administrator, etc.) it is displayed on, depending on the role assigned to the particular user the functionality of the dashboard can differ from other user roles. The above comment regarding the banner is but one example. Other differences in functionality are explained further below. Thus, a user's computer, when programmed according to present principles, is programmed to execute the particular functionality of the dashboard according to the role of the user as established during account set-up described further below. Having a common dashboard appearance with differing role-based functionalities provides a unified interface to the online community of an enterprise, while affording functionality that is appropriate for the particular user depending on the user's assigned role.

A dashboard also includes a first column 2602 of sections. In the embodiment shown, the first column is on the left hand side of the screen. A first section 2604 in the first column is a personal profile section configurable to contain personal information associated with a user of the display, while a second section 2606 is a contact section configurable to contain contact information pertaining to users in a closed group of users affiliated with the user of the display. This feature allows a User to send a quick text only message to one, some, or all of their assigned contacts without having to access the Message Center. Messages sent through the Quick Contact function are delivered to the Inbox of the recipient(s). If a recipient replies to the sender, the reply will be delivered to their Message Center message inbox.

Yet a third section 2608 is configurable to present indications such as gauges of academic performance of the user of the display. Data is compiled and displayed visually within visual gauges in the example shown. This is only applicable for data that is stored directly inside the system. It includes, but is not limited to grades, citizenship, and attendance.

A second column 2610, which may be a center section as shown, is configurable to present icons 2612 representing applications. One or more of the icons can be selectable to invoke respective web sites in a closed group of web sites. In one example, three (3) types of “Apps” may be available. The first is GSI Apps which are links to functionality that has been built directly into the system interface. These include Blog, Calendar, Contacts, Bugs, Manage, Messages, eLocker, and eLearning. A second type of app is API Apps which are links to functionality that has been developed outside the interface, but that has been “linked” directly within the interface through an Application Programming Interface (API). Yet a third type of app includes Linked Apps that are links to websites or systems available on the Internet. Outside systems that require password protected access can be configured within the interface for automatic login.

A third column 2614 of sections, in the example, a column on the right of the screen, can include a first section 2616 configurable for listing events by name and date associated with the user of the display. This is a quick view of up to five upcoming events from the Users calendar. There are three levels of events available within the shared calendar, including Global Events which can only be created by School Administrators (SA) and are visible on the calendars of all Users in the system, Shared Events which can be created by Executive Staff (ES), School Administrators (SA), and Faculty Members (FM) and can be visible to one, some, or all role types as indicated by the event creator, and Individual Events which can be created by each User within the system regardless of their role type. These events are only visible within the calendar of the event creator. This is only a quick view of some upcoming events in the User's calendar. The User can click the Calendar button 2616A to access the full Calendar interface.

A second section 2618 in the third column can be configurable for listing messages to the user of the display. This is a quick view of up to five of the most recent messages received by the User in their Message Center inbox. Urgent messages are displayed in red text. All other messages are displayed in blue text until the link is clicked. Once the link has been clicked by the User, it will be displayed in purple text. This is only a quick view of some of messages in the User's inbox. The User can click the Mailbox button to access the full Message Center interface.

A third section 2620 in the third column can be configurable to list work assignments of the user of the display. This is a quick view of up to five assignments in the User's assignment queue. The data displayed in this quick view is determined by the specific role of the User. Only selected assignments are displayed in this section of the User's dashboard. The User can click the eLearning button 2620A to access to full Learning Management System interface.

The following discussion reveals how the various sections in FIG. 26 may be established.

FIG. 27 is an example UI that can be used to create a banner and control, by user role type, who can see the banner. When a User clicks an add banner selector 2700, FIG. 28 is invoked. The User is required to enter a Banner Name into field 2800 and attach a Banner Image at 2802. They can also make the banner hyperlinked to an outside website URL by checking the Make Link box 2804 and entering a valid URL in field 2806. Linking banner images is not required. The User can also limit the visibility of the banner by User role type. In the example shown this banner will be visible to all role types by checking all boxes 2808 for all role types. The User could make the banner visible to the role type of FM by checking only the box next to FM in the User Role(s) section. Custom banners can transition every ten seconds by default to another banner.

FIG. 29 illustrates how each User can enter personal information, upload images, and manage access credentials in the profile section 2604 of the dashboard shown in FIG. 26 for linked sites within the Apps section 2610. Primary Parents are also provided additional functionality for managing their family unit. In order to manage their profile settings, a User can click the Edit text link 2604A under their picture in the main dashboard of FIG. 26.

As FIG. 29 shows, the User can upload 2902 a primary picture and select 2904 whether their first, middle, or last name is visible when other Users view their profile. All Users except for Students can also view or edit 2906 their primary email from this page. FIG. 30 allows the User to upload up to six additional pictures to their profile. Each picture should preferably be no greater than 1 MB in size and should preferably be in .png or .jpg format. The files can either be uploaded individually or all together simultaneously.

FIG. 31 is available for the User to enter their favorites in one, some, or all of the categories displayed. Once the User enters a value for a data field, they can check the box 3100 next to it to make it visible to other Users or uncheck the box next to it to hide it from other Users in the system. FIG. 32 allows the User to enter 3200 their login credentials for each of the Linked Apps available to them in the Apps section 2610 of their Dashboard of FIG. 26. Only Linked Apps that require login credentials are displayed here. If there are Linked Apps that do not require login credentials, they will not be visible in this page, but are still visible within the Apps section of the main Dashboard. Once an account has been created for a Linked App and the login codes have been saved into the User's profile, the User can click on the icon in the Apps section of their Dashboard and the user's computer will automatically log them in with their secure credentials. Auto login functionality can be implemented for an unlimited number of Linked Apps.

In contrast, FIG. 33 is only visible within the profiles of Students and Parental Units. It displays 3300 the Primary Parent, all of the Students, and all Other Parents 3302 within the family unit. Primary Parents also have the ability to register additional Students from this section by clicking on the Add New Student link 3304. This will take the User into the Interest Form registration process. The Quick Reg registration process is not available from this page.

As stated above, of the three types of applications available in Section 2612 of the dashboard in FIG. 26, one includes functions that have been built directly into the system interface. FIG. 34 illustrates one such built in app, namely, a blog, to which all User role types can be given access to them to post text, images, links, or videos, actively post and share content with friends and colleagues, give and receive feedback about items of interest, and proactively announce their blog to their contacts. What sets this Blog apart from many others is that the User can proactively promote the broadcast to one, some, or all of their connections using the announce selector 3400, which sends messages to the contacts in section 2604 of the dashboard notifying of the blog. Their connections are more likely to view their blog content and to provide feedback because they are colleagues, classmates, and co-workers. Other Users will also feel more comfortable to give their feedback because it's all done within the confines of their system community.

FIG. 35 shows that a User can create a new blog from FIG. 34 by clicking on the Create New button 3402 in the side menu. The system requires the User to enter 3500 a Category. The School Administrator can add, edit, or remove selections from the Category dropdown as necessary. The system also requires a Title 3502 and Posting 3504. A WYSIWYG content editor is provided that allows the User to add text, images, links, or videos. Once the User has entered the required information, they can either save 3506 their new Blog in draft format to finish at a later time or publish 3508 it now. Once they publish their Blog, they can edit or delete it at any time. A Blog can only be edited or deleted by the User that published it.

Recall that a user can announce a blog from button 3400 in FIG. 34. FIG. 36 shows that User can proactively broadcast their Blog content to one, some, or all of their assigned contacts within their school network. To announce a Blog, the User clicks the Announce Blog button in the side menu. The system requires the User to select 3600 one of the blogs they have already created, enter a message subject line 3602, and type in message body text 3604. As soon as the User has satisfied these requirements, they can click the Continue button 3606 to proceed to FIG. 37 to select one, some, or all of their school network contacts or they can send the message to a distribution Group list they created within the Contacts function. Once the User has selected the message recipients, they can click the Continue button 3700 to proceed to FIG. 38, in which the User can tell the system to send the message now 3800, to send the message at a later date 3802, or to send the message on multiple dates 3804 in the future. The User's message is delivered to the recipients' Message Center inbox of FIG. 39 that automatically includes a link 3900 at the bottom to view the blog. When the recipient clicks the VIEW BLOG text link, the system takes them to the Blog that was originally published.

FIG. 40 shows a screen shot allowing a user to respond to a published blog that the recipients could easily view as they became aware of it, and respond by posting a comment 4000 directly under the original Blog post.

Recall that a user can select the calendar button 2616A from the dashboard of FIG. 26, and if selected the screen shot of FIG. 41 is presented to show a Calendar which operates at a global, shared, or individual level depending on the access and permissions assigned by the system to each User role type. For example, School Administrators have the ability to post global events to all of the Users within the school community, while Students only have the ability to post individual events. Parents are given access to the events posted within the calendars of their Students. Once an event has been added to the Calendar, Users have the ability to announce the event posting to any of their assigned contacts or custom group lists. They can also tell the system to send a reminder to their email one, two, or three days before the event. Calendar events can also be saved directly into Outlook, iCalendar, Yahoo, and Google. Events cannot be imported from other calendars into the calendar interface for safety. Only event creators have the right to edit their Calendar entries. If another User attempts to edit an event they did not author, the system displays an on-screen message to let them know they do not have this permission.

If a user selects the add events button 4100, the screen shot of FIG. 42 can appear. The UI of FIG. 42 prompts the user to select an event category from field 4200, enter an event title in field 4202, select an event date from field 4204, and to indicate whether or not the event will be all day (field 4206). System Administrators should preferably also indicate whether or not the event is a Personal Event (input 4208). If it is, the event will only be displayed in their Calendar. If it is not, then they should preferably indicate which User role type(s) will be able to view it in their Calendars using checkboxes 4210. Faculty Members likewise should preferably also indicate whether or not it is a Personal Event. If it is, then the event will only be visible in their Calendar. If it is not, then they should preferably indicate which of their classrooms will be able to view it in their Calendars.

The Event Description is entered into field 4212 using a WYSIWYG content editor which allows the User the flexibility of entering text, attaching images or hyperlinks, or embedding video content.

The next section of the Add A New Calendar Event form (FIG. 43) prompts the User to enter a web link for the event at 4300. The User should preferably indicate whether or not the event will be on campus at check box 4302. If it is an off campus event, then the User can enter an Event Location and Event Address into field 4304 and the system will include a map link within the event summary page. The User may also upload a related document such as an event flyer, permission slip, or meeting agenda using browse selector 4306. The User should preferably also indicate whether or not the event is recurring. If it is, the User can select the exact frequency that the recurring event will occur (check boxes 4308). Once the Add Event button is clicked, the event item(s) is/are visible in the Calendar.

Only event authors have the permission to edit events. Revisions made to a recurring event series can be applied to one instance of the recurring event or to all of the instances within the series. Finally, the User can select an Event End Date (4310) if they would like to discontinue the recurring event series as of a particular date in the future.

FIG. 44 illustrates that if a User's Calendar is too full of events or if they are looking for a specific type of event, they can filter the events displayed by one or more of the available categories by checking the appropriate checkbox 4400. The User can also use the Search function by clicking the button 4402 in the side menu and entering a search keyword. The system will return the results of all event items that include the keyword(s) in the Event Title field 4404. FIG. 45 shows that the User can click on the Event Title 4500 to access the Event Summary Page shown in FIG. 46, which displays all of the information about the selected event including, as shown in the example, the event date and times, the location (along with map link for the User to click and see a Google map), an event description, a web URL, and a document attachment if applicable. The User can 1) print the event summary, 2) set a reminder to be sent to any email address one, two, or three days before the event, and 3) announce the event item to their assigned contact or custom Group lists. Furthermore, the details of the event can also be imported into a Google or Yahoo calendar, Microsoft Outlook, or iCalendar. The User clicks the appropriate icon and save the event to their other calendar(s) as necessary. Events may be prohibited from being imported from other calendars into the system calendars shown in the figures.

Now referring to FIG. 47 to amplify on the contact section 2606 of the dashboard shown in FIG. 26, each User role type is assigned a specific set of acceptable Contacts within their online community. Access permissions can include:
Students—Can interact with their family, their classmates, and the school staff members, and preferably no other members of the online community provided for an enterprise (e.g., a school or school district) provided by the system.
Parents—Can interact with their Students, their Students' teachers, and the school staff members, and preferably no other members of the online community provided for the enterprise (e.g., a school or school district) provided by the system. NOTE: The access of Joint Parents to other Users within the default Parent group may be subject to limitations.
Faculty Members—Can interact with their Students, their Students' parents, and the school staff members of the online community provided for an enterprise (e.g., a school or school district).
School Administrators, Executive Staff, User Administrators, System Administrators, and Master Administrators—Can interact with all Users within the online community provided by the present system for the particular enterprise (e.g., a school or school district).

A User can create custom Group lists by clicking on the CREATE GROUP button 4700 in the side menu. This will take the User to the Group Manager page of FIG. 48. The User can select an entire group of one specific role type or individual contacts from within a role type. For example, a Parent may want to create a Group distribution list that includes all of the School Administrators. From the initial page, the Parent User clicks on the School icon 4800. The system then displays each of the role categories (selectors 4802) the Parent has been assigned within the school community. There are four individuals under the School Administration category. The Parent User could either select individual School Administrators by clicking the Add button 4804 above their image icon 4806 or they could select all of them by clicking the Select All link 4808 in the upper right corner. The selections are then moved into the Group Members box 4810. FIG. 49 shows that a Parent User can remove any of the selected Group members or add any additional Group members from any of the other assigned contacts contained within their Contact interface by selecting a “remove” button 4900 for the particular contact sought to be removed. Once the User is satisfied with their Group member selections, they should preferably enter a Group Name into field 4902 and click Save 4904. All of the User's saved Groups are displayed in the upper left portion 4906 of the Contact interface. The User's Groups are available any time they are attempting to distribute content from their Blog, Calendar, or Message Center.

In many if not all of the UIs of the system, a bug report selector (titled “report issues”) may be presented, e.g., in a footer of the UI or through a bug icon 2650 in the apps section 2610 of the dashboard shown in FIG. 26, that can be selected to post issues or bugs directly inside their account, which brings up the bug report form of FIG. 50. As shown in the form, the system collects the date, the name of the User reporting the bug, and the specific URL the where the issue was located. The User may also describe the details of the issue, indicate whether they were able to find a workaround, upload up to three files of supporting documentation, and add any additional comments.

Once the User clicks the Submit button 5000, the form data is delivered into the Bug Manager interface of FIG. 51 and the issue is added to a work queue indicated at 5100. Responsive to a selection of a VIEW link 5102 under the Details column, the UI of FIG. 52 is presented in which the details of the report can be seen. The User can view the information they entered in the Bug Entry Form, view any history or notes, or add a status update or comment. As shown at 5200, available status options are New—new issue related to original bug, Test—results only for bug fix that was tested, Hold—status of the bug fix test is on hold, Fail—bug fix failed testing, or Fixed—bug fix passed testing. All bug fixes posted by the User that are ready to be tested are listed in the left side of the page. Once the issue has been resolved, the User can delete the record from their work queue.

Now referring to FIG. 52 to amplify on the message center section 2618 of the dashboard shown in FIG. 26, each of the Users within the enterprise community is given access to a private messaging system. This provides them with all of the functionality of a web-based email system like Yahoo or Gmail, while protecting them from spammers and other potential dangers or threats associated with email messaging on the Internet cloud. The enterprise system forwards internal messaging to outside email addresses if indicated for adult Users only. If an adult User activates message forwarding, they will be sent to the email address recorded in the User's system account. Student Users are not allowed to activate message forwarding.

To access the Message Center shown in the UI of FIG. 54, a User can either click the Message icon 2653 under the Apps section 2610 of the dashboard shown in FIGS. 26 (and 53), or click the Mailbox button 2653A in the messages section 2618 of the dashboard. All messaging that is delivered to the User from within the enterprise online community system is collected in the Inbox 5400 (FIG. 54) of the Users message center. Messaging can be received from the following: blogs that have been announced to the User, messages sent to the User through the Quick Contact function, messages sent to the User from within the eLearning assignment manager, and messages sent to the User from within the Message Center.

Bearing in mind that contact settings have already been established, users can only send messaging to assigned contacts. Accordingly, the User can click the CREATE MESSAGE button 5402 in the side menu of FIG. 54 to bring up the UI shown in FIG. 55, which is a New Message Form. The system prompts the User to enter a Subject into field 5500, select a priority level using a checkbox 5502, and to enter body text content into field 5504. The WYSIWYG content editor enables the User to enter text, attach images or hyperlinks, or embed videos. The User may also upload up to three file attachments. The user can click the Draft button if they wish to finish creating their message at a later date. Once the required information has been entered, the User can proceed by clicking the Continue button 5506 to invoke the UI of FIG. 56 to allow a selection of the recipients of the message by clicking on one more contact icons 5600 and/or group selectors 5602. As shown in FIG. 57 the system prompts the User to select when the message should be delivered. As shown, the user is permitted to select to send the message now, send the message now and at a later time, or send the message at a later time. The User can also select multiple dates in the future for the message to be delivered. The system will deliver the message on each day the User specifies within this section. Once the User has selected the delivery date(s) for the message, they can proceed by clicking the Submit button 5700. The message is then delivered to the recipients' message center inboxes.

FIG. 58 shows that if a recipient of a message clicks a message title 5800 in the recipient's inbox, the system presents the UI of FIG. 59 to display the message summary page. The message recipient(s) can print (selector 5900) the message, reply (5902) to the sender, forward (5904) the message to other Users within their enterprise online community, or send (5906) the message to their trash folder. If the User would like the system to forward their messages to an outside email address, they can activate first this function by clicking the SETTINGS button 5908 in the side menu. This invokes the UI of FIG. 60. The User can mark the checkbox 6000 and select the type of messages they would like forwarded from the dropdown menu 6002. Once the user clicks the Save Settings button 6004, the system forwards their internal messages to the email address attached to their system account. Note that preferably, the “forward” function is only available for adult Users. Student Users do not have permission to forward internal messaging to an outside email address. By only using the messaging functions inside the online community system, Students can learn how to properly utilize email functionality without being subject to the dangers and threats associated with general email systems on the Internet cloud.

As shown in the apps section 2610 of the dashboard shown in FIG. 26 and as repeated in FIG. 61, Users within an enterprise online community are given access to an eLocker file storage manager that is accessed by clicking an eLocker icon 6100 (FIG. 61) to invoke the UI of FIG. 62. At least one category should preferably be created in order to upload files. To create a category, the User should preferably click on the MANAGE CATEGORIES button 6200 in the side menu. This will enable selection of a +Add Category link 6202 to access the Add eLocker Category Form of FIG. 63. As shown, the UI prompts the User to enter a Category Name (6300) and to indicate whether or not the Category is visible (Active) or hidden (Inactive) using checkboxes 6302. If the User is a Faculty Member, they can also indicate which of their classes have access using selector 6304. If the User is a School Administrator, then they can indicate which of the classes within the school are allowed to access the category. Once the required information has been entered, the User can click the Save button 6306 to proceed. When at least one category has been created, the User can click an UPLOAD FILES button 6308 in the side menu to access the eLocker file upload page of FIG. 64.

Thus, looking at the UI of FIG. 64 the system prompts the User to enter a File Name into field 6400, to select an option from the Select Category dropdown menu 6402, and to select a file for uploading in field 6404. The User also has the option of entering a File Description in field 6406. Once the required information has been entered, the User can proceed by clicking the Save button 6408. The file is then uploaded into the eLocker interface of FIG. 65 and is available to the User to download as needed. When Faculty Members create categories and upload files, they are available to the Students in their classes. Parents of the Students in their classes can also access their categories and file uploads. The User that creates a category has the ability to edit the information they entered into the Add eLocker Category form. They can also edit or delete any of the files they upload into their eLocker. A User that did not create a category, but that can access it under their Categories list does not have editing permissions. Similarly, a User that did not upload a file, but that has access to the uploaded file in their eLocker does not have the permission to edit or delete that file.

Attention is now turned from messaging and the e-locker file to the learning feature of the example system facilitated in the assignments section 2620 of the dashboard shown in FIG. 26 and repeated for purposes of disclosure in FIG. 66. All Users within the GatherSafely system have access to a comprehensive and intuitive learning management system (LMS) known as eLearning. Regardless of their individual role type, all Users benefit from the functionality included within this module. As discussed more fully below, Teachers can create different types of assignments from scratch or from global templates, align assignment content with core curriculum standards, easily distribute assignments to individual students, to groups of students, or to entire classes, and assess student performance with online tests and quizzes. Teachers also can record and publish student grades for real time access and monitor and analyze student and class performance. Students can access and complete assignments online, easily collaborate with classmates on group assignments, deliver completed to teachers in digital format, and access test results and grades securely in real time. Parents can view status, progress, and due dates for student assignments, interact directly with teachers regarding student performance, and access test results and student grades securely in real time. Administrators can monitor and analyze class and teacher performance and distribute and administer quarterly block assessments to students. Administrators also can create global assignment templates that align with core curriculum standards, easily access critical data for tracking and reporting purposes, and minimize costs by using system that consolidates LMS components and streamlines the assignment process.

The primary driver of the eLearning LMS is the Teacher. Faculty Members can access the interface by clicking the eLearning icon 6600 in the Apps section 2610 or the eLearning button 6602 in the Assignments section 2620. As shown in FIG. 66 (and FIG. 26) both of these selectors are located in the main Dashboard. When a teacher selects one of the above-mentioned selectors, the UI of FIG. 67 appears which illustrates the main page of the Teacher's LMS interface.

As shown in FIG. 67, the Teacher can click the +Create New Assignment link 6700 to begin building a new assignment. Upon clicking the link, they can select whether they would like to build their assignment from scratch or from a template (from a drop-down selector 6702) that has been saved in the global archive with the enterprise's online community.

If the Teacher selects to start from scratch, then the system takes them to the UI of FIG. 68 to create the assignment. The system requires the User to enter a Title into field 6800, a Description 6802, an Assignment Type 6804, an Assignment Category 6806, an Assignment Language 6808, an Assignment Total Value 6810, a Grade Level 6812, a Primary Subject 6814, a Core Competency Area 6816, a Difficulty Level 6818, and a Grading Period 6820. They should preferably also indicate whether or not the assignment is Manual Entry by selecting one of the checkboxes 6822. If Yes is selected, then the remaining functionality in the LMS is bypassed and the assignment is moved into the GradeBook for manual entry of points and grades. If No is selected, then the UI of FIG. 69 appears.

Using the UI of FIG. 69 the User drags and drops sections into the Added Sections column 6900 and assigns points for each one. Once the sum of the points added for the sections is equal to the Assignment Points TOTAL, the User can proceed by clicking the Next button 6902. This will take the User back to the first section shown in FIG. 67 and repeated for description purposes in FIG. 70 with their Added Sections.

As shown in FIG. 70, for an Information Section type, the User can enter a Title 7000 and content. This section type is primarily used to provide additional information or resources that will help the Student better learn the topic. The WYSIWYG content editor allows them to enter text, add images or links, or embed videos. At any point during the creation of the assignment, the User can click the Preview button 7002 to view their progress. Once the required information has been entered, the User can click the Next button 7004 to proceed to the next section. The User can also click the Save Changes button 7006 to save their current work as a draft and come back at a later date to finish their work. All of the User's drafts can be accessed from the upper left section of their main eLearning page using the Assignments button 7008.

After clicking the next button 7004 in FIG. 70, the UI of FIG. 71 appears. For a Discussion Section type, the User can enter a Title 7100 and content. This section type is primarily used to allow Students to interact and discuss specific information or events. Students can post one or more comments under this section and hold an ongoing discussion within the assignment page. The WYSIWYG content editor allows them to enter text, add images or links, or embed videos. At any point during the creation of the assignment, the User can click the Preview button to view their progress. Once the required information has been entered, the User can click the Next button to proceed to the next section. The User can also click the Save Changes button to save their current work as a draft and come back at a later date to finish their work. All of the User's drafts can be accessed from the upper left section of their main eLearning page (Assignments button).

After clicking the next button in FIG. 71, the UI of FIG. 72 appears. For the Manual Upload section type, the User is prompted to enter a Title 7200 and Instructions 7202 in simple text. Under the Number of Upload Fields dropdown menu 7204, they can select the number of files to be uploaded by the Student. The User can click the Save Changes button 7206 to save their work to finish later or they can click the Next button 7208 to proceed to FIG. 73.

In FIG. 73, a Test/Quiz section is shown which prompts the User to enter a Title 7300 and Description 7302. A time limit can be added using the field 7304. The correct answers can be made visible to the student by selecting the checkbox 7306 or the teacher can select to present the correct answers only after a last attempt by a student to answer. The test/quiz can be set for practice only by selecting the checkbox 7308. The Teacher can also allow Students to attempt to answer multiple times and keep either the highest or the latest score by selecting the appropriate checkbox 7310.

After completing the form in FIG. 73, the UI of FIG. 74 is presented to allow the Teacher to add questions and possible point values. There are four different question types that can be added using the dropdown menu 7400. These include multiple choices, in which the User can delete 7402 or add 7404 options as necessary. In order to indicate the correct answer, the User should preferably select the radial button 7406 next to the correct option. Only one correct option can be selected. This question type can be automatically graded by the system.

As shown in FIG. 75 another question type that may be selected is “fill in the blank”, in which the system subsequently will prompt the Student to enter the number of responses indicated by the Teacher in the How Many Responses field 7500. This question type currently cannot be automatically graded by the system. Yet again, FIG. 76 shows that a question type can be true/false in which the Teacher can indicate using the drop down menu 7600 whether the statement in the Question section is true or false. This question type can automatically graded by the system. Moreover, FIG. 77 shows that a fourth question type can be essay, in which the Teacher can define the number of characters that the Student can enter for their essay question answer using the field 7700. They can enter a -0- if they do not wish to restrict the number of characters entered. The User can proceed by clicking the Next button 7702.

The system in response will prompt the User to select how they would like to save the assignment using the UI of FIG. 78. As shown, there are three different ways the Teacher can save their assignment, namely, Save As Draft—This saves their work in a “Draft” status so they can finish it at a later date. Students cannot be assigned under this option. The assignment also can be Saved As Final—This saves their work as finished and allows them to assign students. The third option is Save As Global Template—This saves their work as finished and allows other Teachers in the system to access the assignment as a template when they create new assignments. Assignments given this save status will be added to the Assignment Archive in the enterprise's online community. In the example of FIG. 78, the assignment was saved under the Save As Final status and the checkbox 7800 was marked to continue to assign students. When the User clicks the Save button 7802, the system then prompts them to select assignment recipients using the UI of FIG. 79.

As shown in FIG. 79, the system displays icons 7900 representing all of the Students that have been assigned to the Teacher's classroom. If the Teacher is managing more than one classroom, then the system will display all of their Students by default. If the Teacher wants to see the Students in one of their classes, they can choose the desired classroom from the Filter By Class dropdown menu 7902 in the upper right corner of the page. The Teacher can select one, some, or all of the Students in their classroom as assignment recipients by clicking on the appropriate icons 7900 or “all selector” 7904. Once they have selected the desired group, they can proceed to the next step by clicking the Continue button 7906 to invoke the UI shown in FIG. 80.

As shown in FIG. 80, the system then prompts the Teacher to select a release date 8000 and a due date 8002 for the assignment. An assignment that is created and published prior to the release date and time is placed in Pending status and not visible to Students or their Parents. It will become visible once it has been released. Although all of the sections within the assignment have the same release date/time, they each can have a separate due date by selecting the checkbox 8004 and entering the respective due dates and times in the individual section fields 8006. Once the Teacher has entered the required information, they can complete assignment creation process by clicking the Save and Finish button 8008. The new assignment is created and the Teacher is returned to their main assignments page.

The main assignment page shown in FIG. 67 is repeated for descriptive purposes in FIG. 81, now showing the newly created assignment according to the above description to enable the user to view a detailed summary 8100 of their new assignment. The user can also delete the assignment from the Details section by selecting the delete button 8102. This is the only place an assignment can be deleted and it can only be deleted by the Teacher who created it. The Teacher can also click the WORKFLOW button 8104 to view the progress of their Students shown in the UI of FIG. 82. In this example, the assignment was just released, so all eleven Students are shown under the Released column 8200. The Teacher uses this section to manage the progress of their Students by seeing how many student are working on the assignment as indicated by the in progress column 8202, how many have submitted the assignment as indicated by the submitted column 8204, and how many assignments have been graded as indicated by the column 8206.

FIG. 83 shows the dashboard presented in FIG. 26, updated to reflect the new assignment at 8300. Once an assignment has reached Released status, it is displayed in the Assignments quick view of the Students main dashboard. Students can access eLearning LMS module by clicking the eLearning icon 8302 in the Apps section, the eLearning button 8304 in the Assignments quick view, or the title 8306 of the assignment in the Assignment quick view, all of which selectors are on the students' dashboards.

FIG. 84 shows that responsive to a Student selecting eLearning, they are taken directly to their main assignment dashboard. They can filter the view by different status levels (using dropdown menu 8400) to be sure they stay on top of the most critical assignments. In this example, the Student has one assignment that has not been started. They can start working on it by clicking the Open Assignment button 8402.

Responsive to the student clicking the Open Assignment button 8402, the UI of FIG. 85 appears. In this example, the Student is required to watch the embedded video to prepare for an upcoming in class discussion.

After completing the task the student can click on the Next button 8500, which causes the system to take the student to the next section of the assignment, in this example shown in FIG. 86. This section in the example shown requires the Student to post a comment regarding the embedded video they had viewed in the prior section. Discussions are ongoing and unlimited within an assignment page. The Student can proceed by clicking the Next button 8600 to move to the next section of the assignment, shown in this example by FIG. 87. In this example, the Teacher has asked the Student to write a short paper and to upload it back into the assignment page for review. Once the Student uploads their file, they can click the Next button 8700 to proceed to a test in FIG. 88. The Student clicks “start” 8800 to start a timer countdown as indicated at 8802, in this case, five minutes to complete the assessment. There are only four questions in the example as indicated to the student at 8804 and the student is allowed two attempts at each question as indicated at 8806. Used attempts for each question are indicated at 8808, and as indicated to the student at 8810, the system will take the latest score.

The student can defer test taking by clicking the next button 8812. However, responsive to clicking the start button 8800 the UI of FIG. 89 appears. The Student answers each of the questions shown at 8900 and clicks the Save Progress button 8902 to record their answers. To respond to the next question the student selects the continue button 8903. In this way the student completes the test and can then click the Submit Now button 8904 to send their work to the Teacher for grading. The Student can also choose to click the Save Without Submitting button 8906 if they need to return at a later point to complete taking the test.

Once the Student has answered all of the questions and has clicked the Submit Test button the system takes them to the test summary page shown in FIG. 90. In this example, the Teacher allowed the Student to attempt the test two times as indicated at 9000. If the Student chooses to retake the test by again selecting the “start test” button, the system will keep the latest score as indicated at 9002.

The Student proceeds by clicking the Next button 9004, and the system presents the UI shown in FIG. 91 in response, showing an example Assignment Submission page. The Student can save their work as a Draft by selecting the draft checkbox 9100 and then selecting the “save” button 9101. This will put the assignment in In Process status for the Student to complete and submit at a later date. They can also submit their completed assignment by selecting Save and Submit checkbox 9102 and clicking on “save” 9101. This will submit the assignment to their Teacher for grading.

Once the Student has selected a submission option and clicked the Save button 9101 to record their selection, the system returns them to their main assignment page where they can see that their work has been submitted to the Teacher for review. For convenience of description the main assignment page is shown again in FIG. 92, indicating the progress in window 9200.

Having described how a Teacher can generate an assignment and a Student can complete it, refer now to FIG. 93, illustrating how the Parent of the Student can access the eLearning module to monitor the progress of their Student(s). They can only view a summary 9300 of the assignments and their current status 9302. Parents are not given direct access to the Student's assignments. Only the Students and Teachers have permission to interact within assignments. In this example, the Parent can see that one of their Students has already submitted their work to the Teacher for grading and the other Student's assignment is still In Progress.

Returning to the Teacher's eLearning features, once the Students begin working on their assignments, the Teacher can monitor their progress by clicking the WORKFLOW button 9400 in the side menu of the Teacher's main eLearning (PMS) page. This page displays all of the Teacher's assignments as shown at 9402 and tracks each of the Students activity in previously-discussed fields 9404. The Teacher can click the Details link 9406 next to each of their assignments to access a summary of the information they entered as shown in FIG. 95. Once an assignment has been released, it cannot be deleted.

In the example shown, as indicated at 9500 there are nine Students that have not yet started working on the assignment. The Teacher can click the total under the Released column to view a detailed list of these Students as shown in FIG. 96. As indicated in FIG. 96, the Teacher can then send a message to one, some, or all of the Students in the list. Once the Teacher has selected the desired recipients and has created their message, he can click the Send Message button 9600 to proceed to send a message shown at 9602.

Responsive to the Teacher sending the message, as shown in FIG. 97 each of the Students that was checked in the recipient list receives the message in their Message Center inbox. Replies to the message will be delivered directly to the Teacher's Message Center inbox.

Referring back to the Teacher's summary page, conveniently shown again in FIG. 98 for ease of description, as indicated at 9800 one of Students is currently working on the assignment. The Teacher can click on the total under the In Progress column 9800 to view a detailed list and to interact with the Student as described above in reference to FIGS. 96 and 97. Specifically, as shown in FIG. 99 the Teacher can select one, some, or all of the Students in the detailed list, type a message 9900, and click the Send Message button 9902 to send the message to the selected student. FIG. 100 shows at 10000 that the Student(s) receives the Teacher's message directly in their Message Center inbox.

Referring back to the Teacher's summary page, conveniently shown again in FIG. 101 for ease of description, as indicated at 10100 one of Students has already completed the assignment and has submitted their work for grading. The Teacher can click the total under the Submitted column to see a detailed list of the Students in this category as shown in FIG. 102. To view the Student's submitted work, the Teacher can click the View/Edit link 10200 under the Submission column which causes the system to display all of the work the Student has submitted for the Teacher to review as shown in the UI of FIG. 103. Once the Teacher has reviewed the Student's work in the each of the assignment sections and has entered the number of points earned in the field 10300, the system displays a summary of the total points earned out of the total available for the assignment. The Teacher clicks the Save Grade button 10302 to assign the points to the Student. Once the Teacher is finished reviewing the submitted work for their Student(s), he can enter a message for one, some, or all Students and click the Send Message button 10400 in the message center mailbox shown in FIG. 104. The message will be sent directly to the Student's Message Center inbox, shown in FIG. 105. When the Teacher has finished entering the points earned for his Student(s), he can send the points to the online Gradebook by clicking the Send to Gradebook button 10402, moving the Student's results progress from the Submitted column 10100 of FIG. 101 to the Graded column 10102.

Thus, the Teacher can grade their Students' work as it is completed and submitted. The Teacher does not need to wait for all of the assignments to be submitted before reviewing and grading the work.

Each of the assignments that have been created by the Teacher is displayed in the online Gradebook, shown in FIG. 106. Once the Teacher has assigned a point value to a Student's work, and has clicked the Send to Gradebook button in the prior screen, grades are displayed for each of the Students within the Gradebook interface as shown.

In the example shown, the Teacher can add filtering to the Gradebook interface to view their entries by only one classroom (for Teachers that are managing more than one) as indicated at 10600, Points, Percentages, or Letter Grades by appropriately selecting an entry from the dropdown menu 10602, Assignment category (Homework, classwork, extra credit, etc.) by appropriately selecting an entry from the dropdown menu 10604, Primary subject (Reading, math, science, etc.) by appropriately selecting an entry from the dropdown menu 10606, and Grading period (the total number of Grading periods is entered in the School Settings page) by appropriately selecting an entry from the dropdown menu 10608. The Teacher can also apply a grading curve by entering a value under the Curve box 10610 and clicking the Update button 10612. Any time the values within the Gradebook are modified, the Update button should preferably be clicked in order for the changes to be applied.

It the example of FIG. 107, the points earned for Gina Jones has been changed from 93 to 95 as indicated at 10700, owing to the application of a grading curve from FIG. 106. The new point value is displayed in RED text and is underlined. Once the Teacher is satisfied with the revisions to their Gradebook, the Teacher should preferably click the Update button again to apply the changes.

Returning to the main eLearning screen, shown again in FIG. 108 for flow of description, Teachers, Students, and Parents can also view assignments in a detailed list by clicking on the SCHEDULE button 10800 in the side menu. The User can apply a date range in fields 10802 and the system will display all of the assignments within the range by the date they are due. They can print their results by clicking the Print button 10804 and keep a hard copy version of their assignment schedule for reference.

The above completes discussion of the eLearning feature. Turning now to FIGS. 109 et seq., the attendance feature for Teachers is shown. Teachers are required to record attendance for each Student in their class(es), and the present system allows a teacher to efficiently and accurately account for their Students and instantly report the information to School Administrators for review. A Teacher can access their attendance manager by clicking an Attendance icon in the Apps section 2610 of the Teacher's main Dashboard exemplified in FIG. 26. A Teacher can also access this interface by clicking on an Attendance gauge “A” at the lower left corner of their main Dashboard in the gauge section 2608.

FIG. 109 illustrates the main Teacher attendance page UI. As a default, the left side of the page displays an overview of the attendance statistics for the current school period for all of the classes the Teacher is managing. The Teacher can select a specific class from the dropdown menu 10900 to view these statistics for just one of their classes. The system also defaults to displaying all of the Teacher's classes on grey bars 10902 in the middle of the screen. If a Teacher clicks one of the grade icons at the top of the page, the system will display grey bars for those classes. If the Teacher wishes to record the status of only one of their Students, she can enter the Student's name under the Student Name field 10904 and click the Search button 10906. The Teacher can then record attendance for the individual Student.

When the Teacher clicks the grey bar 10902 for one of their classes, the system presents the roster page shown in FIG. 110 that lists all of the Students in the class as shown. None of the attendance boxes 11000 are yet checked and the Teacher must log into their account each day to record attendance. The Teacher must record a value for each Student listed under the class roster. They can assign the same value for all of the Students by clicking a box at the top of one of the columns. For example, if all of the Students are present, then the Teacher can click the box next to Present at the top of the page to add this mark for all of them at one time. Once a mark has been added for each Student, the Teacher can click the Save button 11002 to proceed. The system will not allow the Teacher to proceed unless they have added a mark for all of the Students on the roster.

Note that as shown in FIG. 111, once the Teacher has assigned an attendance status to a Student, a graphic identifier 11100 is displayed in the right hand column of the roster. There are four different attendance status levels available, including present, indicated, e.g., by a green icon 11100, meaning the Student has arrived on or before the start of class. A second status is Absent Pending indicated, e.g., by a red icon 11100, meaning that the corresponding Student did not arrive by the time attendance was taken by the Teacher. The School Administrator is notified. Absent Confirmed (indicated, e.g., by a blue icon) means that the School Administrator has confirmed a reason for the Student's absence and has recorded it into the system, and Tardy (e.g., indicated by a yellow icon) means that the Student has arrived after the start of class, but before the Teacher recorded class attendance.

FIG. 112 shows a UI for Absence Auto-Notification, wherein responsive to a Teacher marking a Student absent as indicated at 11200, an auto-notification is sent to the Message Center inbox for the School Administrator and also to the Message Center of the Student's primary parent. The system will automatically include the Student Name, the Status Change, and the Date Reported within the body text of the email. The content of this message can be revised by the School Administrator as needed.

FIG. 113 illustrates a UI for Confirming Student Absence, in which, responsive to a Teacher marking a Student absent, the status icon is displayed in red as indicated at 11300. When the School Administrator processes the absence, the system prompts them to enter a reason and additional notes under the Absence Description popup. When the required information has been entered, the status icon is changed to blue. This helps the Teacher understand that the absence has been confirmed by the School Administrator and has communicated successfully with the Student's primary parent. When the Teacher clicks on the blue status icon for a Student, the system displays the Absence Description popup 11302 for the Teacher to review. Teachers do not have permission to edit the information in the Absence Description.

FIG. 114 illustrates that when the Teacher accesses their Attendance Manager, it defaults to the current date 11400. The Teacher can view previously submitted rosters to monitor past attendance behavior for their Students. They can also view rosters in the future to see if the School Administrator has recorded any extended absences for their Students. Teachers are only able to modify attendance marks for the current day. They do not have permission to edit marks for dates in the past or in the future.

School Administrators can also access past, current, and future attendance rosters for all of the Students in the school. They do have permission to edit all attendance rosters as needed until the Average Daily Attendance (ADA) totals have been reported to the District.

FIG. 115 shows a Seating Chart that the Teacher can create for taking attendance. First, the Teacher clicks the SEATING CHART button 11500 in the side menu. The system prompts the Teacher to enter a numeric value for the Rows and Columns fields 11502 and 11504. Each of the boxes within the grid 11506 includes a chair icon. When the Teacher clicks the chair icon in one of the boxes, the system displays a dropdown selector 11508 of the Students in the class. The Teacher selects the desired Student from the list by clicking on their name. Once the Teacher has assigned all of their Students to seats in the chart, the Teacher can click the Print button 11510 to print out a hard copy for reference offline. The Teacher can click on the Save button 11512 to proceed. In this way, seating charts can be created for each of the classrooms being managed by the Teacher.

The dashboard shown in FIG. 26 is repeated in FIG. 116 to illustrate content management. A majority of the content that drives the dynamic functionality of the system is controlled from within the Manage interface. Each of the Users within the system has different levels of permissions and access depending on their individual role type. If a User has permission to access this interface, a Manage icon 11600 will be visible in the Apps section 2610 of their main dashboard.

Users within the system are given different access and permissions to Manage functionality depending on their role type. The section each User manages may or may not affect the other Users in the system. In example embodiments, Master Administrators have access to controls that affect one, some, or all of the enterprise's online community sites within the network. System/School/User Administrators have access to controls that only affect the Users within their individual community, while Faculty Members have access to controls that only affect the Students and Parents and other teaching staff within their classroom(s).

As shown in FIG. 117, a User can enter a section of this interface by clicking on the appropriate button from the side menu. Assume a report abuse selector 11700 is selected. The ABUSE REPORTS page 11702 lists all of the instances of potentially unacceptable behavior reported by Users from within the system. When the User clicks the View link 11704 for one of the records, they can see the Users involved in the report. When the User clicks on the URL link 11706 for a record, the system displays the actual instance of potential abuse for them to review. Once the User determines whether or not the abuse is valid, they can click on the Pending link 11706 to record an action. This causes the form of FIG. 118 to appear, in which the User selects the recipient(s) using checkboxes 11800 and enters a custom message 11802. Clicking the Resolve button 11804 sends the message and changes the status of the record from Pending to Resolved.

Now assume that a BLOG CATEGORIES selector 11900 in the manage screen repeated in FIG. 119 is selected. This section is where Users can create and manage all of the available categories for the Blogs, shown in blog window 11902. A +Add Category link 11200 in FIG. 120 can be selected to cause the system to prompt the user to type in a name. They can proceed by clicking the Save button 11202. The User can then click the Edit link for the category to make it active or inactive. Active blog categories are available to Users when they are creating new blogs. Inactive blog categories are not available when new blogs are created. Any blogs that were created under an active blog category are still visible when a blog category becomes inactive. The inactive blog category is only removed from the list of available options for new blogs.

Now suppose that the content selector 12100 shown in the Manage screen repeated in FIG. 121 is selected. This section is where a User can view and modify the content of automated notifications sent by the system and selected portions of text displayed within the site. Revisions made to messages are applied in real time. The User can either click one of the icons 12102 to cause the UI of FIG. 122 to appear to view all of the notifications available under a specific section. The user can either Preview 12200 the message or Edit 12202 the message by clicking on the appropriate link. As also shown in FIG. 123 the user can enter a keyword in the Search box 12300 and click the Go button 12302 to search, and in response the system will display all of the entries with that include the keyword in their title or description.

Next suppose that the manage apps selector 12304 in the manage screen repeated in FIG. 123 is selected. This invokes the UI of FIG. 124. This section is where a User can manage the content displayed under the Apps section 2610 of the main Dashboard of FIG. 26. By clicking the APP LINKS button 12400, the User creates and manages all of the links to websites outside the enterprise's online community system. To create a new link, the user clicks the +Add New link button 12402 and the system invokes the Add App Link Form of FIGS. 125.

As shown in FIG. 125, the user can enter an App Name/Website Address/Icon Image in fields 12500/12502/12504, respectively. The user also can indicate if the app should open in a new page by selecting selector 12506, indicate if a login is required using check selector 12508, and enter a description of the link in field 12510. Checking one or more checkboxes 12512 enables the user to select the affected User role types, and check selector 12514 enables the user to indicate if Teachers can assign the app to their Students. If a Teacher is allowed to assign the App to their Students, then they can assign the App to one, some, or all of the Students in their class(es). If they are not allowed to assign the App to their Students, then the App will be assigned to their Students if the appropriate grade is selected under the User Roles section. To enter the required information the User can proceed by clicking the Submit button 12516.

Note that if an App requires a login, a User can enter and store their login credentials in the profile section in their main Dashboard. As a result, the User can click the icon for the App from the Apps section of their Dashboard and the system automatically will log them into their secure account automatically. The system thus gives users a single secure point of access, and saves the User from having to try and memorize their login credentials for multiple sites. Note further that the external links available in the app section 2610 are limited to what an administrator makes available. This aspect, coupled with disabling the address bar on the browsers of Student computers and disabling hyperlinks that otherwise might be selected to transfer the Student away from the pre-approved site, means that Student computers can access only links internal to the system and external links placed in the apps section of the dashboard, and no other Internet sites.

FIG. 126 shows that when the default app icons selector 12600 in the manage apps section is selected, a User can edit 12602 the icons displayed in the Apps section 2610 of the main Dashboard that can be selected to take Users to the applications within the system. When the App Backgrounds selector 12700 in the manage apps section is selected, a User can upload and manage the backgrounds that are available for display as the background image for the Apps section within the account Dashboard. When the members selector 12800 in the manage apps section is selected as shown in FIG. 128, a User can access to the entire database of members within their enterprise's online community. They can filter 12802 the view by account Status (Pending, Active, Inactive, Deleted, and Full Data Delete) or by Role Type (TK, KG, 1G, 2G, 3G, 4G, 5G, FM, SA, ES, AUA, ASA, and AMA). The User can also search 12804 by the member's name.

The user (if in an authorized class) can click a “view profile” selector 12806 to change the member's profile as shown in FIG. 129. There are five levels of member status available, including:

Pending—Registration is still being processed. Auto-notification sent to applicant prompting them to contact the School Administrator in order to provide additional information or documentation.

Active—Registration has been processed and the Member has been granted access to the enterprise's online community.

Inactive—The Member's account has been suspended. Auto-notification sent to Member prompting them to contact the School Administrator.

Deleted—The Member's account has been deleted, but all of their related data is available for auditing or review. Auto-notification sent to Member letting them know their account has been deleted.

Full Data Delete—The Member's account has been deleted, and all of their related data within the system has also been permanently deleted.

Referring to FIG. 130, Users with administrator levels of access can view detailed information in the following areas by clicking on the appropriate icon 13000: Health records, family members, legal or custody, citizenship, class performance, attendance, and notes. This information is kept confidential and is only visible to Users with the proper permissions.

FIG. 131 shows that when the Polls selector 13100 in the manage apps section is selected, the User can access polling functionality. An unlimited number of polls can be created and saved. An unlimited number of polls can be visible at the same time.

By clicking on the +Add Poll link 13102, the User is presented with the Add Poll form of FIG. 132. The User can enter a Title into field 13200, a question in field 13202, and up to five possible selections in fields 13204. The User must indicate whether to post the Poll now, to post it on a specific date in the future, or not to display it, using the appropriate check selectors 13206. If the User indicates that responding is optional, then the system will only display the Poll once during login. If responding is required, then the system forces the User to take the poll(s) in order to proceed to their Dashboard.

Selecting the classrooms selector 13208 causes the UI of FIG. 133 to appear. Once all Teachers have been registered in the system, the School Administrator can create classrooms accordingly. To create a new class, the User must click the +Add New link 13300. The system will then invoke the Add Classroom form of FIG. 134.

In the Add Classroom form of FIG. 134, the system prompts the User to select one of two Class Types using dropdown menu 13400:

Primary—This class type is based on a main subject such as English, Math, Science, History, etc. The available Primary class types are entered by the School Administrator under the Manage|Student Settings button.

Secondary—This class type must be related to one of the Primary class types (i.e. Computer Lab would be under Science or Technology.). The available Secondary class types are entered by the School Administrator under the Manage|Student Settings button.

The User must also select a grade or grades the class will be available to using the dropdown menu 13402. They must enter a Class/Course Name in field 13404, a Class/Course Number in 13406, and a class description in text box 13408. Also, the user can enter a Room/Location 13410, a Location/Address 13412, a Start Time 13414, and an End Time 13416. One or more Teachers can be connected to a classroom. The User can start entering the name of the Teacher in the Add Teacher box 13418 and the system will retrieve the Visual Identifier (VI) 13420 for the Teacher. Once the User clicks on the Teacher's VI, the system associates it with the new classroom. When the User has satisfied all the data requirements, the user can click the Submit button 13422 to proceed.

As soon as one or more Students have been successfully registered in the system, and at least one classroom has been created, the School Administrator can begin assigning Students to available classrooms.

By clicking on the PRIMARY ASSIGNMENT or SECONDARY ASSIGNMENT button 13424 and 13426, respectively, under Manage|Classrooms, the School Administrator can view each of the Students and attach them to Primary and Secondary classrooms accordingly. FIG. 135 shows that as each of the classrooms is filled with available Students, the User is able to measure and balance each classroom with respect to various demographics (i.e. Gender, behavior, etc.).

Students can also be assigned to one or more classrooms within the Members section. The School Administrator can select one or more of the classrooms that are available to the Student from the Personal Information tab within their member profile.

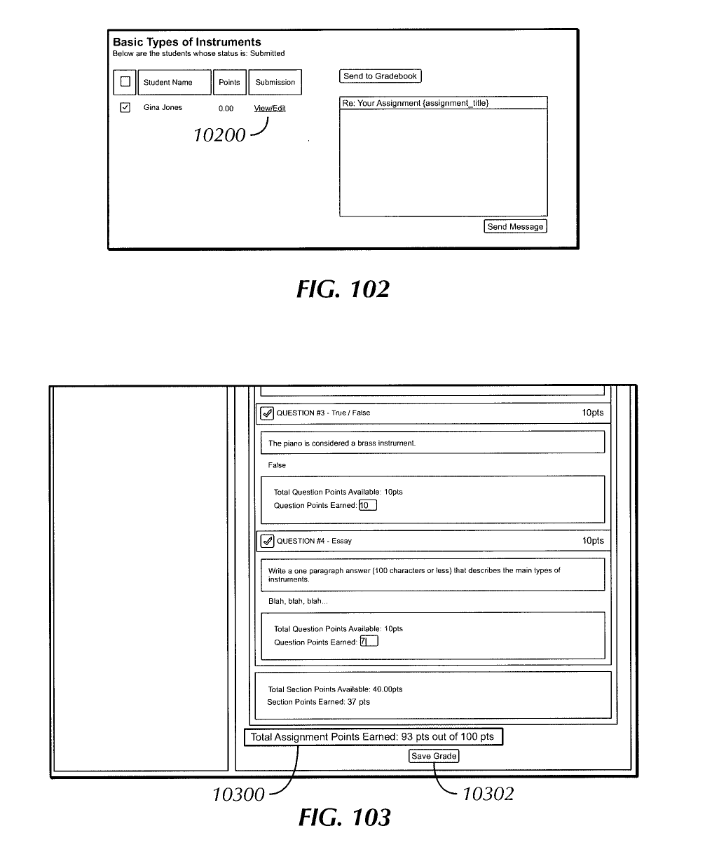

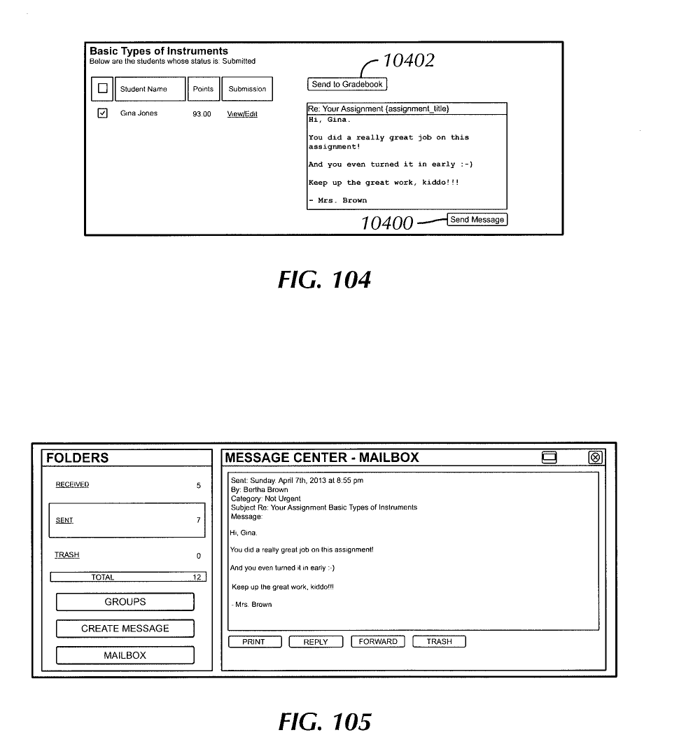

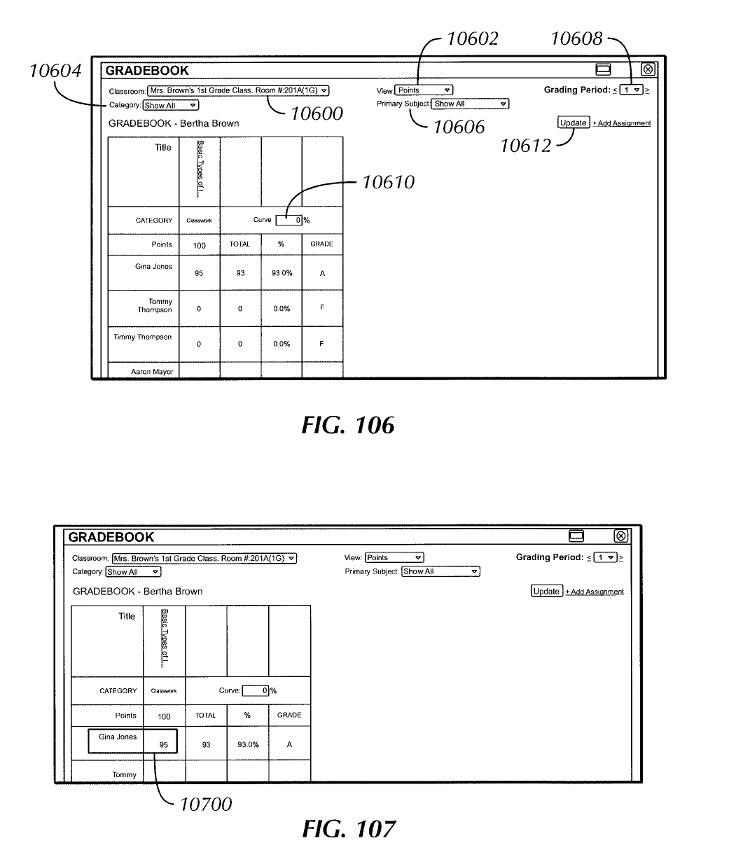

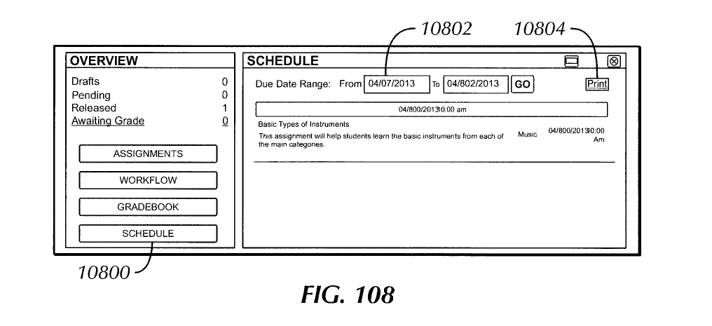

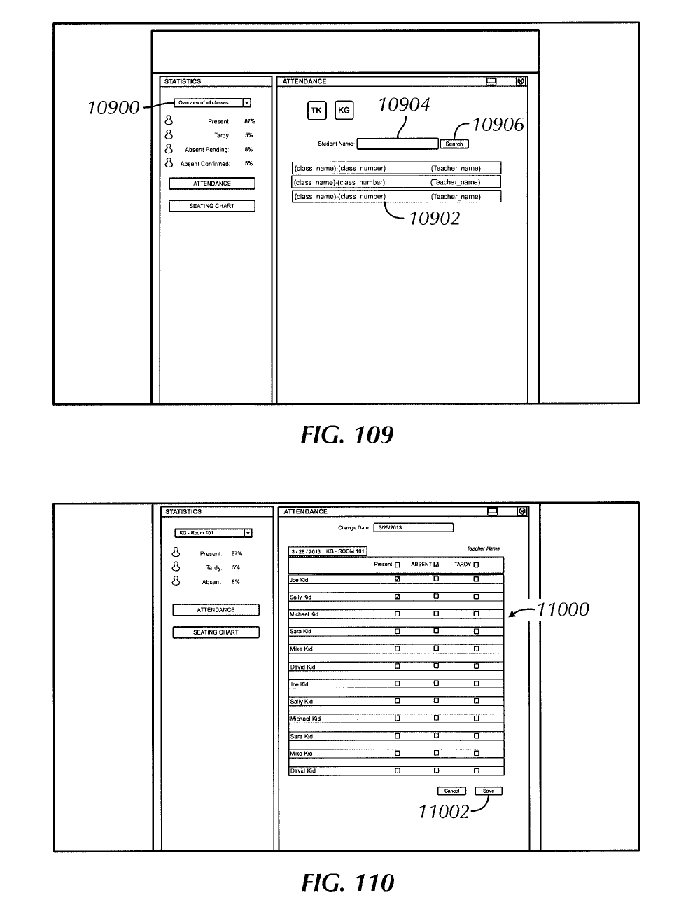

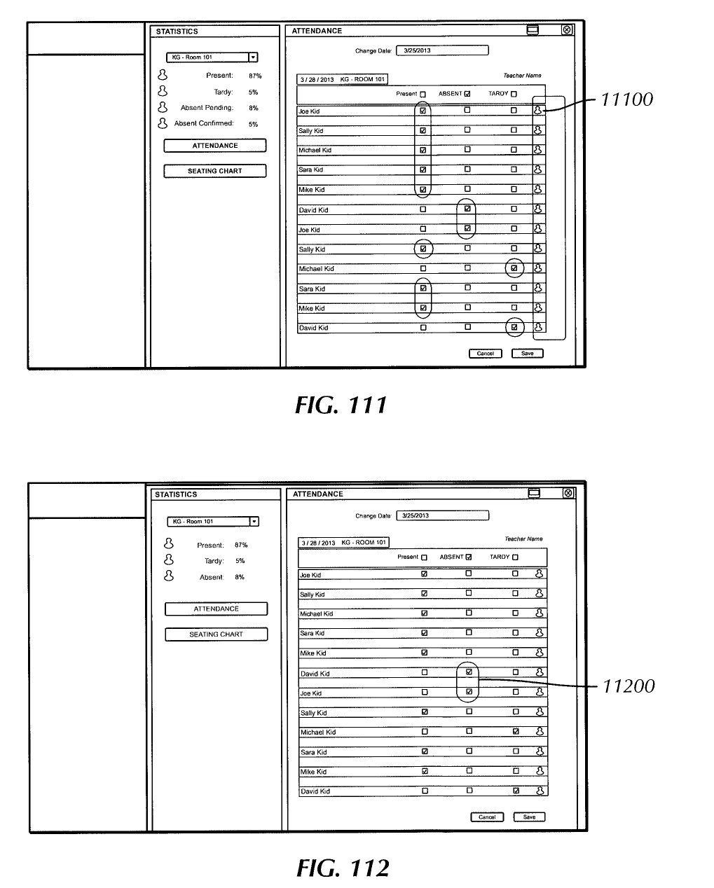

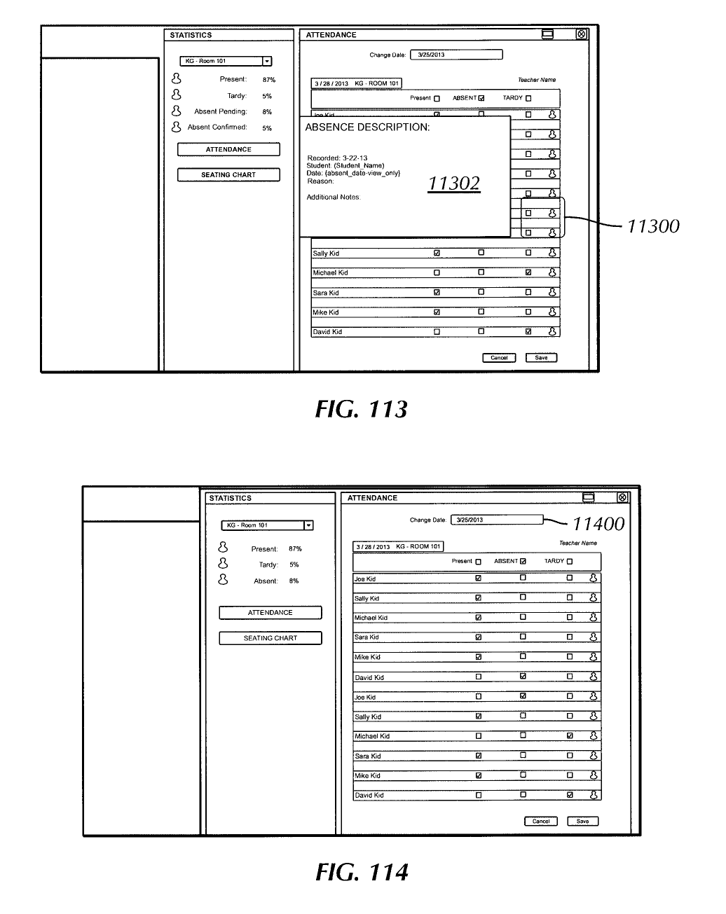

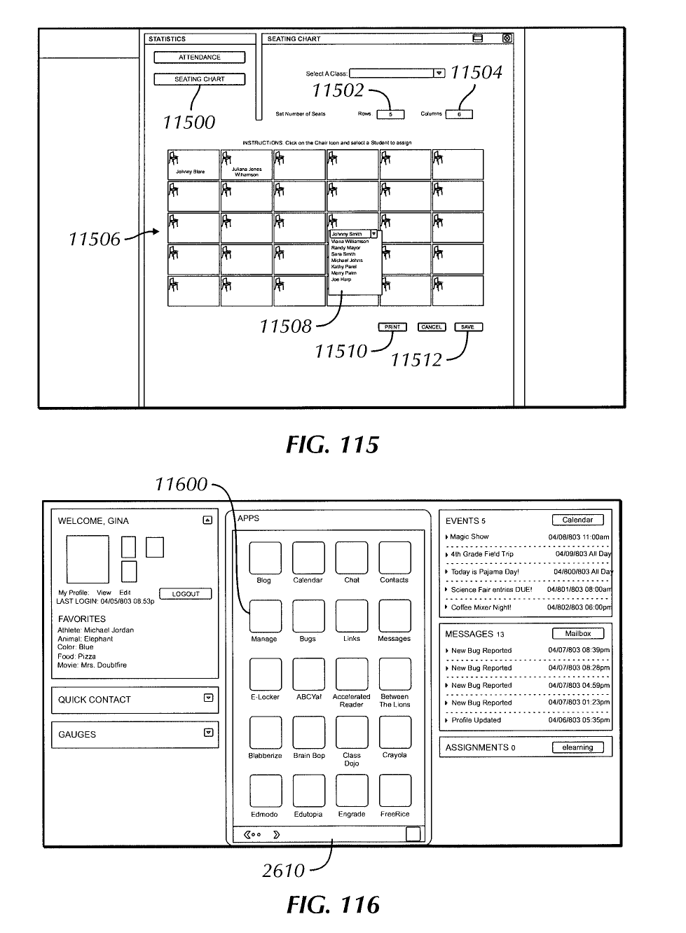

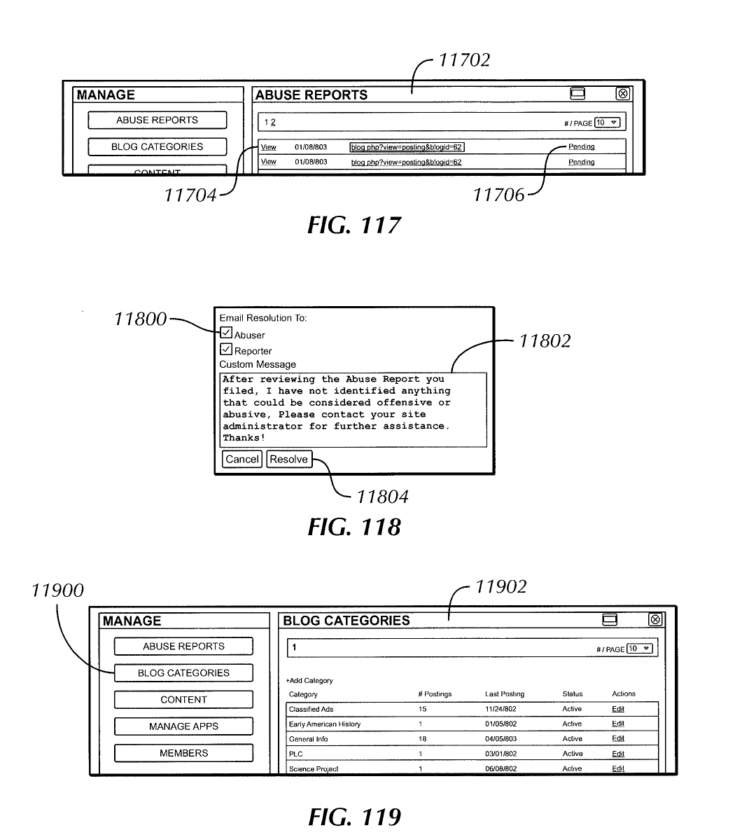

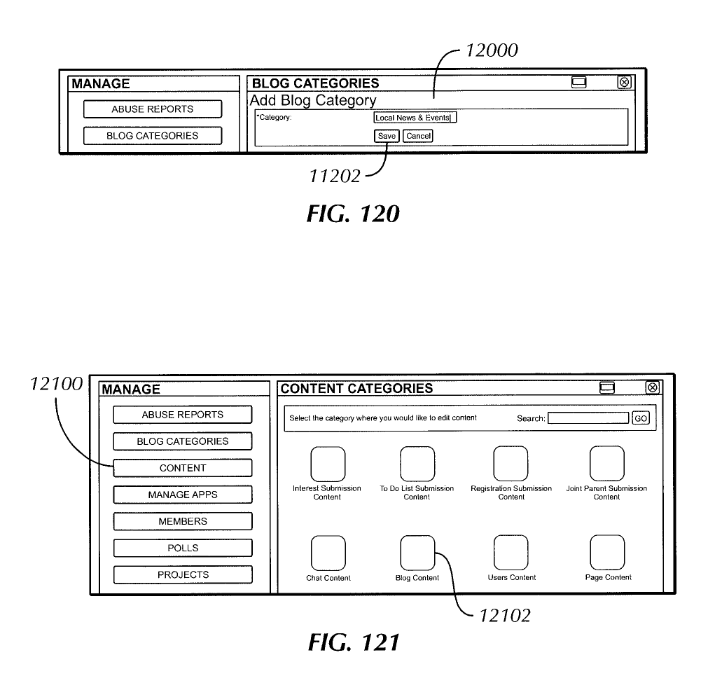

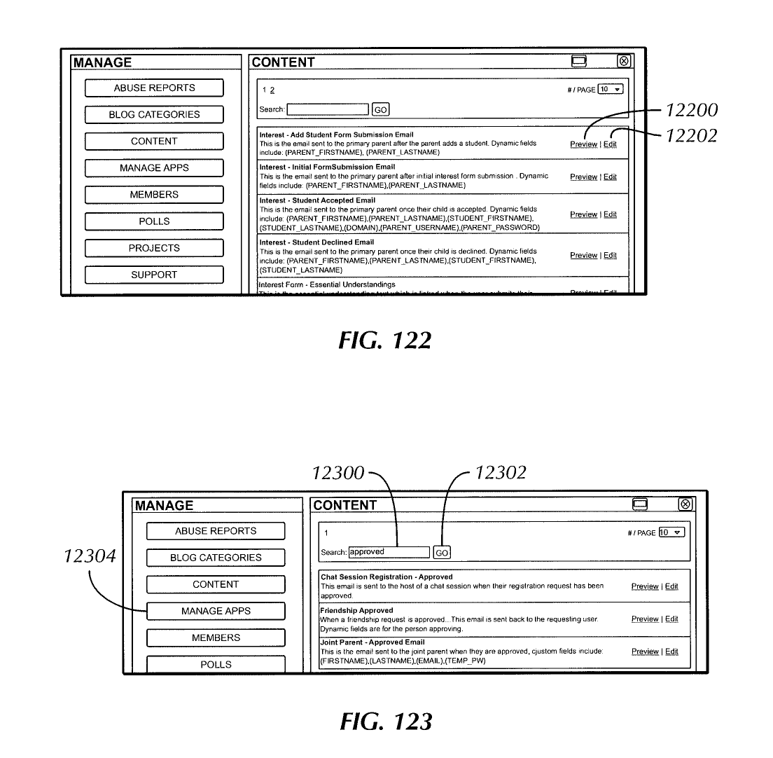

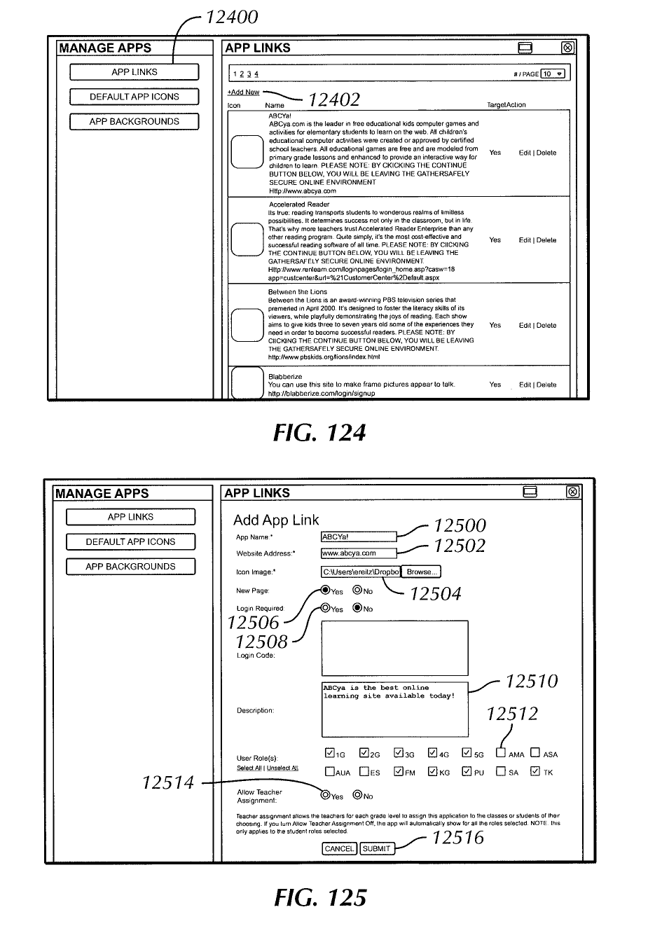

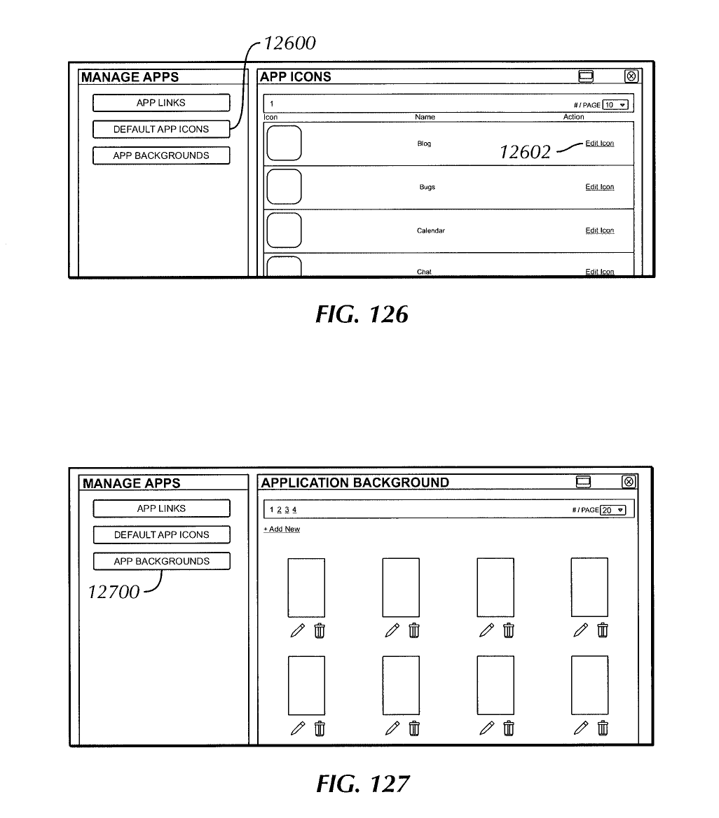

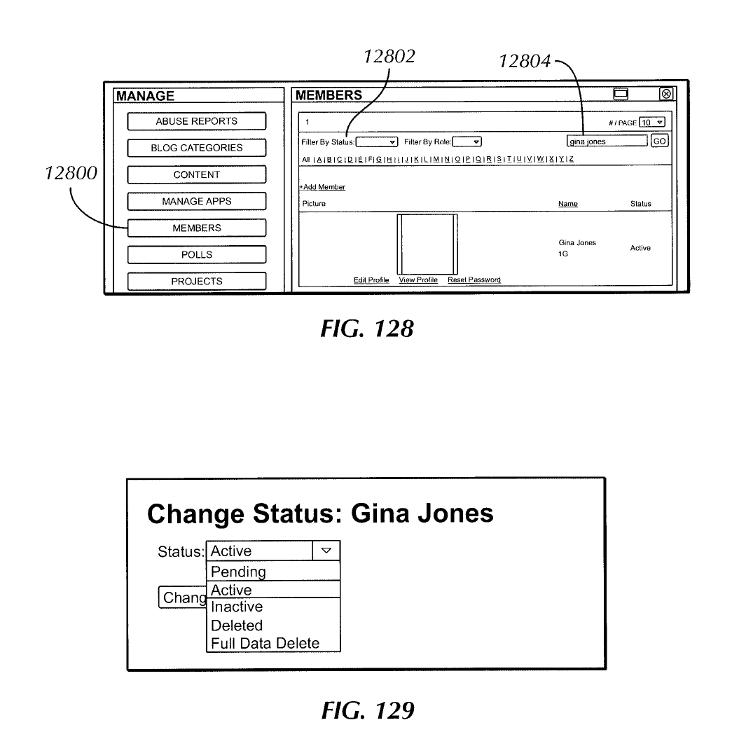

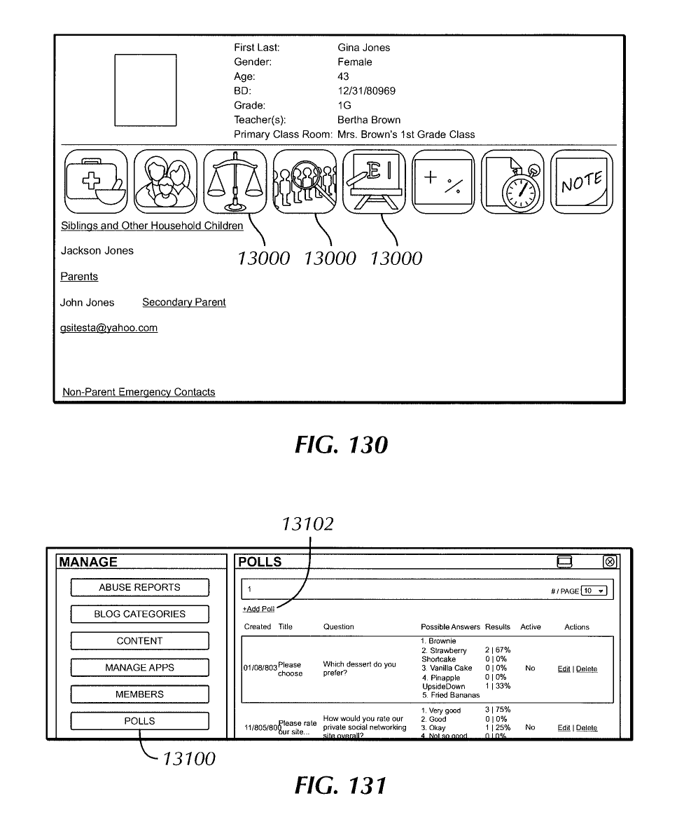

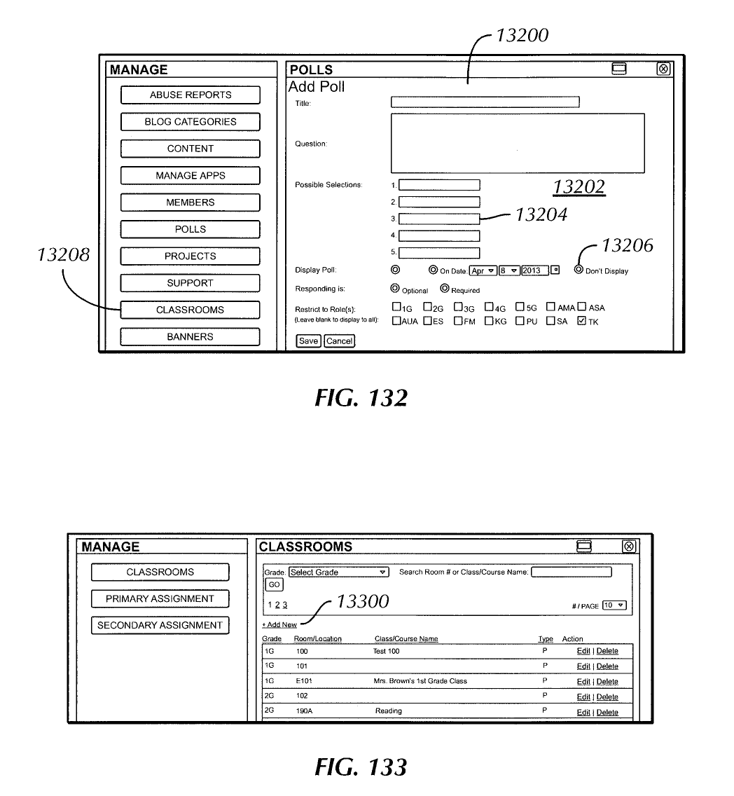

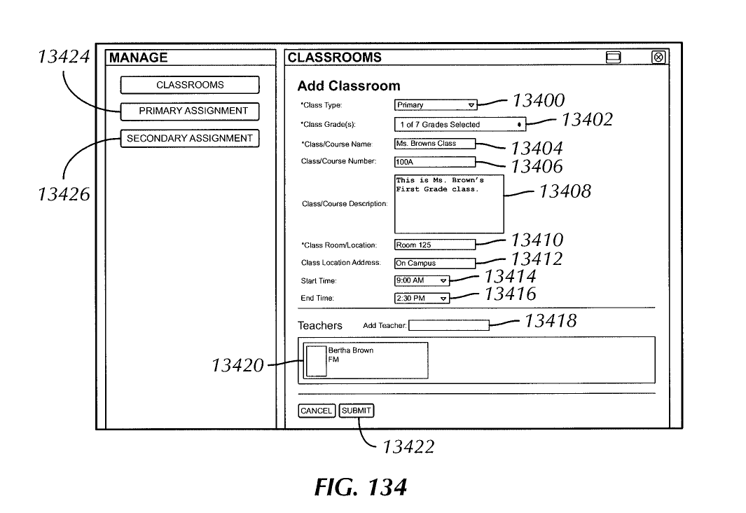

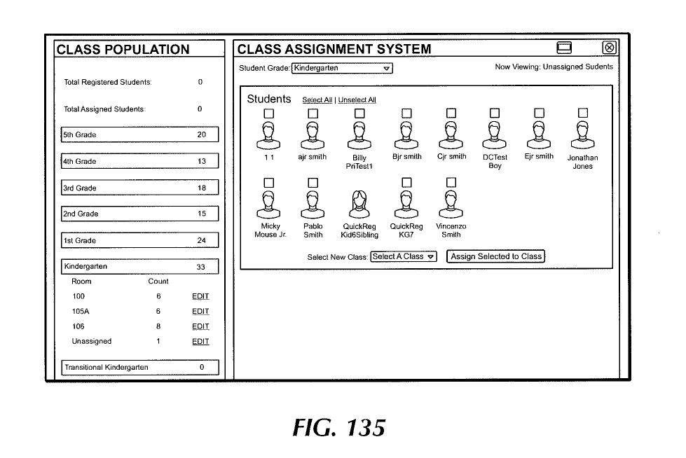

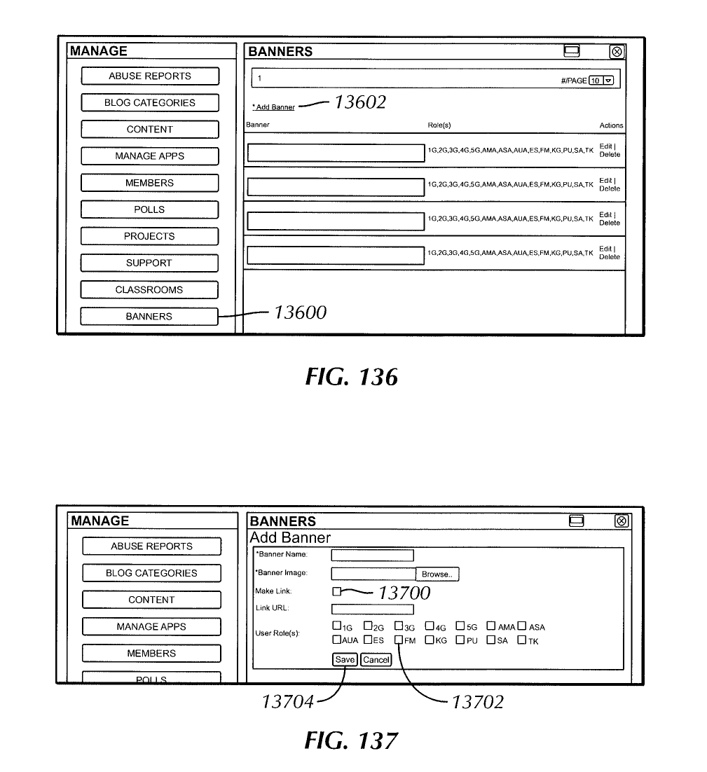

FIG. 136 shows that selection of the banners button 13600 invokes the banner management interface of FIG. 137 in which a user can create and modify customized top banners that will be displayed within each page of the system. To create a new custom banner, the User must first click on the +Add Banner link 13602. This will open the Add Banner form of FIG. 137.

As seen from looking at FIG. 137, the system prompts the User to enter a Banner Name, and a Banner Image for uploading/displaying. They can also indicate whether or not the banner will be hyperlinked to another web page. If the Make Link checkbox 13700 is marked, the User must enter a Link URL. The web page link can be to another section within the internal online system or to another external web page. The User can also indicate which User role types are allowed to view the custom banner. For example, if the box 13702 for FM is checked, then content that is specific to teachers and other teaching staff (FM) is only visible to that User type. Once the User has satisfied all of the requirements within the form, they can click the Save button 13704 to proceed. All of the custom banners can be viewed or edited from within this interface. If more than one banner exists for a role type, they are displayed in the order they appear in the Manage interface and transition at, e.g., ten second intervals as a default.

### Administrative UIs

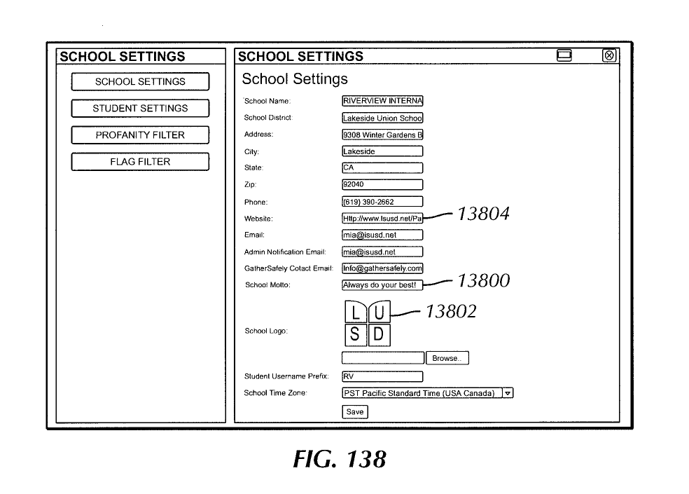

The SCHOOL SETTINGS button 13800 in FIG. 138 invokes a UI in which the User can adjust some of the school specific settings within the online system. School Name, School District, Address, City, State, Zip, Phone, and Email are displayed in the left hand portion of default top banner within the system as shown. The School Motto is displayed in the middle of default top banner in field 13800. The School Logo is displayed at 13802 and is hyperlinked to the URL that is entered into the Website box 13804. The Student Username Prefix will be the default prefix used for all system-generated User ID's created for Students. The School Time Zone is the time zone for the physical location of the school campus.

Selecting the STUDENT SETTINGS button 13900 in FIG. 139 allows the User to control settings that affect the registration process, the eLearning assignment creator, and the Grade Book. The DOB Cutoff Range is the range for Students birth dates that are being allowed into the school that is attached to the Online Registration management grid. The Interest Registration Date Range is the range for Students birth dates being allowed into the school that is attached to the Date of Birth field in the Interest Form. The QuickReg passcode is the code that must be entered by a User in order to access/initiate the QuickReg registration process. Primary Subjects, Secondary Subjects, Core Competencies, and Assignment Types are options that are displayed in the dropdown fields within the identification section of a new assignment.

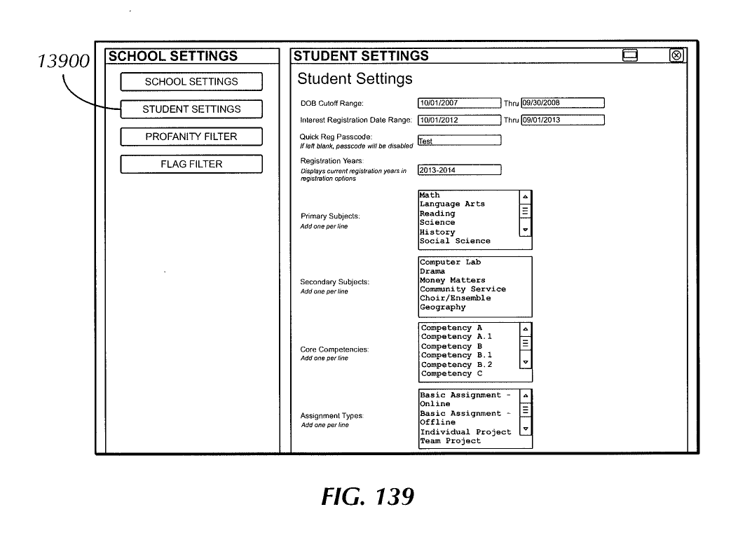

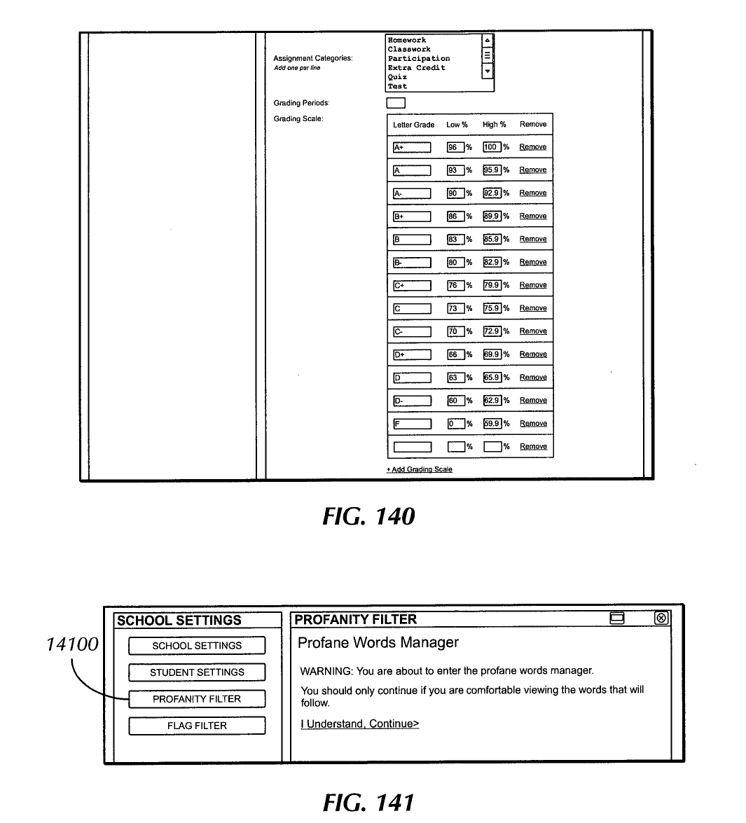

Assignment Categories in FIG. 140 are options displayed within a dropdown field in the identification section for a new assignment. Grading Periods is the amount of separate sections into which the school year will be divided (i.e. 3=trimesters, 4=quarters, etc.). The Grading Scale is the global default grading scale available to all Teachers within their online GradeBook within the eLearning interface. Teachers have the ability to modify the default Grading Scale. Any revisions applied within a Teacher's login do not affect the global template or any of the modified grading scales for other Teachers within the system.

FIG. 141 illustrates that selecting the PROFANITY FILTER button 14100 invokes a Profane Words Manager interface. A majority of profane words has already been uploaded into the interface. None of the profane words that are contained within this database are allowed to be sent by a User to any other Users within the system. A User may enter the profane word or symbol, but the system will only show the characters as asterisks.

If a School Administrator is made aware of any profane words that are not being blocked within the system, they can enter them into this interface in real time and the system will block the next instance of that word or symbol occurring within the system. Generally, online school community sites are connected to the same database of profane words. This way, if one school community identifies a profane word or symbol, then the system will block the next instance of that word or symbol that occurs in any of the school community sites.

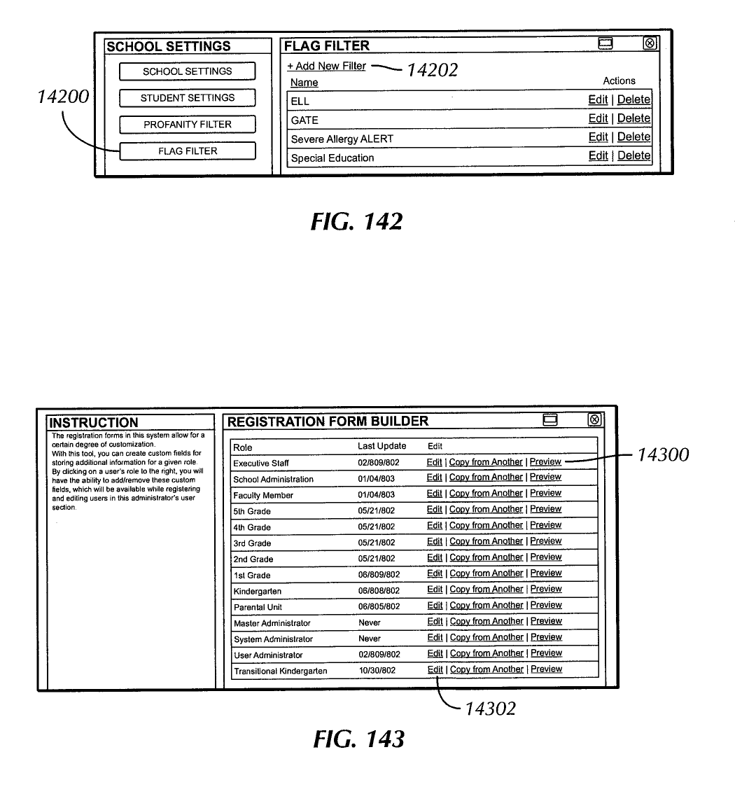

FIG. 142 shows a FLAG FILTER button 14200 which if selected allows the User to create and manage User ‘flags’ or labels that can be attached to a User's member profile. When the User clicks on the +Add New Filter link 14202, the system takes them to the Add New Filter Form.

As shown in FIG. 142 the system prompts the User to enter a Flag Name and a Color Code. The Color Code is applied to the text for the Flag Name when it's displayed within the Member section. The User must also select at least one User role type that the Flag will affect, e.g., ALL STUDENTS=English Language Learner, GATE, Special Education, PARENTS=No Campus Access, ALL USERS=Severe Allergy Alert, etc). School Administrators can attach any of the flags that are available to a User role type from the Flag Assignments tab within their Member profile.

FIG. 143 show that responsive to selection of a REG FORM BUILDER button the registration form management interface UI is presented. The registration form for each User role type is available to Preview 14300 or Edit 14302. When registration forms are edited, the changes are instantly reflected within the corresponding databases. Form field revisions are also applied in real time to the Add Member function with the Member profile management interface.

For example, if the school must begin collecting an additional set of data for all incoming transitional kindergarteners, the new data requirements can be applied within the Registration Form Builder interface. Eventually, the school may be required to go back prior to the data requirement revision and collect the data retroactively. The School Administrator can begin collecting the new data immediately and entering under the Member profile management section without being delayed by having to modify the data requirements for member accounts that existed prior to the change.

This functionality is typically reserved for the system programmer and revisions must be made using a very formal, time consuming, and frustrating process. By making this functionality available to site administrators at the system level, a school is helped to: respond instantly to changes in data requirements, decrease the amount of redundant data entry within or between systems, and increase efficiency and data integrity.

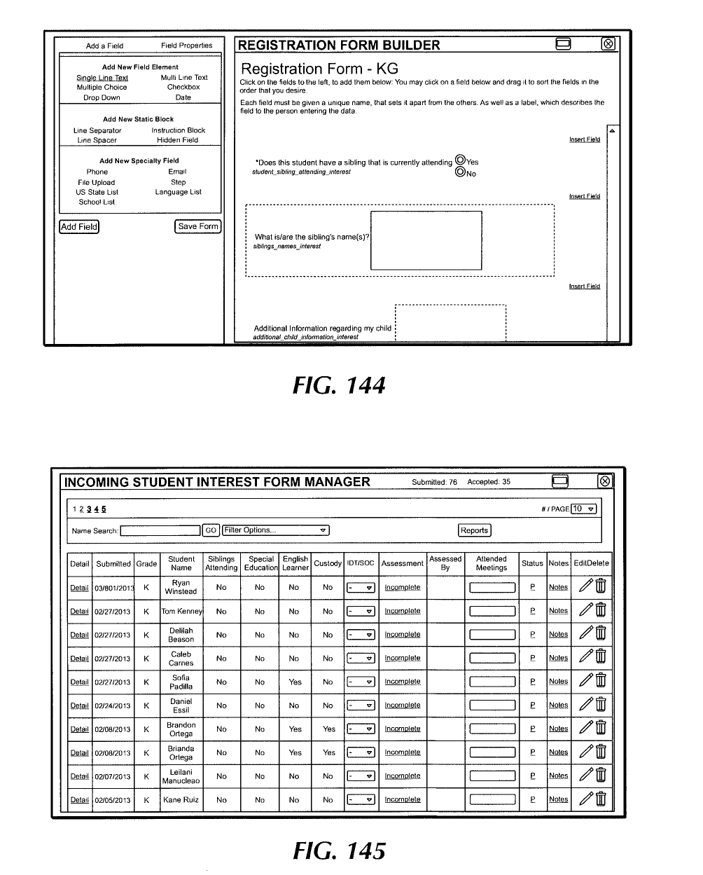

FIG. 144 is a Form Gen interface. The User can add any of the available fields on the left hand side of the page. They can then drag and drop the fields within the main screen as needed. Once the User has added all of their needed form fields and has applied all of their individual field settings as necessary, they can then click the Save Form button to apply the changes and proceed. Any revisions made within the registration forms are applied in real time. Any data entering the system databases through either the registration process or under the member profile section will automatically be subjected to the revised data requirements.

In FIG. 145 an INTEREST FORMS button within the Manage page takes the User to the Interest Form management interface. The Interest Form is the first step in the formal registration process within the system. Once the School Administrator has reviewed and processed the information entered in the Interest Form, they can modify the Status of the registration record to move it further along the process.

If an Interest Form is accepted, then the data continues on to the Online Registration Manager interface. If it is declined or put on hold, the data continues to reside in the Interest Form manager until the status is changed to accepted. Records can also be deleted from within the interface. Once a record has been deleted from within this interface, all of the data related to the record will be permanently removed from the system.

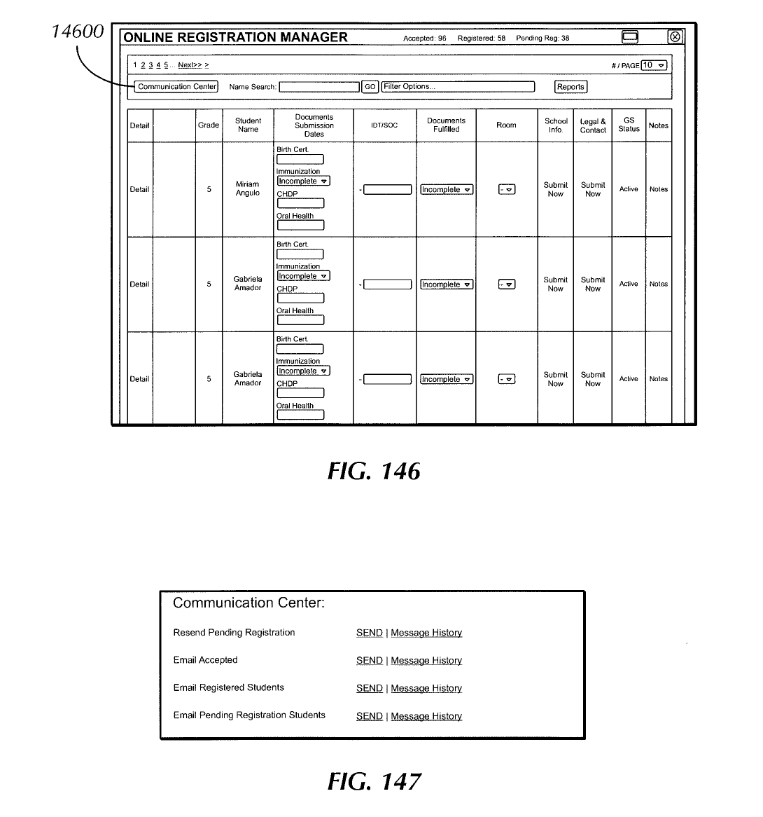

FIG. 146 shows that once a record within the Interest Form interface is given a Status level of accepted, the data is moved into the Online Registration interface. Records cannot be deleted from within this interface. The User must go to the Member management section and change the member status to Full Data Delete in order to permanently remove the record from the system. If the User clicks on the Communication Center button 14600 at the top left of the grid, FIG. 147 is invoked in which the User can send messages to registrants to prompt them to complete various registration requirements. All communications are stored under the Message History link.

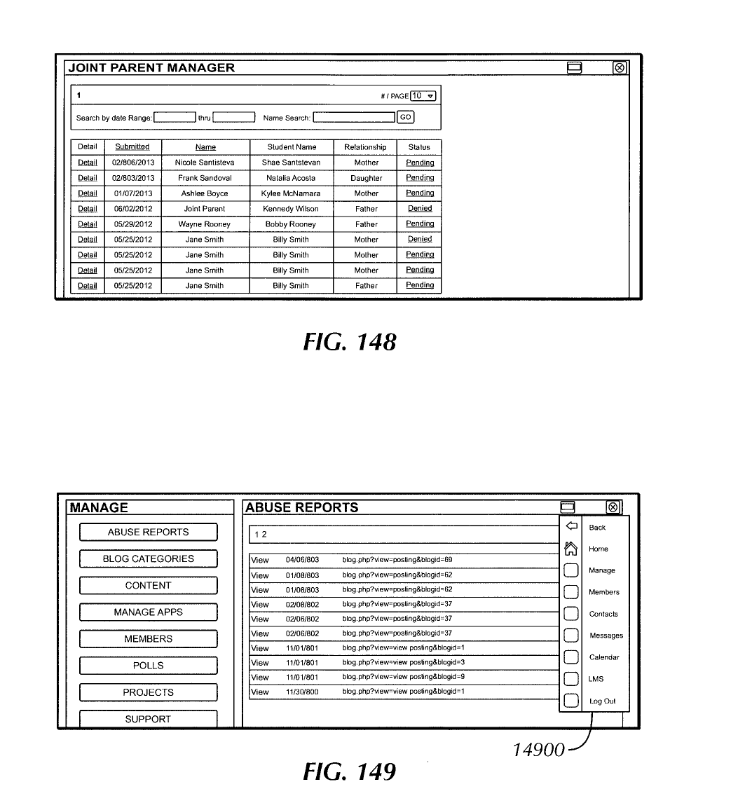

FIG. 148 show that selecting a JOINT PARENT button invokes a management interface for all registrations that have entered the system through the Joint Parent registration form. Records within this grid are assigned a default status of Pending. Once the status is changed to approved, the data is moved into the Member management interface. Records that are assigned a Denied status are stored within this interface for reference. Denied status cannot be modified. The User will be required to complete and submit a new Joint Parent registration form in order to gain accepted status within the system. Users that enter the system under this registration process are subject to a limited amount of access and permissions. Limitations are specified by each school within the system and will be applied accordingly within each online school community.

FIG. 149 shows that each main page within the system includes a Smart Menu drop down menu 14900. A User can click the icon to view a list of the most common pages available within the system. Once they identify the appropriate page, the User can click the icon to proceed directly to the specified section within the site. Note that the displayed list is an example a system default list which can be modified as specified.

While the particular METHOD AND APPARATUS FOR A SECURE, COLLABORATIVE COMPUTER BASED COMMUNITY is herein shown and described in detail, it is to be understood that the subject matter which is encompassed by the present invention is limited only by the claims.

What is claimed is:

1. Apparatus comprising:
at least one computer readable storage medium that is not a carrier wave and that is accessible to a digital processor and bearing instructions which when executed by the processor configure the processor to execute logic to execute a method comprising:
present on a display a user interface comprising:
a first column of sections, a first section in the first column being a personal profile section configurable to contain personal information associated with a user of the display, a second section being a contact section configurable to contain contact information pertaining to users in a closed group of users affiliated with the user of the display, a third section configurable to present indications of academic performance of the user of the display;
a second column configurable to present icons representing applications, at least some of the icons being selectable to invoke respective web sites in a closed group of web sites; and
a third column of sections, a first section in the third column being configurable for listing events by name and date associated with the user of the display, a second section in the third column being configurable for listing messages to the user of the display, and a third section in the third column being configurable to list work assignments of the user of the display.

2. The apparatus of claim 1, wherein the first through third sections of the first column are presented in order respectively from top to bottom on the display.

3. The apparatus of claim 1, wherein the first through third sections of the third column are presented in order respectively from top to bottom on the display.

4. The apparatus of claim 1, wherein the second column is presented on the display between the first and third columns.

5. The apparatus of claim 1, wherein the first column is presented along a left edge of the display and the third column is presented along a right edge of the display.

6. The apparatus of claim 1, wherein the UI comprises a banner section presented simultaneously on the display above the first, second, and third columns.

7. The apparatus of claim 1, wherein functionality of the UI when presented on a display of a user in a first user category is different from functionality of the UI when presented on a display of a user in a second user category.

8. Apparatus comprising:
at least one computer readable storage medium that is not a carrier wave and that is accessible to a digital processor and bearing instructions which when executed by the processor configure the processor to execute logic to execute a method comprising:
present on a display a parent user interface comprising:
data input elements allowing a primary parental unit to enter their gender, name, address, contact information, preferred language, and indicate whether their mailing address is the same as their street address.
data input elements allowing a primary parental unit to enter at least one student's name, address, contact information, and preferred language, indicate whether the student is part of a custody agreement, and whether the student has a sibling at a school.

9. The apparatus of claim 8, wherein the instructions configure the processor to display a parent UI including an on-screen confirmation message and to deliver an automated email notification informing the primary parental unit that the data entered into the data input elements has been received and is being reviewed.

10. The apparatus of claim 8, wherein the instructions configure the processor to present on the display an administrator UI including data fields to indicate whether a student assessment has been performed and by whom, data fields for recording the date the parent and student attended an orientation meeting, a Notes text link for recording notes within a student's registration file, and a status selector to indicate whether the student's data was accepted, added to a waiting list, or denied.

11. The apparatus of claim 8, wherein successful acceptance into the school's registration process is responded to by an automated email notification provided to the primary parental unit, the auto-notification being amendable by a user designated as a school administrator, which includes the temporary passwords of the primary parental unit and student made available only to the primary parental unit.

12. The apparatus of claim 8, wherein the instructions configure the processor to present on the display a parent user interface comprising:
data input elements allowing a parent to enter their employer, education level, and parental status, to indicate whether they would like important email notifications to be sent to them automatically, and to indicate whether the student resides at their address more than 50% of the time.
data input elements allowing a parent to enter additional student information, siblings or other household children not attending the same school, non-parent emergency contacts, after school child care providers, additional school information, and health services information.

13. The apparatus of claim 8, wherein the instructions configure the processor to present on the display an administrator UI including data fields for recording the dates when a student's birth certificate, immunization records, Child Health & Disability Prevention form, and Oral Health records have been received by the school, a selector field to indicate whether documents have been fulfilled, a selector field indicating the student's classroom, data fields for entering data input elements for School Information and Legal & Contact information, a Notes text link for recording notes within a student's registration file, and a status selector to indicate whether an account is active or inactive.

14. The apparatus of claim 8, wherein successful activation of an account is responded to by automated email notification provided to the primary parental unit, the auto-notification being amendable by a user designated as a school administrator, and the system prompts the parent and student to change their temporary passwords to permanent passwords upon their initial logins.

15. The apparatus of claim 8, wherein the instructions configure the processor to present on the display a user interface enabling an administrator to instantly modify the specific data input elements within the user accounts for all user role types including teachers, parents, and students.

16. Computer system comprising:
at least one student computer providing at least an entry student user interface (UI) on a display;
at least one parent computer providing at least an entry parent UI on a display and associated with at least one student UI; and
at least one teacher computer providing at least an entry teacher UI on a display and interacting with the student and parent computers to establish a secure cloud-based environment for student learning and collaboration, promotion of appropriate and responsible online student behavior, introduction and development of student work skills and abilities, and access to hundreds of online learning systems for students instantly and securely, the parent UI affording a parent access to student performance and behavior, the parent computer programmed to facilitate submission of student registration information online, the teacher UI facilitating teaching curriculum development and publication to student computers and online grading of student submitted response to curriculum.

17. The system of claim 16, further comprising:
at least one school administrator computer providing at least an entry administrator UI on a display and interacting with the student and parent computers to gather and present performance data and metrics and distribute individualized or customized information within the system.

18. The system of claim 16, wherein the student UI includes:
a first column of sections, a first section in the first column being a personal profile section configurable to contain personal information associated with a user of the student computer, a second section being a contact section configurable to contain contact information pertaining to users in a closed group of users affiliated with the user of the student computer, a third section configurable to present indications of academic performance of the user of the student computer;
a second column configurable to present icons representing both internal and external applications, at least some of the icons being selectable to invoke respective web sites in a closed group of web sites; and
a third column of sections, a first section in the third column being configurable for listing events by name and date associated with the user of the student computer, a second section in the third column being configurable for listing messages to the user of the student computer, and a third section in the third column being configurable to list work assignments of the user of the student computer.

19. The system of claim 18, wherein the student UI comprises a user specific rotating banner section presented simultaneously on the display above the first, second, and third columns.

20. The system of claim 18, wherein the teacher UI includes:
a first column of sections, a first section in the first column being a personal profile section configurable to contain personal information associated with a user of the teacher computer, a second section being a contact section configurable to contain contact information pertaining to users in a closed group of users affiliated with the user of the teacher computer, a third section configurable to present indications of academic performance for the students of the user of the teacher computer;
a second column configurable to present icons representing both internal and external applications, at least some of the icons being selectable to invoke respective web sites in a closed group of web sites; and
a third column of sections, a first section in the third column being configurable for listing events by name and date associated with the user of the teacher computer, a second section in the third column being configurable for listing messages to the user of the teacher computer, and a third section in the third column being configurable to list work assignments of the user of the teacher computer, wherein functionality of the student UI is different from functionality of the teacher UI.
